(19) United States
(12) Patent Application Publication
(10) Pub. No.: US 2023/0202735 A1
(43) Pub. Date: Jun. 29, 2023

(54) Tray Having Nested Drainage Platform

(71) Applicant: Converter Manufacturing, LLC, Orwigsburg, PA (US)

(72) Inventor: Millard F WALLACE, Orwigsburg, PA (US)

(73) Assignee: Converter Manufacturing, LLC, Orwigsburg, PA (US)

(21) Appl. No.: 18/091,934

(22) Filed: Dec. 30, 2022

Related U.S. Application Data
(63) Continuation of application No. PCT/US21/40351, filed on Jul. 2, 2021.
(60) Provisional application No. 63/047,907, filed on Jul. 2, 2020.
(60) Provisional application No. 63/164,896, filed on Mar. 23, 2021.

(51) Int. Cl. B65D 81/26; B65D 1/34

(52) U.S. Cl. CPC B65D 81/262; B65D 1/34

(57) ABSTRACT

The disclosure relates to trays for segregating liquid in a reservoir space distinct from a storage space. The trays include a body having a floor and a platform spaced away from the floor and bearing at least one orifice or gap extending therethrough for facilitating fluid flow from the storage space into the reservoir space under the influence of gravity. The gaps and/or orifices are relatively centrally located, which tends to inhibit retrograde flow of fluid from the reservoir space into the storage space. The platform can include one or more deflectable doors defined by elongated gaps. Deflection of a door, such as by a protrusion extending from the body, opens the door-defining gap into a larger opening to facilitate fluid flow. The platform can also have one or more adaptors and/or sockets for securing its position relative to the floor.

### CROSS-REFERENCES TO RELATED APPLICATIONS

This application is a continuation-in-part of international application PCT/US2021/040351, filed 2 Jul. 2021, which is entitled to priority to U.S. provisional patent application No. 63/047,907, filed 2 Jul. 2020 and to U.S. provisional patent application No. 63/164,896, filed 23 Mar. 2021.

### BACKGROUND OF THE DISCLOSURE

The invention relates generally to the field of containers for storing solid items separately from fluid, such as trays for storing cuts of meat out of contact with fluids which exude from the meat.

Many foodstuffs are packaged and/or sold in relatively rigid containers which have an open face for receiving, containing, and supporting the foodstuff. Common examples are trays containing cuts of meat (e.g., beef steaks, ground meat, seafood, or cut poultry parts) and bins, bowls, or trays containing whole or cut vegetables, fruits, mushrooms, or prepared food items (e.g., sausages, dumplings, or breaded food items). Such containers can be contained within an opaque secondary container (e.g., a paperboard box) or sealed with thin plastic films, such as transparent films which overwrap the container or are sealed to its rim.

Packaged foodstuffs commonly shed liquid, including liquids used to rinse or wash animal or plant tissues, liquids components of the foodstuff, or liquids which exude (“weep”) from the foodstuff upon standing, aging, or movement. The presence of liquid within a foodstuff container can tend to render the contents undesirable or unappetizing to consumers, and such liquids can also degrade the quality, flavor, and/or microbiological safety of the foodstuff. For these reasons, liquid-shedding foodstuffs are often packaged in containers which can retain their mechanical properties in the presence of the liquid and are also commonly packaged together with an absorbent material (analogous to an infant diaper) which absorbs and retains liquid shed by the foodstuff.

Containers made from plant fibers tend to absorb liquids shed by foodstuffs unless they are lined with a wax or plastic material. However, such linings render fibrous container non-recyclable (or, at least, difficult and strenuous to recycle), and such linings tend to interfere with composting as well. For these reasons, fibrous containers such as paper, cardboard, and paperboard tend to be disfavored for wet or weeping items, at least when recyclability of the packaging is considered important.

Solid and foamed plastic containers resist liquids and are suitable foodstuff containers for that reason. However, the very resistance that plastics exhibit towards liquids means that exuded liquid within a closed or sealed plastic container will tend to slosh around the container (degrading appearance and, potentially, wholesomeness) unless an absorbent material is included within the container. However, absorbent materials also tend to assume an undesirable appearance when blood or other non-clear fluids are absorbed, and absorbed fluids can promote unpleasant odors and/or growth of microorganisms, each of which tends to render contained items less desirable to consumers. Absorbent materials also tend to be non-recyclable, which renders their inclusion in a package undesirable. Furthermore, absorbent materials are sometimes attached or adhered to the container, which can further limit the recyclability of the container. Practical and technical consideration also limit recyclability of foamed plastics.

Others have disclosed foodstuff containers that are able to contain exuded fluids in compartments or reservoirs in the container, distinct from the foodstuff-storage space of the container, at least so long as the container is maintained in a certain position (e.g. resting upon an intended “bottom” surface). Absent use of an absorbent material, previous containers have largely proven unable to contain significant quantities of exuded liquids in a manner that prevents the liquid from re-entering the storage compartment under conditions of normal use, transportation, and display.

A significant need exists for foodstuff storage containers which are amenable to simple and easy recycling and which are able to sequester significant amounts of liquid exuded from a foodstuff at a location distinct from the location of the foodstuff within the container without the use of an absorbent material. The present disclosure describes such containers.

### BRIEF SUMMARY OF THE DISCLOSURE

The disclosure relates to thermoplastic trays for segregating liquid. Such a tray includes a body which is peripherally-sealably engageable with an insert (i.e., forms a substantially liquid-tight seal when the body is engaged at its periphery with the insert). The body includes a floor that is contiguous with sidewalls which surround it. The sidewalls are also contiguous with one another and extend away from the floor to a circumferential rim of the body. The floor and the walls defining a concave interior and a convex exterior, and the sidewalls include an interior perimeter engagement zone for engaging the insert. The floor has at least one protrusion extending away from the floor into the interior, and the exterior of the floor defines a lower surface of the tray. The insert includes a perimeter adaptor having a shape complementary to and snugly opposable against the perimeter engagement zone of the body. The adaptor is contiguous with and surrounds a platform that has at least one orifice extending through it. The lower surface of the tray can be substantially planar, so as to make the tray flat-bottomed. Preferably, both the rim and the engagement zone extend horizontally completely around the perimeter of the sidewalls of the body when the lower surface of the tray rests on a horizontal surface; this will tend to render the upper surface of the insert horizontal as well.

It is possible to make the insert and the body from a unitary piece of the thermoplastic (e.g., such as by 3-D printing it or casting it in a dissolvable mold), but this is atypical and not very practical. Far more typically, the insert and body will be discrete pieces of the same type of thermoplastic and will be assembled to form the final tray.

At least one protrusion preferably extends inwardly a distance sufficient for the protrusion to contact the platform, such as a support that contacts the platform at a surface of the support that is planar and substantially parallel to the bottom of the tray. The tray can, of course, include multiple supports to maintain the vertical position of the insert when it is loaded with items placed into the storage space of the tray. In another embodiment, the protrusion is a shaft which extends inwardly a distance sufficient to extend into a socket formed in the platform. If the shaft compressibly fits the socket (e.g., if the socket is a hole which extends through the platform or the socket is a sealed extension of the platform which extends generally in the direction of the rim), then the shaft will tend to hold the insert and body together. The tray can include multiple shafts, of course, each of which can extend into a socket or orifice formed into the platform of the insert.

The rim of the tray will normally include the peripheral edge of the thermoplastic sheet from which the body is formed. The rim preferably includes a rolled or turned edge which disposes the peripheral edge away from the periphery of the rim. In an important embodiment, the body has the overall shape of a rounded rectangular tray and the insert has a rounded rectangular shape and wherein the adaptor is snugly opposed against the engagement zone of the body. The engagement zone can, for example, have a roughly semi-circular profile having its concavity facing the interior around the entire perimeter of the sidewalls, and that zone can engage with the adaptor of an insert that has a rolled edge adaptor conformation about the entire perimeter of the insert.

The insert of the tray has one or more orifices which extend through the platform for facilitating fluid flow therethrough. The platform portion of the insert can have a shape which includes at least one drainage channel for facilitating liquid communication from the platform to the orifice, the drainage channel being positioned gravitationally lower than the platform when the platform is horizontal. The platform can also have one or more vents extending through it, the vent being positioned gravitationally higher than the drainage channel when when the platform is horizontal. Orifices, vents, and other perforations extending through the insert are preferably centrally located, such as being only within the central third of the insert, as measured along any primary axis of the insert. The platform can also have one or more bumps extending upwardly therefrom when the tray is upright (rim up, floor down). The bumps can be arrayed across the platform, and can be shaped and positioned to inhibit blockage of fluid flow across at least a portion of the platform, such as into or through a drainage channel associated with an orifice. Bumps can be shaped and positioned to inhibit fluid blockage by a deformable solid resting upon the bumps (e.g., the bumps can be pyramidal, conical, frustoconical sections, hemispherical, or other shapes).

The floor of the body can a texture which tends to retain fluid, such as a plurality of fluid cells for sequestering fluid therein. By way of example, the floor can have multiple hexagonal fluid cells formed therein a honeycomb pattern. To avoid damaging fragile plastic film which may contact the lower surface of the tray, one or more of the fluid cells of the floor can have a rounded shape at the exterior surface of the floor. Preferably, the peripheral-most portion of each fluid cell nearest the periphery of the floor has a rounded exterior surface.

In a specialized embodiment, one or more orifices through the insert defines an integral door. Such a door includes a deflectable portion having a door edge defined by one extent of the orifice, the deflectable portion being deflectable between open and closed positions along a flexible hinge region that is integral with the platform and integral with the deflectable portion of the door. Such a door also includes a frame edge which is integral with the platform and has a frame edge defined by another extent of the orifice, the door edge and frame edge being closely opposed against one another when the deflectable portion is in the closed position and less closely opposed against one another when the deflectable portion is in the open position. The position of the engagement zone, the position of the door in the platform, the contour of the platform, and the position and height of at least one protrusion can be selected such that when the adaptor is snugly opposed against the engagement zone, i) the insert divides the interior into a storage space and a reservoir space and ii) the protrusion impinges against the door and deflects the deflectable portion into the open position, thereby facilitating fluid flow through the orifice between the storage and reservoir spaces.

The tray platform can includes multiple doors and the body can include multiple protrusions, at least two of the protrusions impinging upon doors, deflecting the deflectable portion into the corresponding open positions when the adaptor is snugly opposed against the perimeter engagement zone.

In another embodiment, the disclosure relates to a tray for isolating liquid and a solid mass. This tray includes a body engageable with an insert. The body includes a floor contiguous with sidewalls which surround the floor, which are contiguous with one another. The sidewalls also extend away from the floor to a circumferential rim. The floor and the walls define an interior, and the sidewalls include a perimeter engagement zone within the interior for engaging the body and the insert. The floor has one or more protrusions, each extending away from the floor by a height distance into the interior. The insert includes a platform with an integral door defined by a gap extending through the platform. The platform is surrounded by an adaptor for engaging the perimeter engagement zone of the body. The door includes a deflectable portion having a door edge defined by one extent of the gap, the deflectable portion being deflectable between open and closed positions along a flexible hinge region that is integral with the platform and integral with the deflectable portion of the door. The door also includes a frame edge which is integral with the platform and has a frame edge defined by another extent of the gap. The door edge and frame edge are closely opposed against one another when the deflectable portion is in the closed position and less closely opposed against one another when the deflectable portion is in the open position. The adaptor has a shape substantially the same as, but snugly nestable against, the perimeter engagement zone. The position of the perimeter engagement zone within the interior, the position of the door in the platform, the contour of the platform, and the position and height of at least one protrusion can be selected such that when the adaptor is snugly nested against the perimeter engagement zone, the insert divides the interior into a storage space and a reservoir space and the protrusion impinges against the door, deflects the deflectable portion into the open position, and facilitates fluid flow through the gap between the storage and reservoir spaces.

### BRIEF SUMMARY OF THE SEVERAL VIEWS OF THE DRAWINGS

FIGS. 1A, 1B, 1C, and 1D are diagrams which depict a tray 300 as described herein, which comprises a concave body 200 having the overall shape of a rounded rectangular tray and an insert 100 that nests within the interior of the body. FIG. 1A is an overhead view above the open face of the body. FIG. 1B is a long-edge view of the tray. FIG. 1C is a sectional view taken along line 1C-1C in FIG. 1A, and FIG. 1D is a sectional view taken along line 1D-1D in FIG. 1A. In this embodiment, the tray 300 is sealed with a piece of transparent plastic film 400 that is adhered to a sealing surface 295 situated on the upper surface of the rim 290 that surrounds the concave interior of the body. The body 200 has a floor 210 and sidewalls 240 which connect the rim 290 to the floor. The sidewalls 240 bear a perimeter engagement zone 245 which accommodates the insert 100 along its outer periphery. A generally-disk shaped support 230 rises above the floor 210 of the body in this embodiment, and serves to maintain the insert 100 separate from the floor in the vicinity of the support, even if an object is loaded atop the insert. The insert 100 also engages with the body 200 at the perimeter engagement zone 245 and divides the interior of the body into a storage space 235 (bounded by the upper surface of the insert, and the interior of the sidewalls of the body between the insert and the rim of the body) and a reservoir space 205 (bounded by the lower surface of the insert, the floor 210 of the body, and the interior of the sidewalls between the insert and the floor. Also in this embodiment, the shape of the insert 100 is selected so that the insert engages the perimeter engagement zone 245 of the body about the entire outer periphery of the insert. In this embodiment, the substantially planar insert rests upon and engages a shelf 231 that extends inwardly from and completely around the perimeter of the interior of the body at an elevation above the floor 210 that is equal to the height above the floor of the generally-disk shaped support 230. The insert 100 has a single circular orifice 170 extending through its interior, here offset from the center of the insert 100. In the assembled tray 300, the storage space 235 of the body communicates with the reservoir space 205 solely through the orifice 170, because the insert 100 is sealed to the shelf 231 in a liquid-tight fashion about the entire periphery of the insert. Moreover, when a sheet of plastic film 400 is sealed in a liquid-tight fashion about the entire perimeter of the rim 290, the storage space 235 and the reservoir space 205 are isolated from the exterior of the film-sealed assembled tray and form a storage compartment 335 and a reservoir compartment 305, fluid communication between these compartments being possible through the orifice 170 only.

FIG. 2 is a series of diagrams of a tray 300 of the type shown in FIGS. 1A-1D, lacking the film seal and shown in seven different orientations, designated i-vii. In each of these orientations, the tray is oriented so that its floor 210 and rim 290 are vertical, relative to gravity (direction of gravity is indicated by the solid arrow in the center of the figure. The tray includes an insert 100 that is sealed in a fluid-tight manner about its entire perimeter to the shelf 231 that surrounds the reservoir space 205 of the tray. The insert thereby forms a reservoir compartment 305 that is completely sealed, except at the orifice 170 that extends through the insert, which permits the interior of the reservoir compartment to communicate with the storage space 235 of the tray and thence (because the storage space of the tray is not sealed in these diagrams) with the environment beyond the tray. In each diagram, the tray is illustrated having a clear insert and containing a liquid (gray shading) in its reservoir space. Each of the vertically-oriented trays is depicted rotated relative to the other trays, and it can be seen that the amount of fluid that each tray can retain in its reservoir space differs, depending on the position of the orifice. For each tray, fluid at or above the height of the orifice would be able to pass out of the reservoir space and out of the tray.

FIGS. 3A, 3B, 3C, and 3D are sectional views of a tray of the type illustrated in FIGS. 1A, 1B, and 1D (each sectional view is taken approximately along line 1C-1C in FIG. 1A), differing in the configuration of the perimeter engagement zone (PEZ) 245 of the tray body 200. FIG. 3A is substantially identical to FIG. 1C. The PEZ in FIG. 3B includes an overhang 248 that would tend to prevent the insert 100 from falling out of the assembled tray 300 if it were inverted (i.e., in a position in which its floor 210 were at the gravitational top of the tray). The PEZ in FIG. 3C also includes an overhang 248. The PEZ in FIG. 3D more snugly engages the perimeter of the insert 100 that the PEZ of the trays depicted in FIGS. 3A-3C.

FIGS. 4A, 4B, 4C, and 4D are diagrams which depict a sectional view of a part of an insert 100 before and after engagement with a body 200 as described herein. The planes of the sectional views are analogous to the planes designated “P25BE” (for the body) and “P25CF” (for the insert) in FIG. 25A. FIGS. 4A and 4B correspond to and diagrammatically illustrate what is depicted in FIG. 20C: prior to engagement (FIG. 4A), the perimeter engagement zone 245 of the body 200 and the adaptor 145 of the insert 100 are not adjacent one another; the body 200 and insert 100 are caused to engage (as shown in FIG. 4B) by aligning the perimeter engagement zone 245 and the adaptor 145 and, preferably (as here) causing the contoured surfaces of the perimeter engagement zone 245 and the adaptor 145 to closely oppose against one another to form a snug fit. FIGS. 4C and 4D are analogous to FIGS. 4A and 4B, and illustrate that this insert and body can be engaged with one another even when the insert is inverted, relative to its position in FIGS. 4A and 4B.

FIGS. 5A and 5B are analogous to FIGS. 4A and 4B, respectively, and illustrate that an insert 100 bearing a peripheral flange 142 can be similarly engaged with the body 200. As illustrated in FIG. 5A, the adaptor 145 of the insert 100 includes an outwardly-extending adaptor section 146 and an inwardly-extending adaptor section 144. These snugly fit against positionally-corresponding an outwardly-extending engagement section 246 and an inwardly-extending engagement section 244 of the body 200. The body 200 also includes an overhang 248 that further secures the insert 100 within the body 200 when the adaptor 145 of the insert is snugly fit against the perimeter engagement zone 245 of the body.

FIGS. 6A and 6 are analogous to FIGS. 5A and 5B, respectively, and illustrate that an insert 100 bearing a peripheral flange 142 and an outwardly-extending adaptor section 146 (but lacking an inwardly-extending adaptor section 144 as in FIGS. 5A and 4B) can be similarly engaged with a body 200 having an outwardly-extending engagement section 246.

FIGS. 7A, 7B, 7C, and 7D are analogous to FIGS. 4C, 4D, 4A, and 4B, respectively, and illustrate that an insert 100 bearing its peripheral edge 199 on an outwardly-extending peripheral flange 142 and an adaptor 145 can be snugly fit into a body having a positionally-corresponding perimeter engagement section 246, and that the snugness of the fit can be enhanced if the body 200 further includes an outwardly-extending socket 242 that accommodates the peripheral flange when the adaptor is snugly fit against the perimeter engagement section. Embodiments of this include an embodiment in which the peripheral edge 199 of the insert 100 is nearer the rim 290 of the body 200 than is the platform 120 of the insert, as in FIGS. 7A and 7B and an embodiment in which the peripheral edge 199 of the insert 100 is farther from the rim 290 of the body 200 than is the platform 120 of the insert, as in FIGS. 7C and 7D.

FIGS. 8A, 8B, and 8C are a series of diagrams which illustrate sectional views of assembly and edge-smoothing of a tray 300 as described herein. FIG. 8A depicts nesting of a tray-shaped insert 100 with at tray-shaped body 200. Near the peripheral edge 199, the insert has a configuration which engageably-matches the configuration of the body 200 near its peripheral edge 299. FIG. 17B depicts the nested insert and body, which now form an assembled tray 300, in which the peripheral edge 299 of the body and the corresponding peripheral edge 199 of the insert remain disposed near the outer periphery of the tray. In FIG. 17C, the tray 300 has been subjected to an edge-rolling procedure to displace the potentially sharp body peripheral edge 299 and insert peripheral edge 199 away from the outer periphery of the assembled tray. Also visible in these views is a protrusion 220 which extends from the floor 210 of the body and extends through a gap 125 in the insert when the insert and body are assembled as in FIGS. 8B and 8C, thereby displacing the deflectable portion 135 of a door defined by the gap 125 in the insert. The tray depicted in sectional view here is similar to the tray pictured in FIGS. 23E and 23F.

FIGS. 9A, 9B, 9C, 9D, 9E, and 9F illustrate a substantially planar, rounded rectangular insert 100 described herein. FIG. 9A is a view from above one of the faces of the platform 120 of the substantially planar insert, with the doors 130 in their closed positions. FIGS. 9B and 9C are long-edge and short-edge views, respectively, of the same insert with the doors 130 in their closed positions; and dashed lines illustrate the positions of doors 130 in their open positions. In FIGS. 9D, 9E, and 9F, the doors 130 are in their open positions, with the deflectable portions 135 thereof extending into space above one face of the insert. The gap between door edges and frame edges can be seen in the overhead view of FIG. 9D and in the short-edge view of FIG. 9E. FIG. 9F is a view along the long edge of the rounded rectangular insert 100.

Each of FIGS. 10A and 10B is an overhead view of a substantially planar, rounded rectangular insert 100 described herein. The insert depicted in FIG. 10A has a platform 120 that is perforated by four orifices 170, each positioned such that its nearest extent is set a defined distance D_{L} from one of the long edges S₁ and S₃ of the insert and such that its nearest extent is set another distance, D_{V}, from one of the short edges S₂ and S₄ of the insert. The insert depicted in FIG. 10B has a platform 120 that is perforated by two orifices 170, each positioned such that its nearest extent is set a defined distance D_{V} from one of the long edges S₁ and S₃ of the insert and the same distance, D_{V}, from one of the short edges S₂ and S₄ of the insert.

FIGS. 11A, 11B, and 11C illustrate a substantially planar, rounded rectangular insert 100 having four flat sides S₁₋₄ and two C-shaped gaps defining doors in the platform 120 of the insert, the doors being in their closed positions. FIG. 11A a view taken above a planar face of the insert, portions of the gaps are indicated to have gap-to-platform-edge distance (D_{L}) of a selected length. FIGS. 8B and 8C are long-edge and short-edge views, respectively, in which dashed lines indicate the positions of the doors when they are in their open positions.

FIGS. 12A, 12B, 12C, 12D, 12E, and 12F illustrate substantially planar, rounded rectangular inserts 100 having four flat sides S₁₋₄ and two C-shaped gaps defining doors therein. In an embodiment shown in FIGS. 12A, 12B, and 12C, the doors are in their closed positions and portions of the gaps are indicated to have gap-to-platform-edge distance D_{V} (indicated in FIG. 12A) selected to retain a particular volume of liquid between the insert and the body when the tray is held with its floor vertical and with one of its long edges horizontal. FIGS. 12B and 12C are long-edge and short-edge views, respectively, of the same tray in which dashed lines indicate the positions of the doors when they are in their open positions. In an embodiment shown in FIGS. 12D, 12E, and 12F, the doors are in their closed positions and three portions of the gaps are indicated in FIG. 12D to have gap-to-platform-edge distance (D_{V}) selected to retain a particular volume of liquid between the insert and the body when the tray is held with its floor vertical and with one of its long edges horizontal. Another portion of a gap is indicated in FIG. 12D to have a relatively short gap-to-platform-edge distance. FIGS. 12E and 12F are long-edge and short-edge views, respectively, in which dashed lines indicate the positions of the doors when they are in their open positions.

FIGS. 13A, 13B, 13C, and 13D illustrate one embodiment of the tray body 200 described herein. FIG. 13A is an overhead view above the open face of the body; visible are the rim 290, floor 210, and sidewalls 240 of the tray body 200. Also visible in FIG. 13A are four ridge-shaped protrusions 220 and a centrally-disposed support 230. Supports 230 that are labeled (and more easily distinguished) in FIG. 13C are also visible in FIG. 13A. FIG. 13B is a long-edge view of the exterior of the body 200, and FIG. 13D is a short-edge view. Because the body is depicted as opaque in these views and hidden lines are not used to depict internal features, those internal features cannot be seen in FIGS. 13B and 13D. FIG. 13C is a view of a section taken at line 13C-13C in FIG. 13A. Visible in the section are the four ridge-shaped protrusions 220, the peripheral edge 299 of the body, the central support 230, and supports 230 which are positioned as part of the sidewalls and which include a perimeter engagement zone 245 which, in the embodiment illustrated in FIG. 14, is engaged against the insert 100. In FIG. 13C, it can be seen that the height distance D_{H} of protrusions 220 is greater than the floor-to-support height D_{P}.

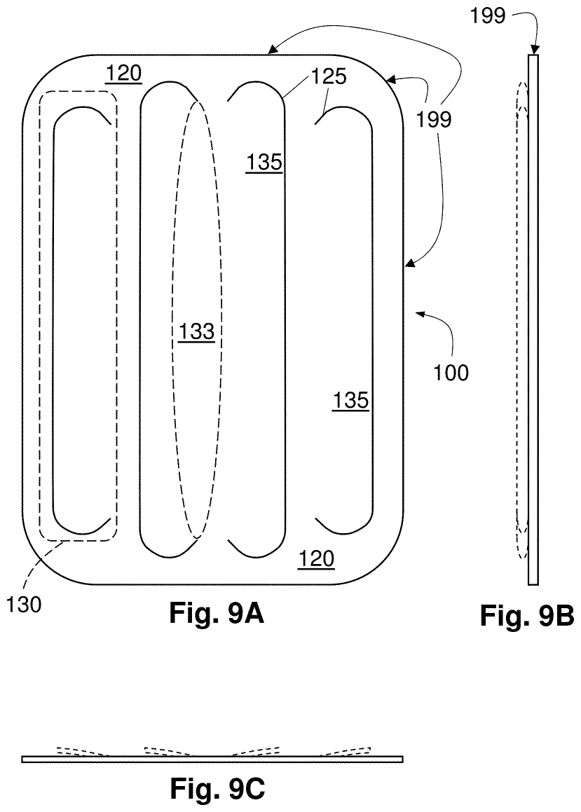

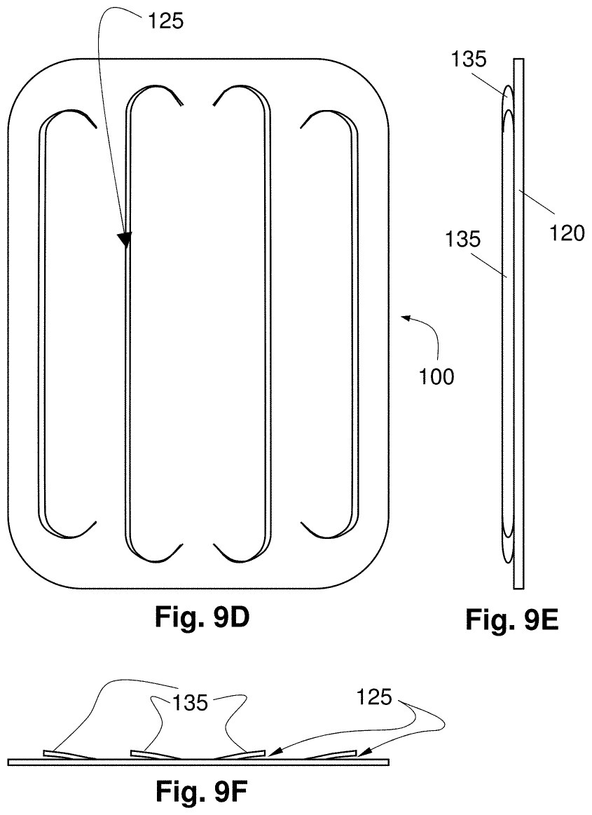

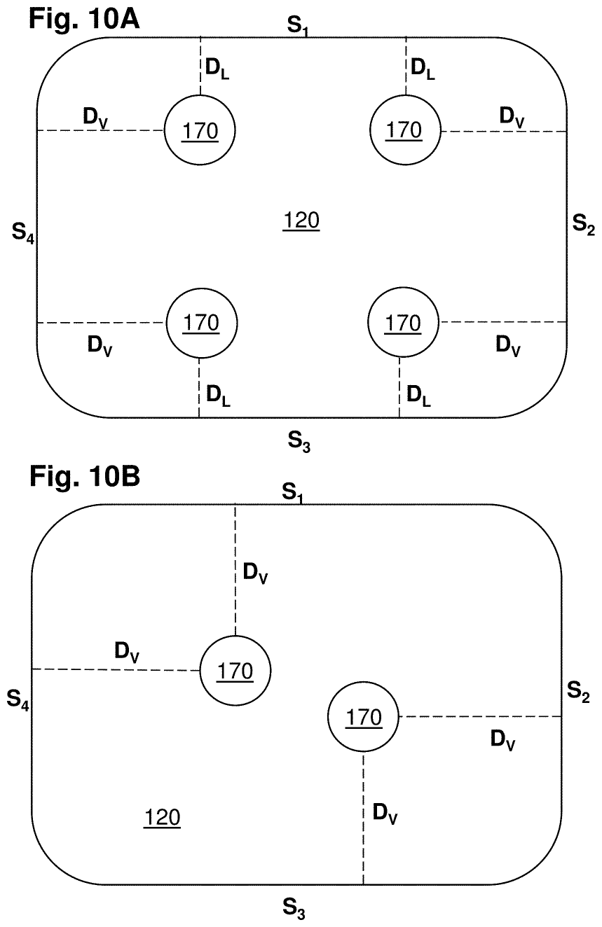

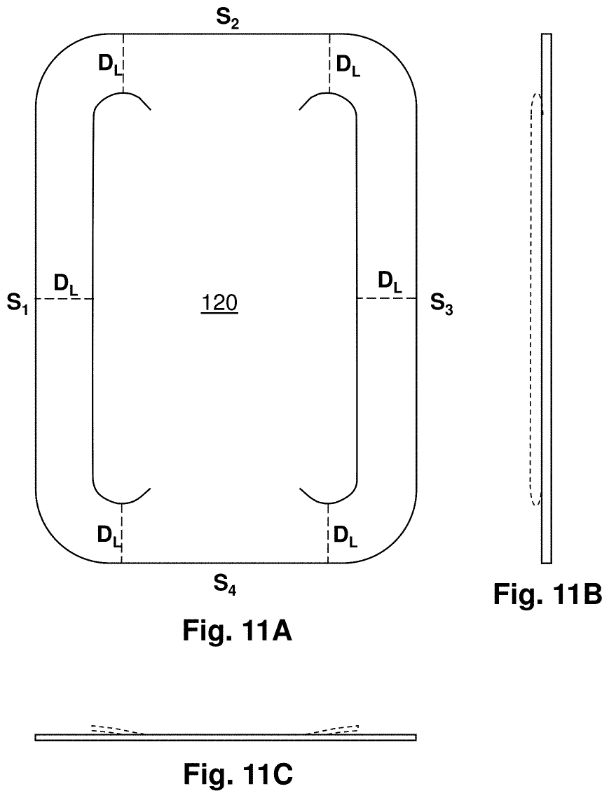

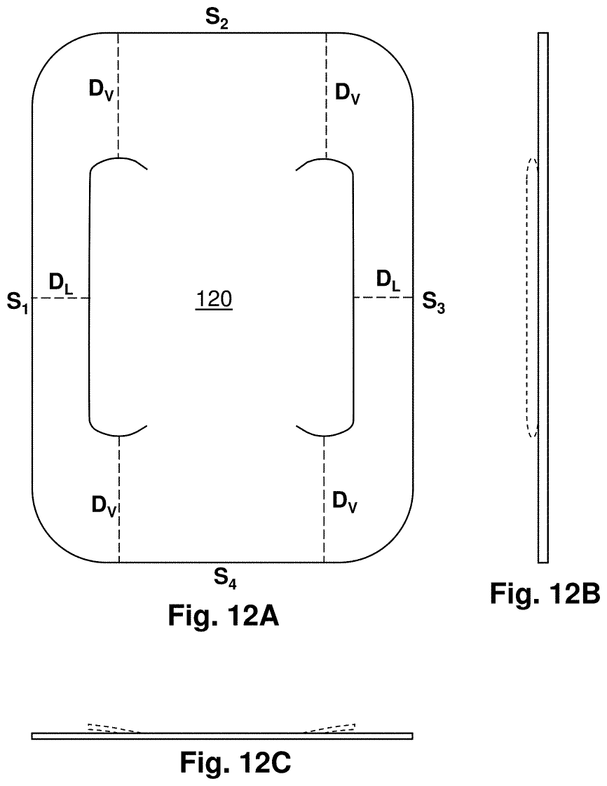

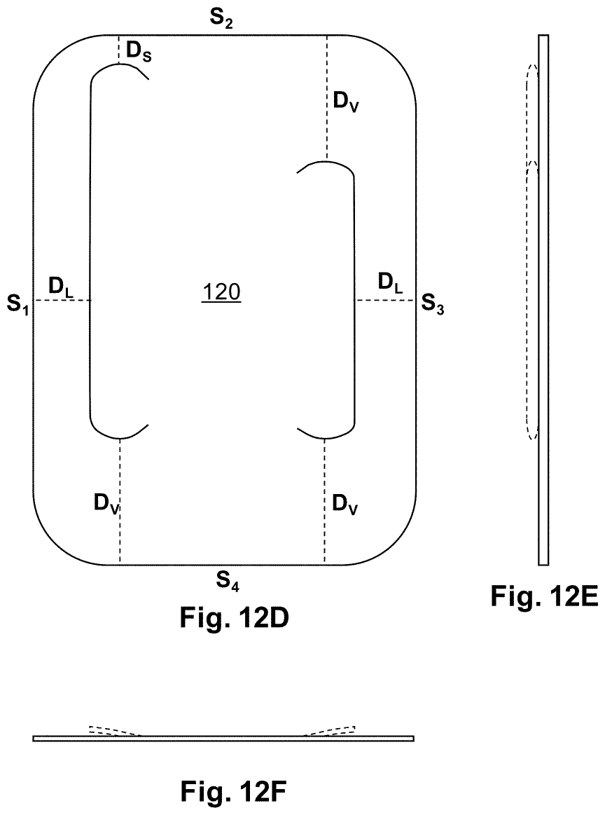

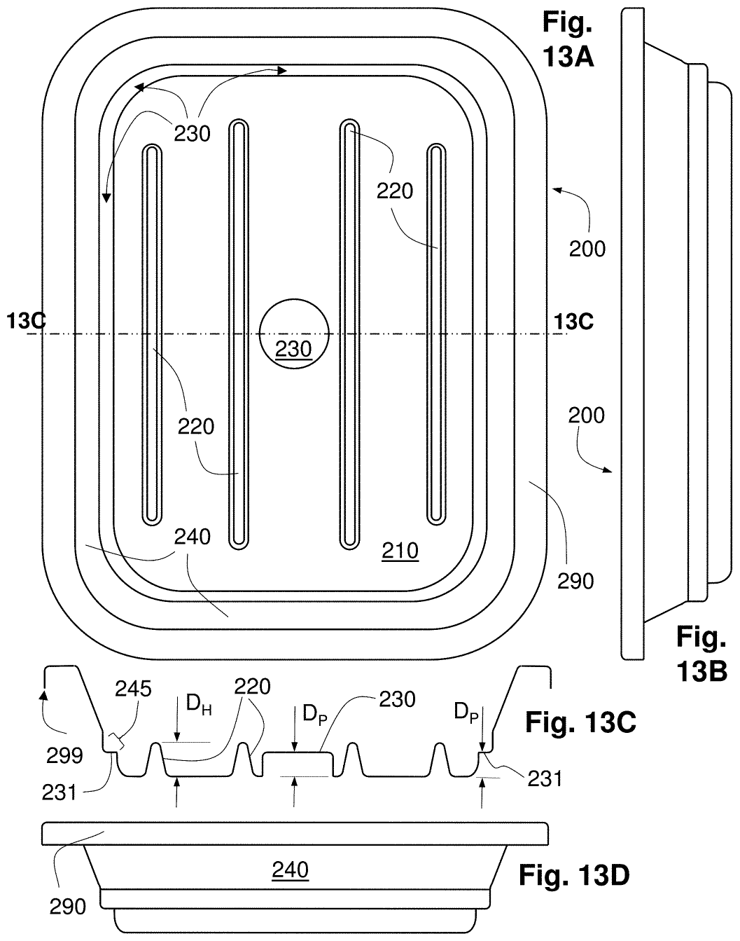

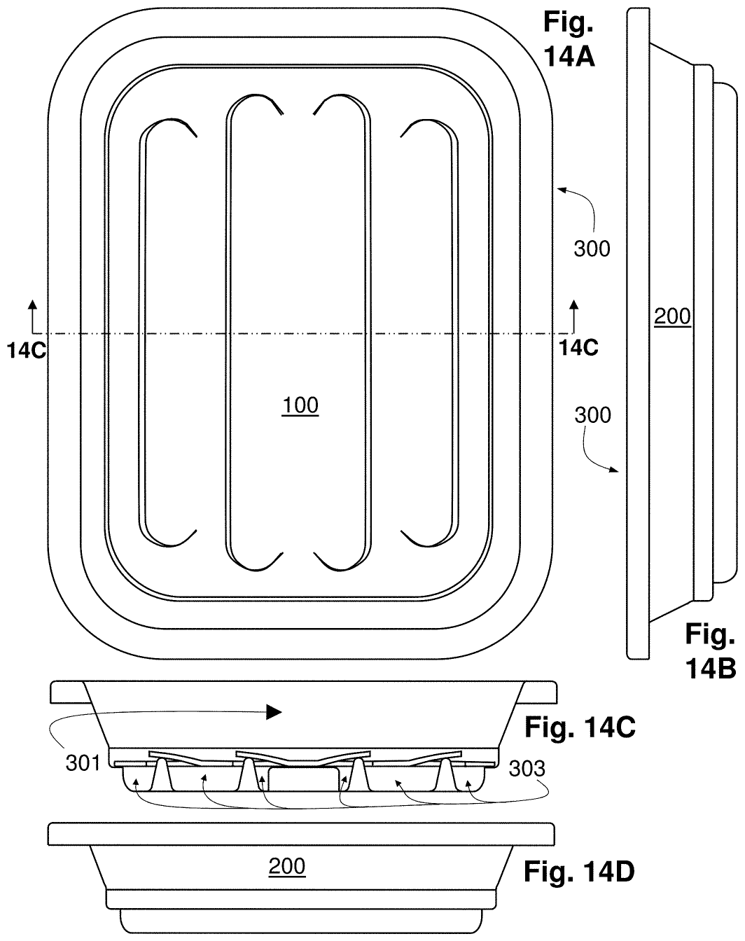

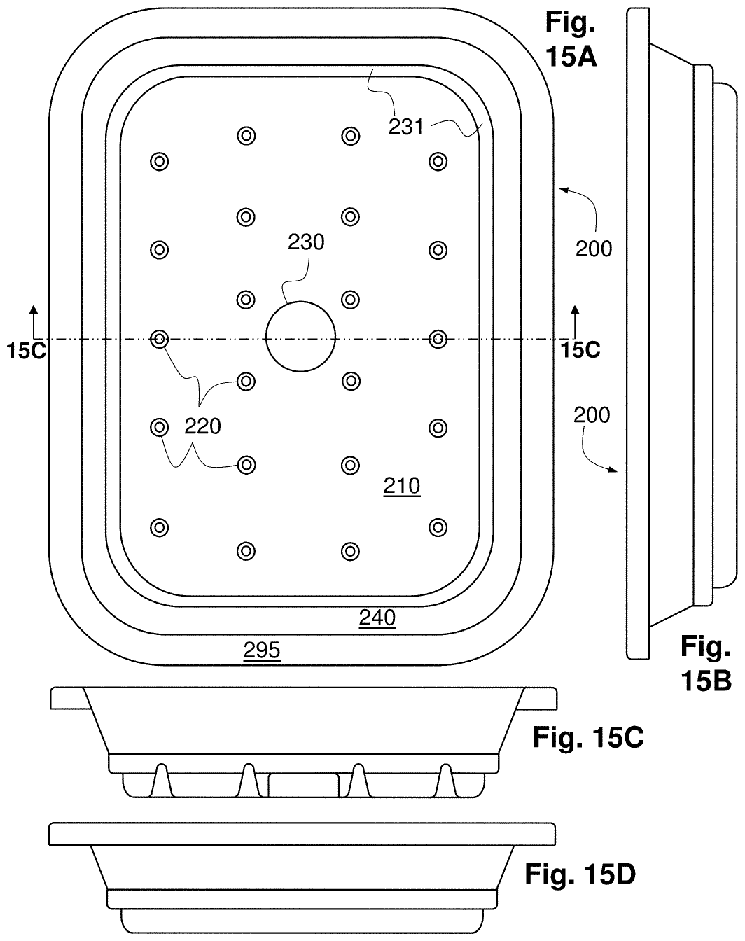

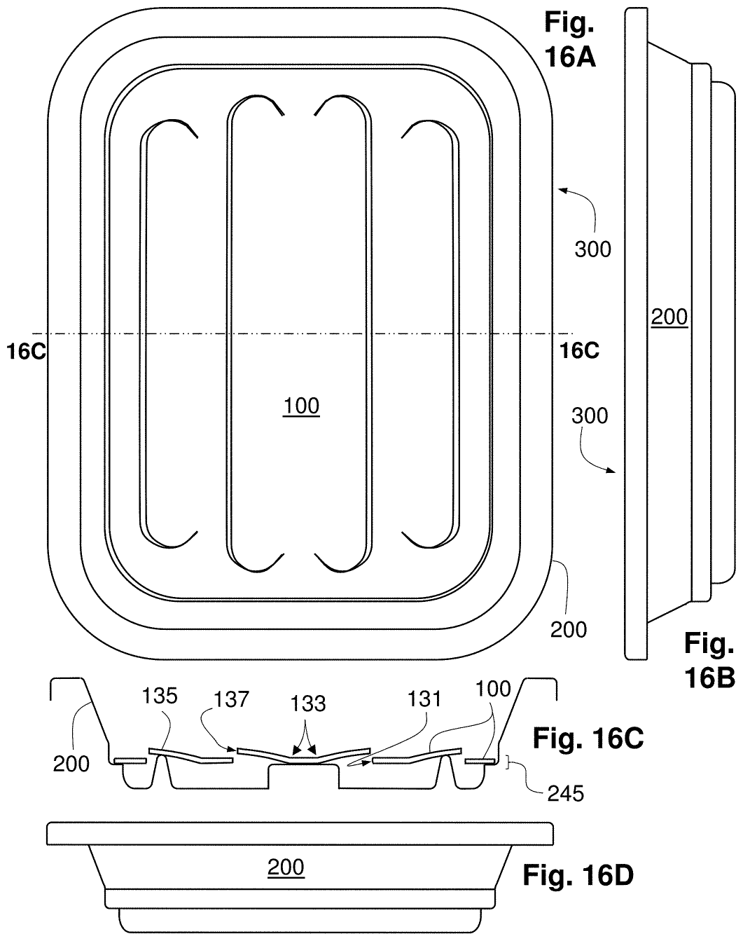

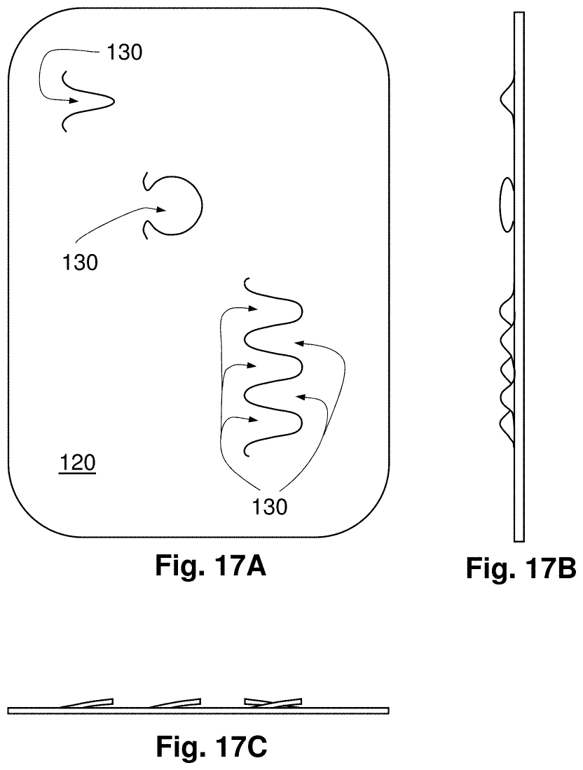

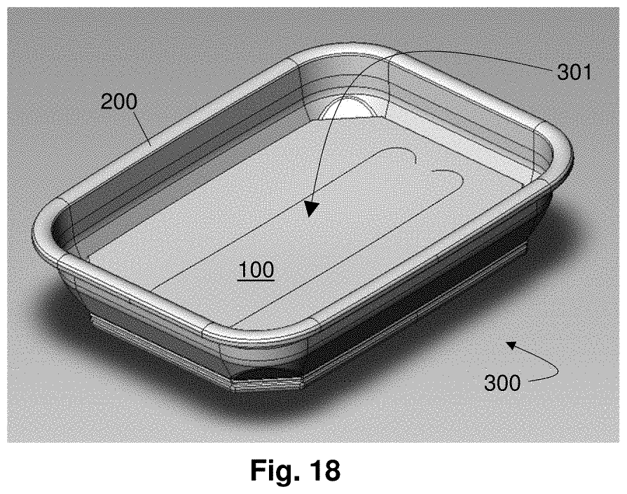

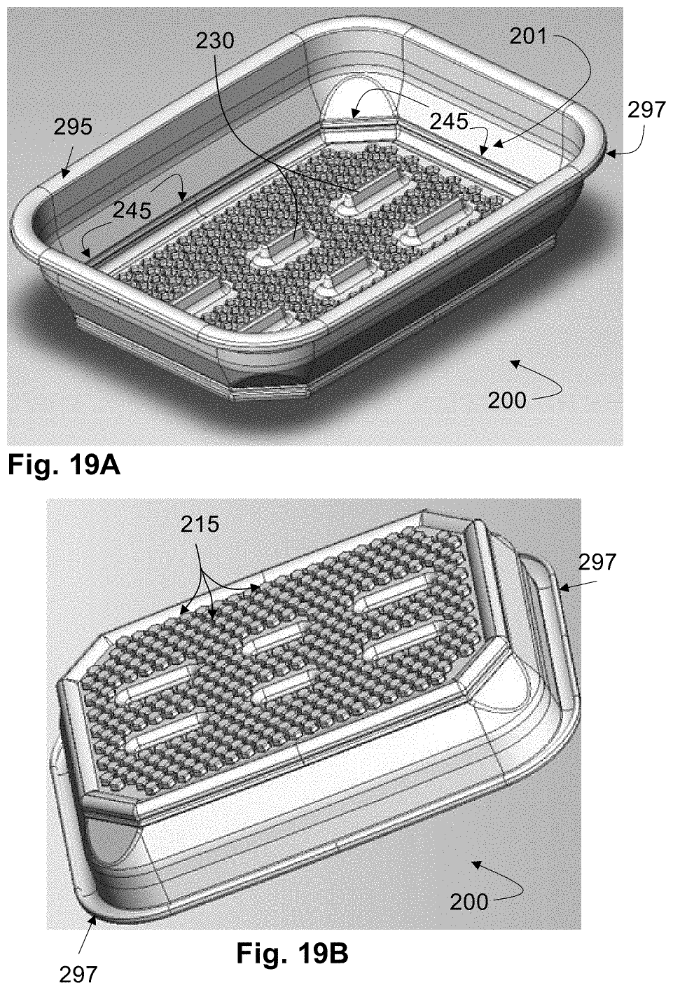

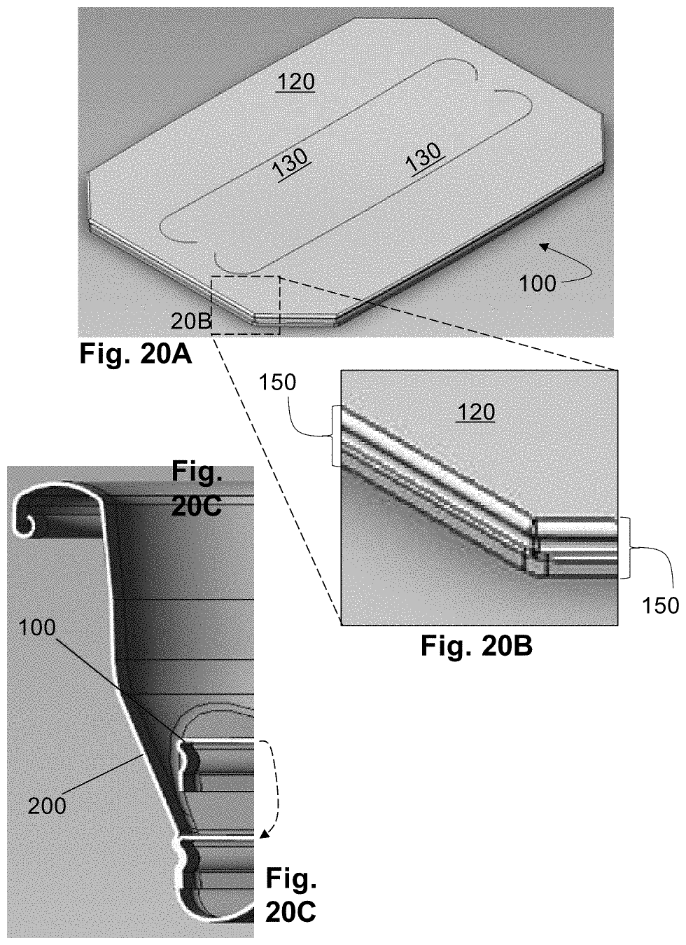

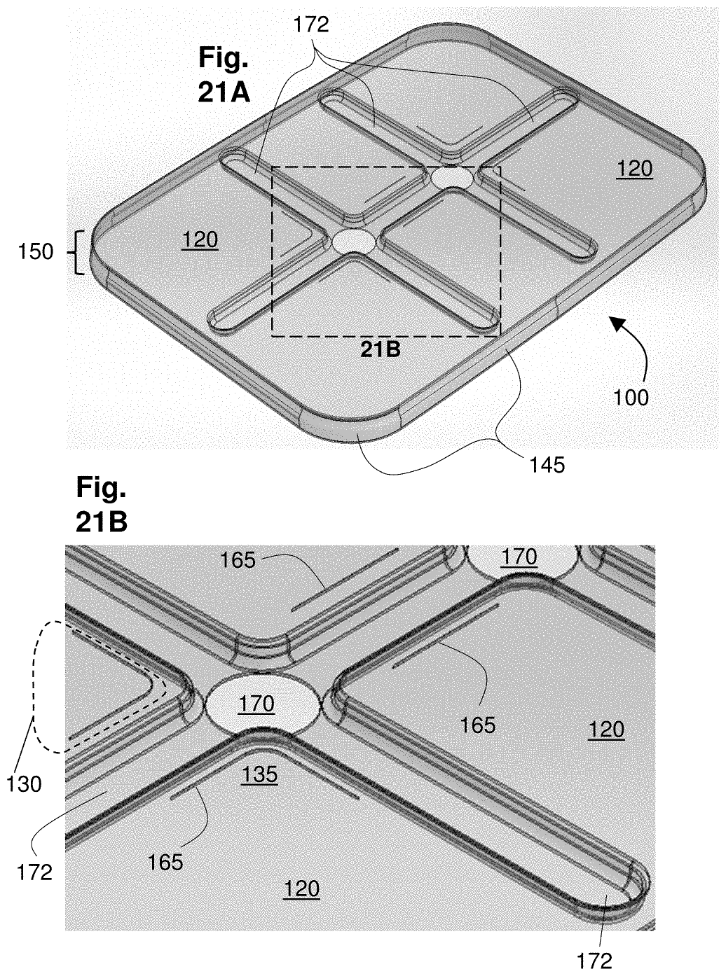

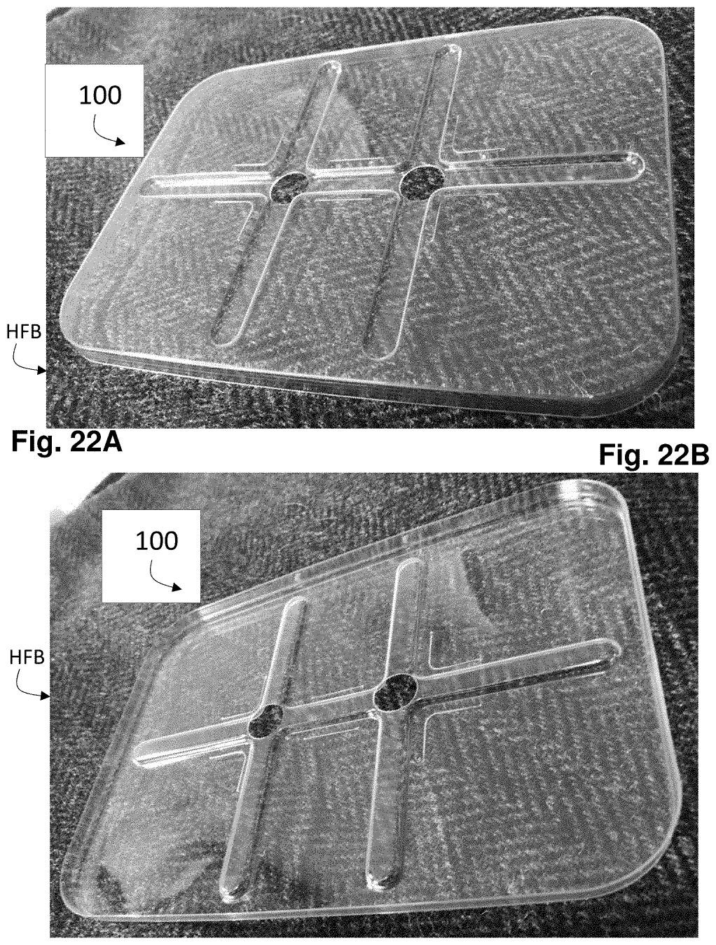

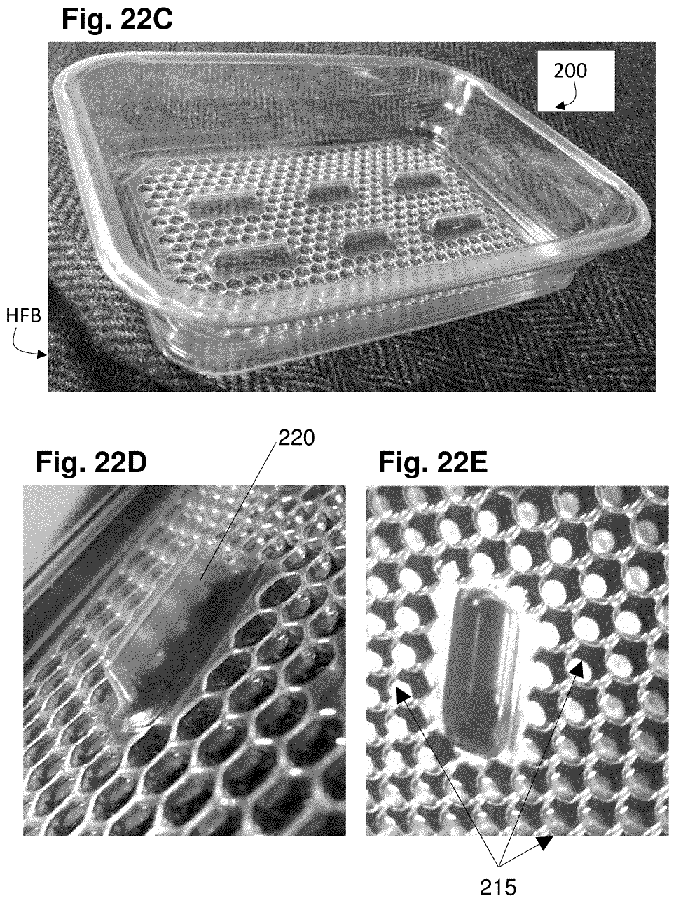

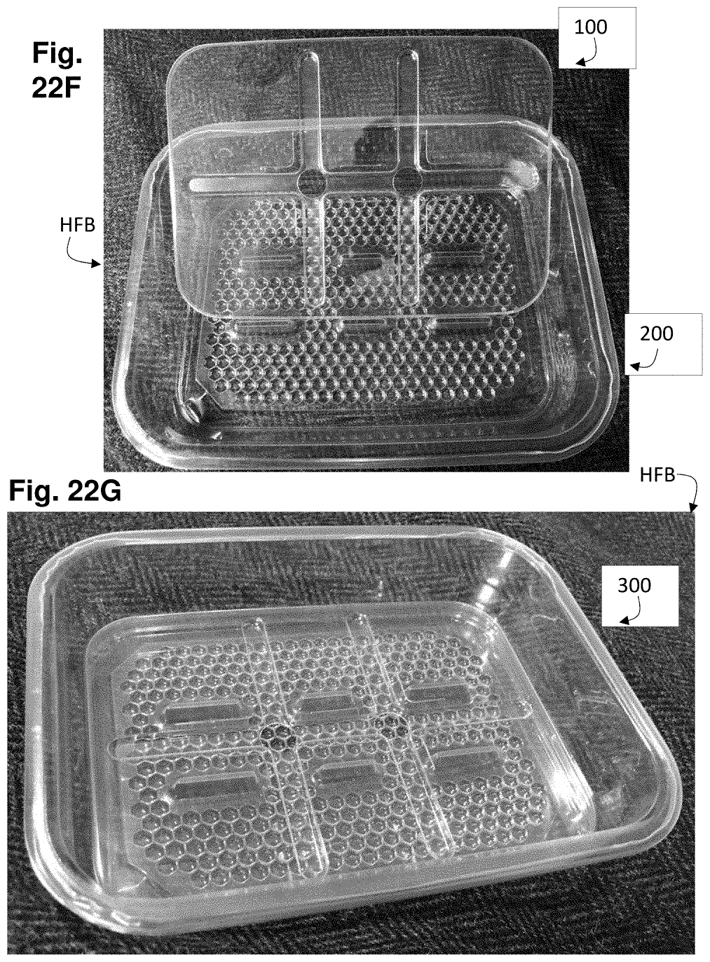

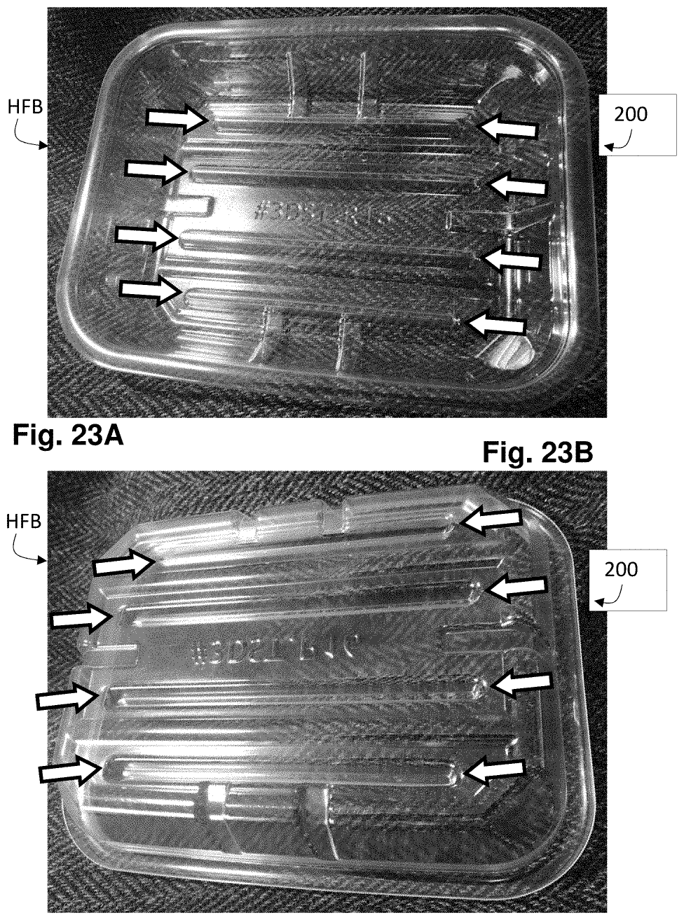

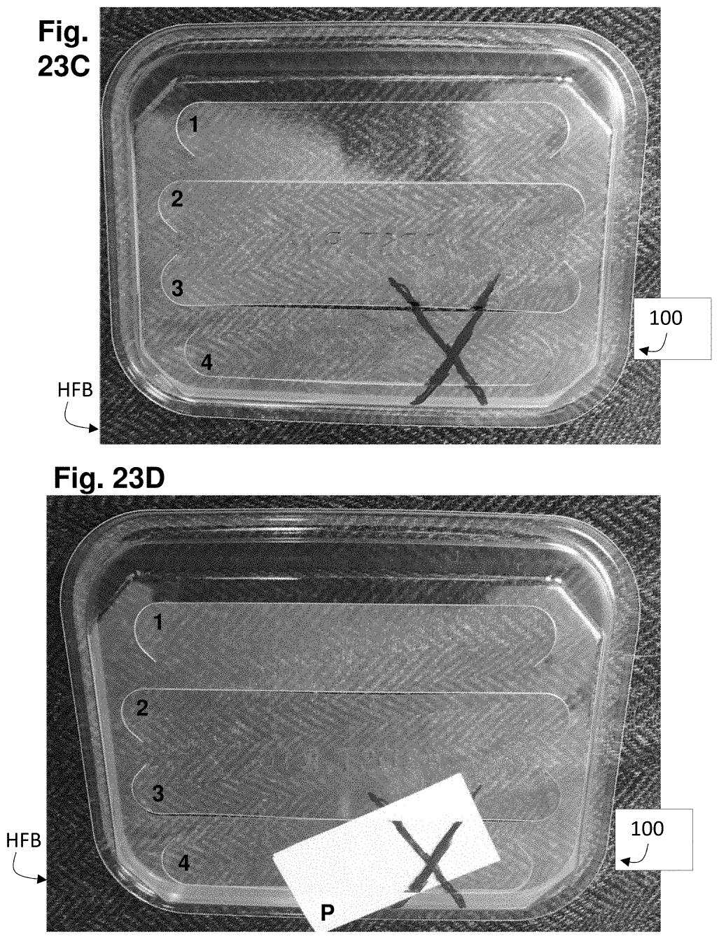

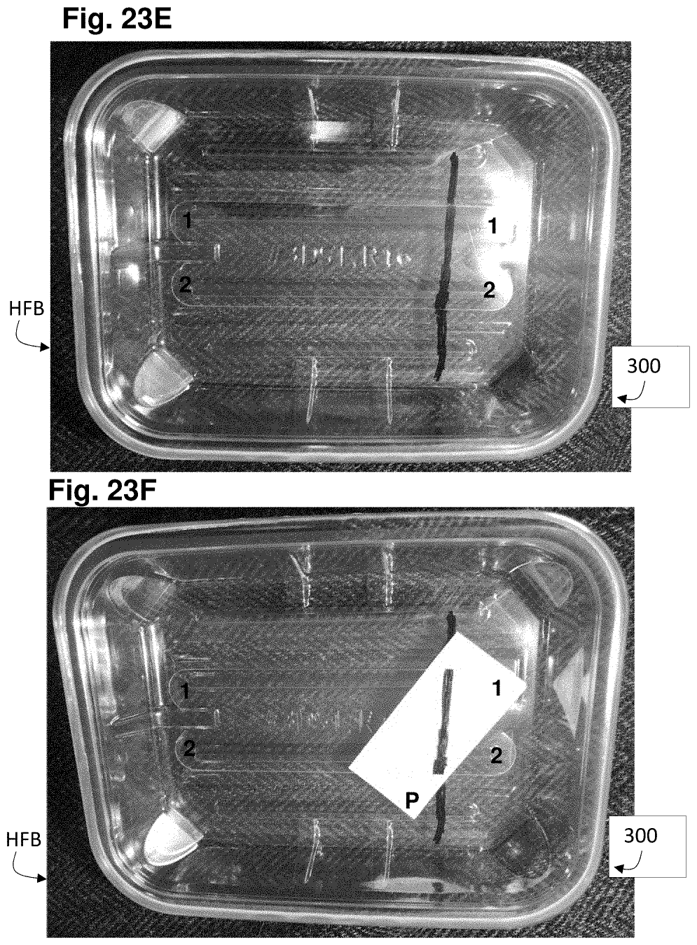

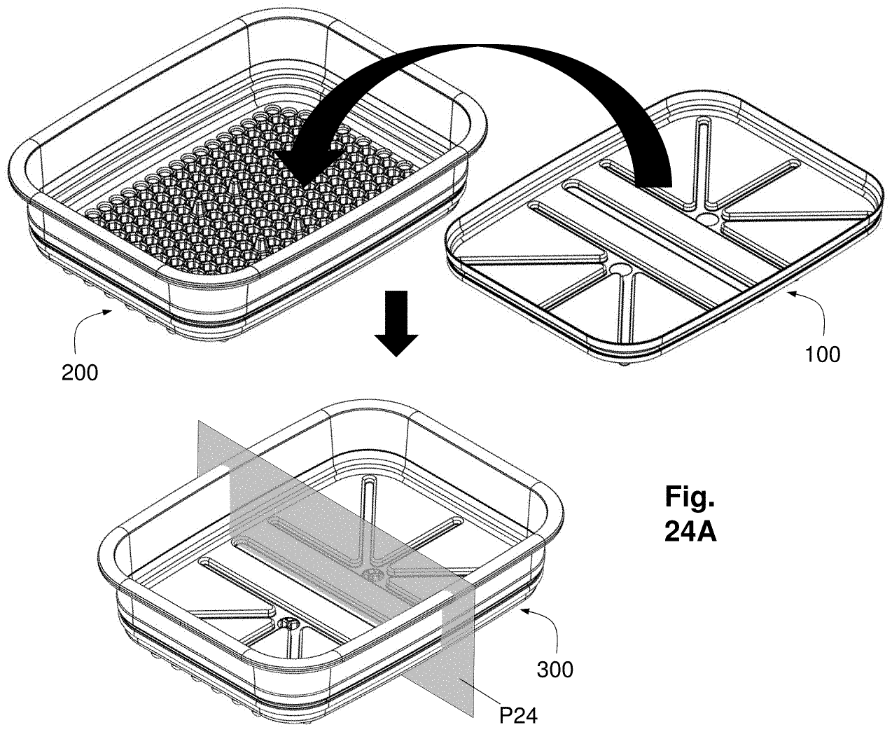

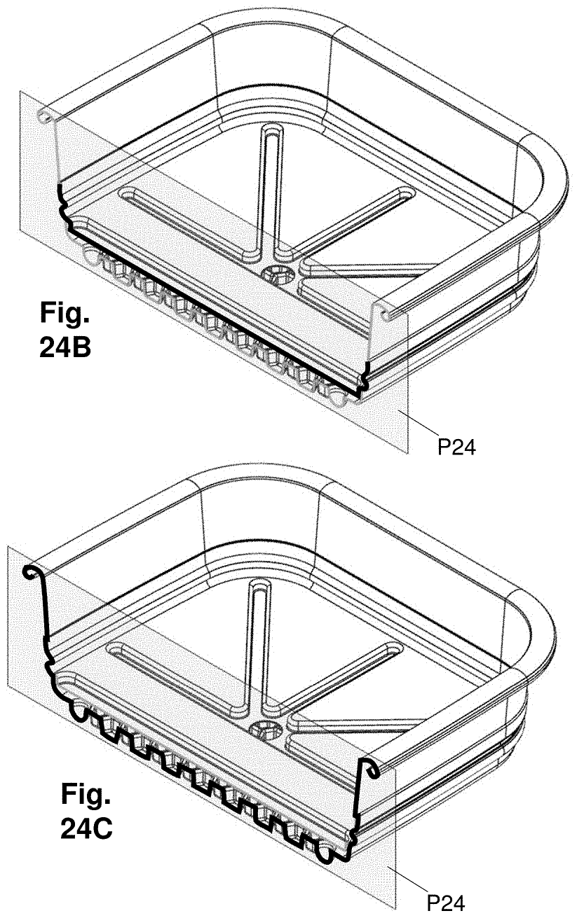

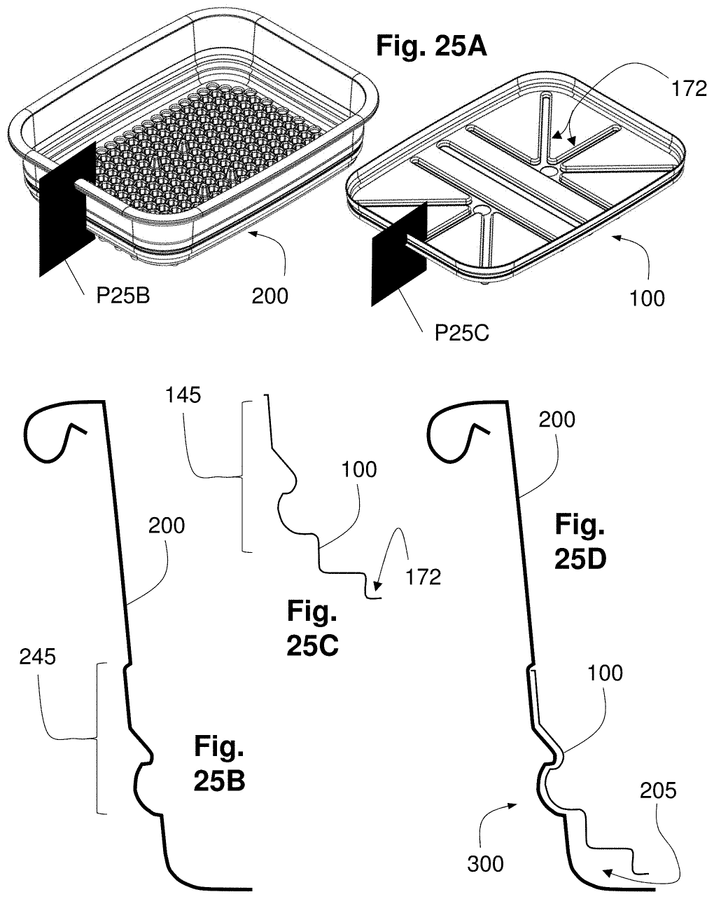

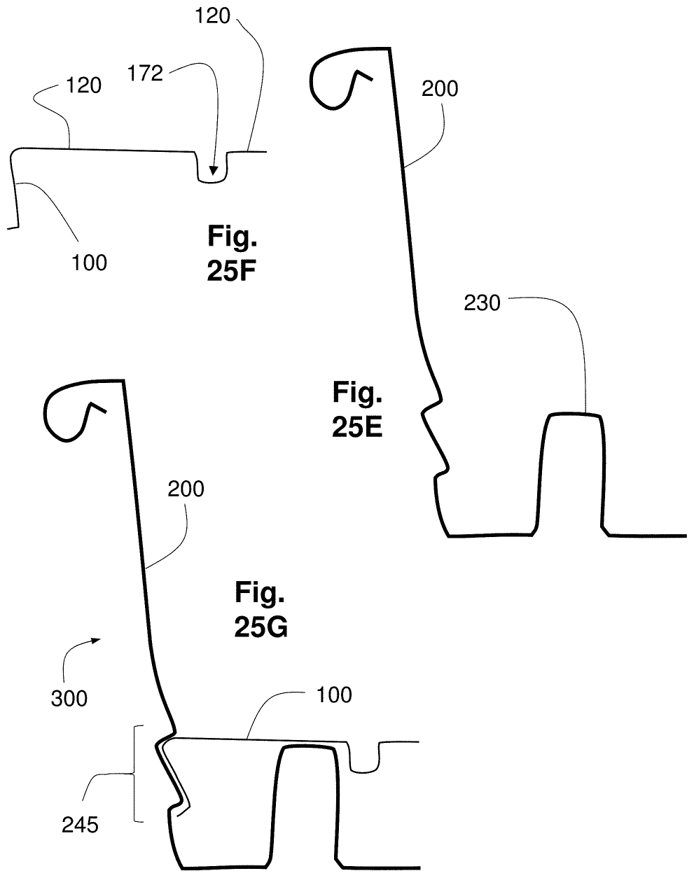

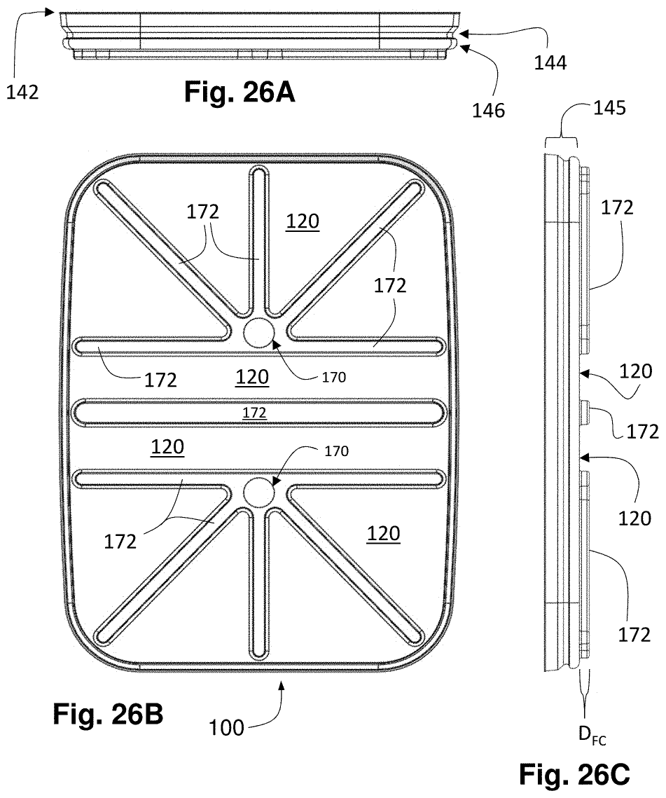

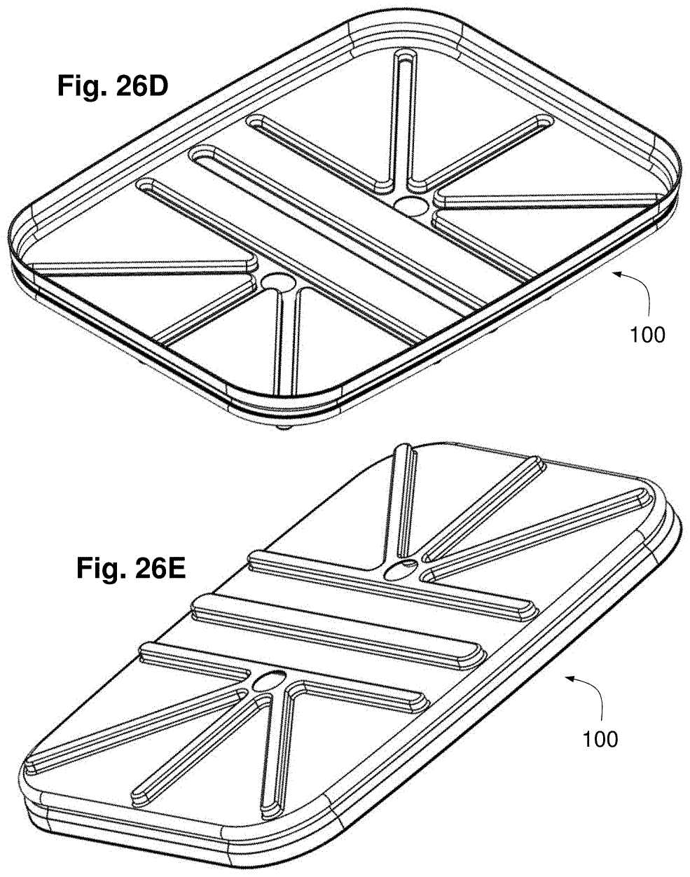

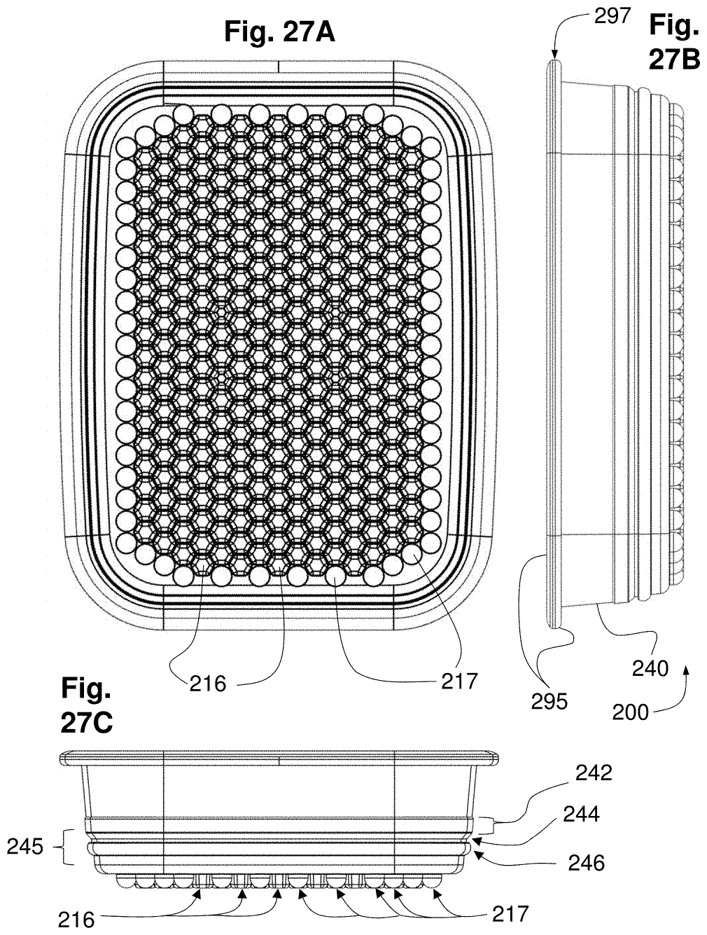

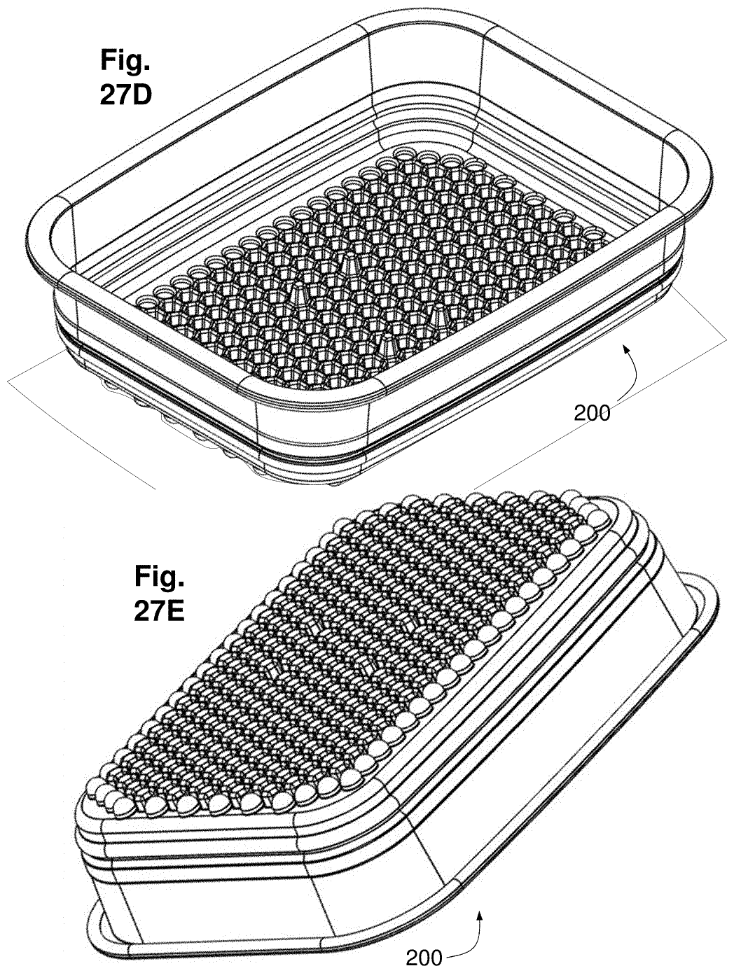

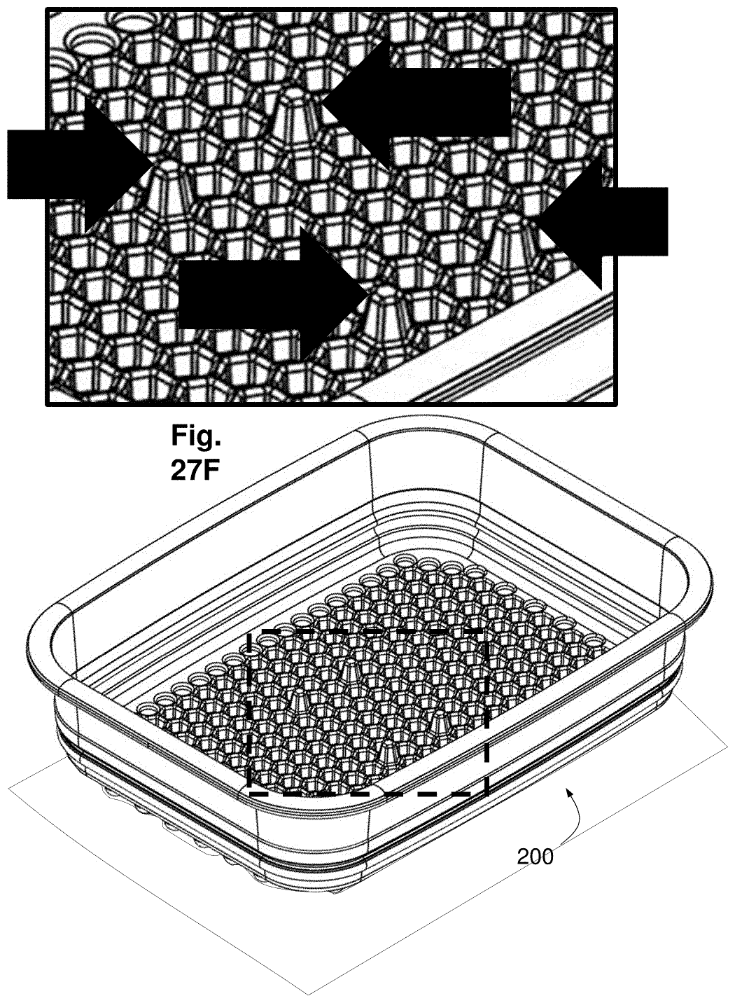

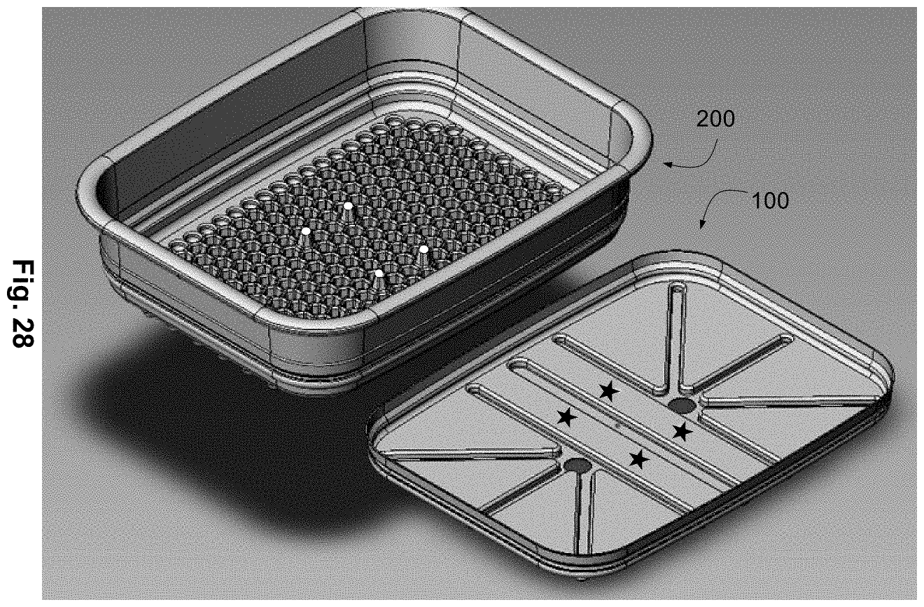

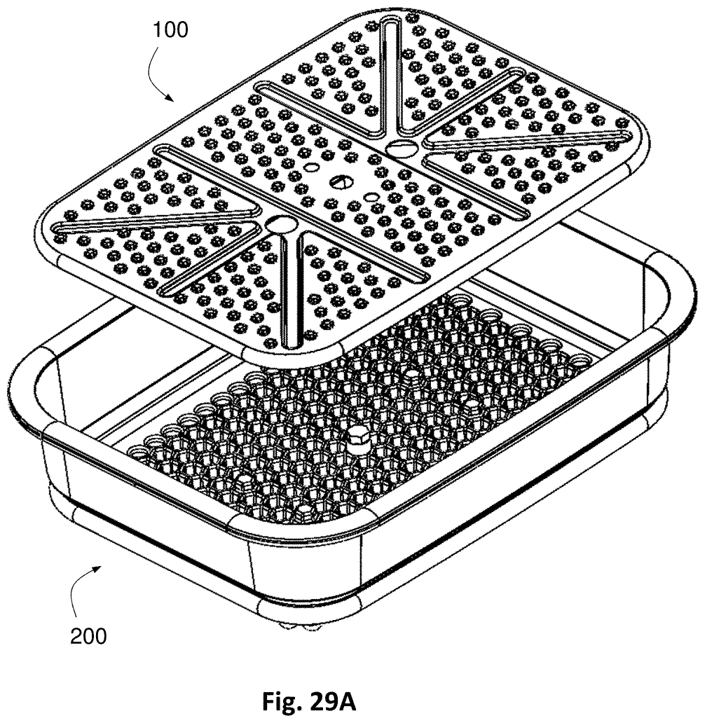

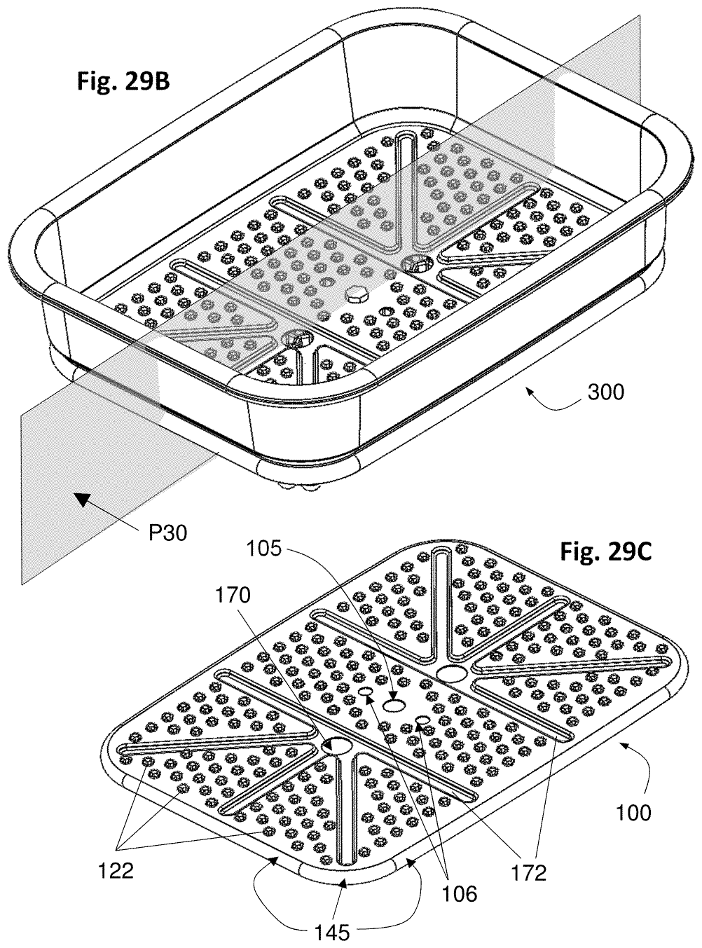

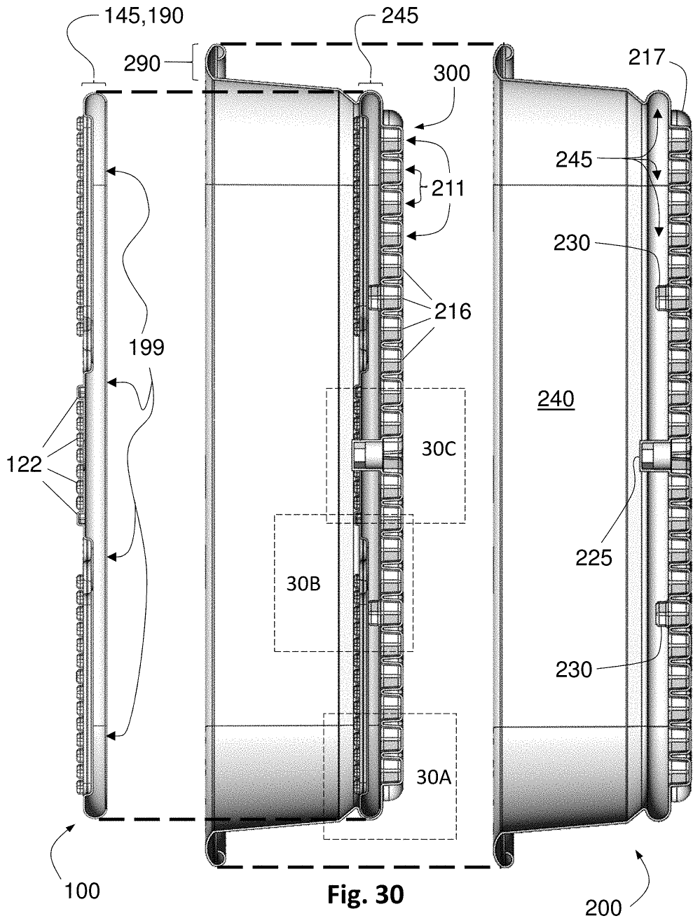

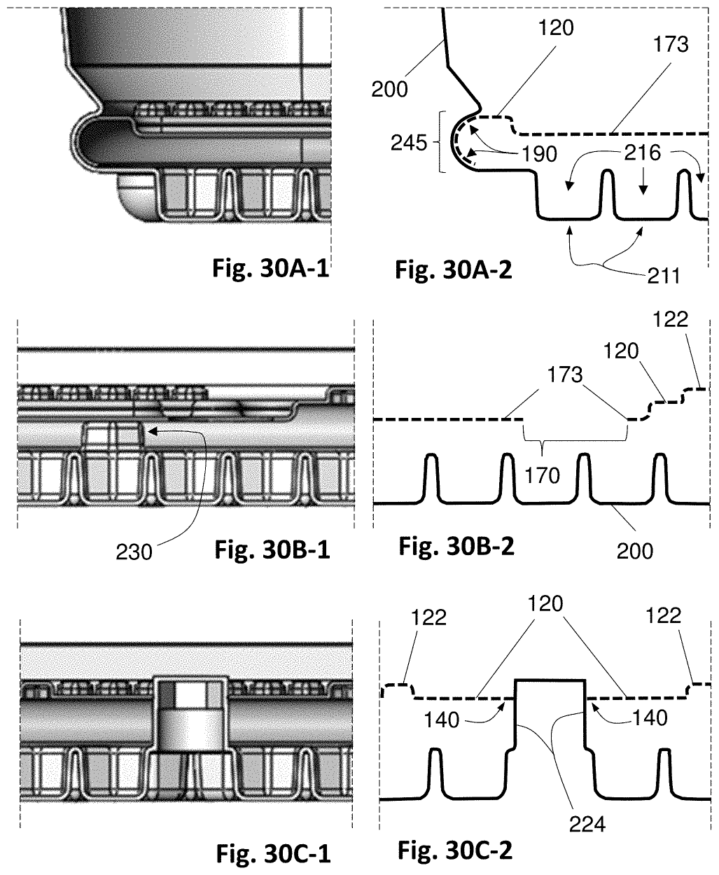

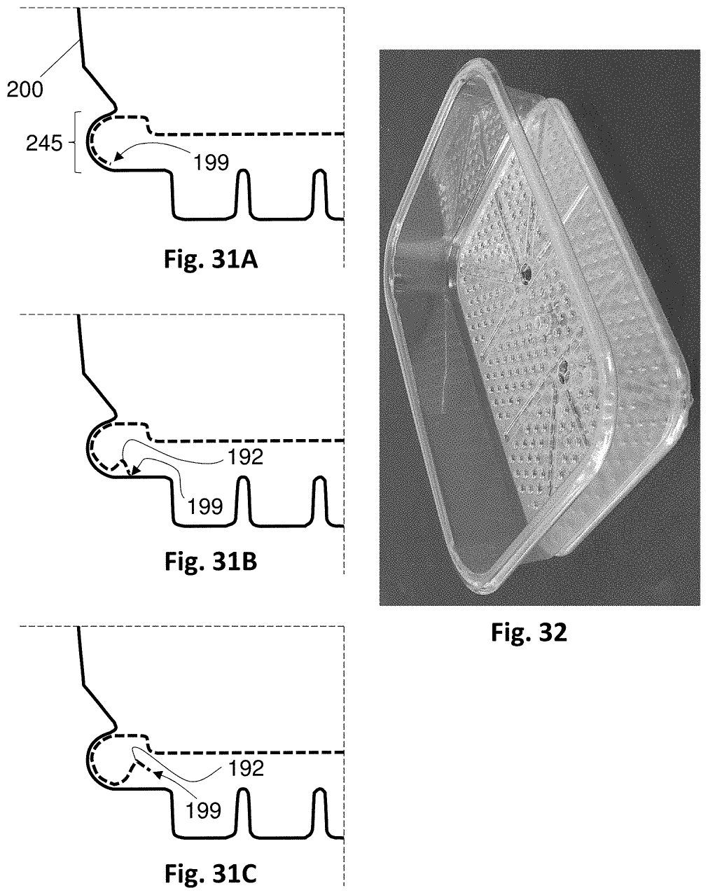

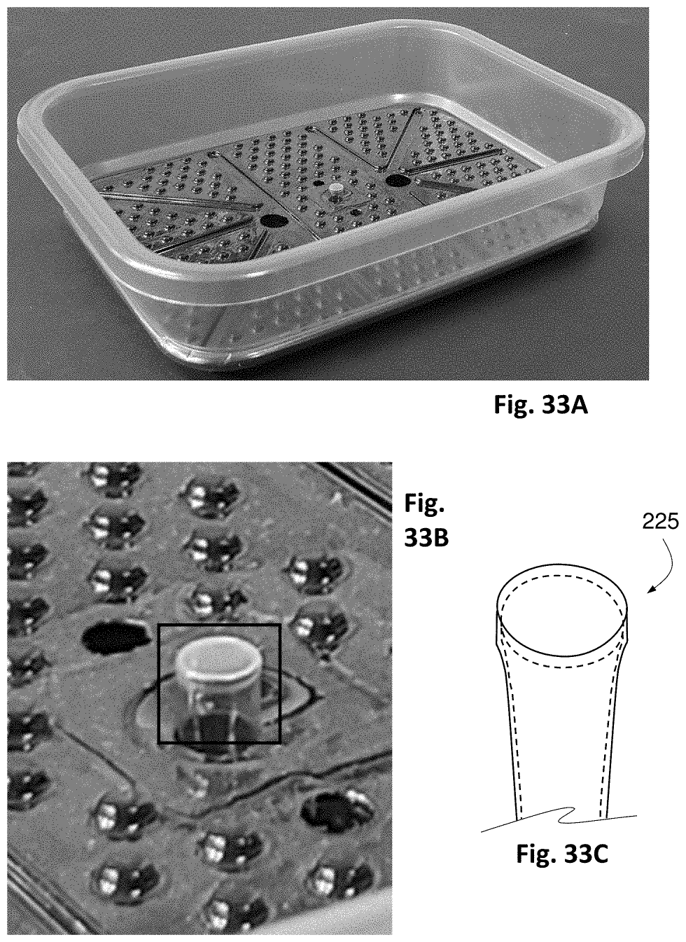

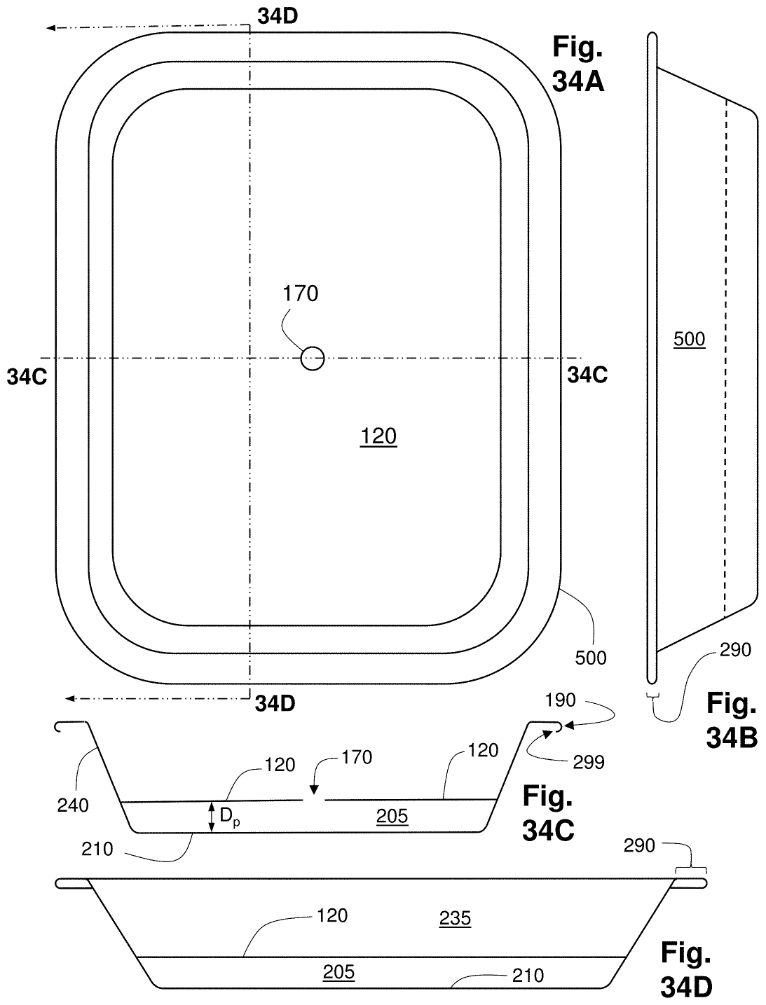

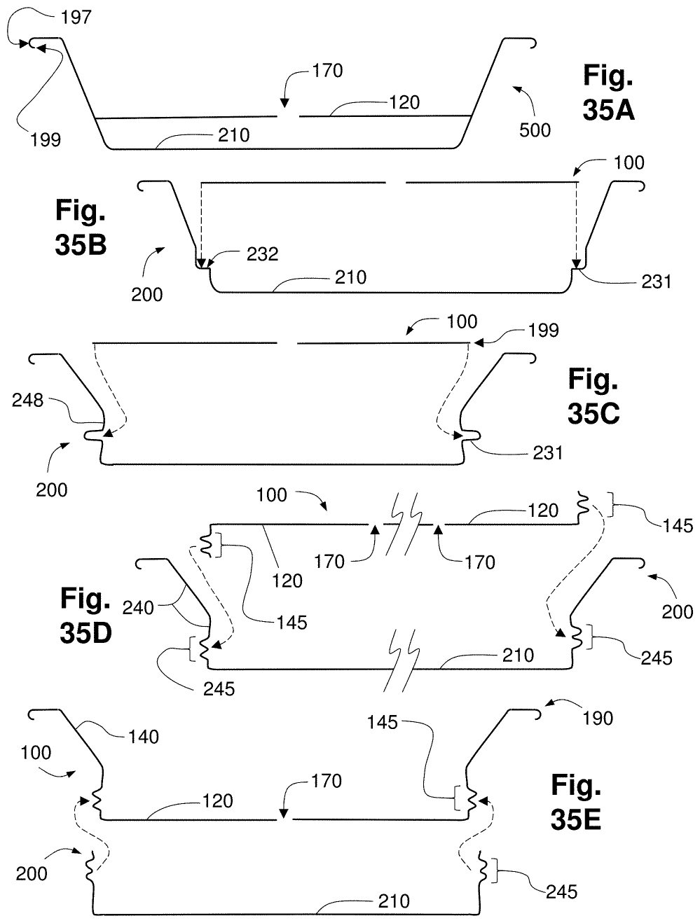

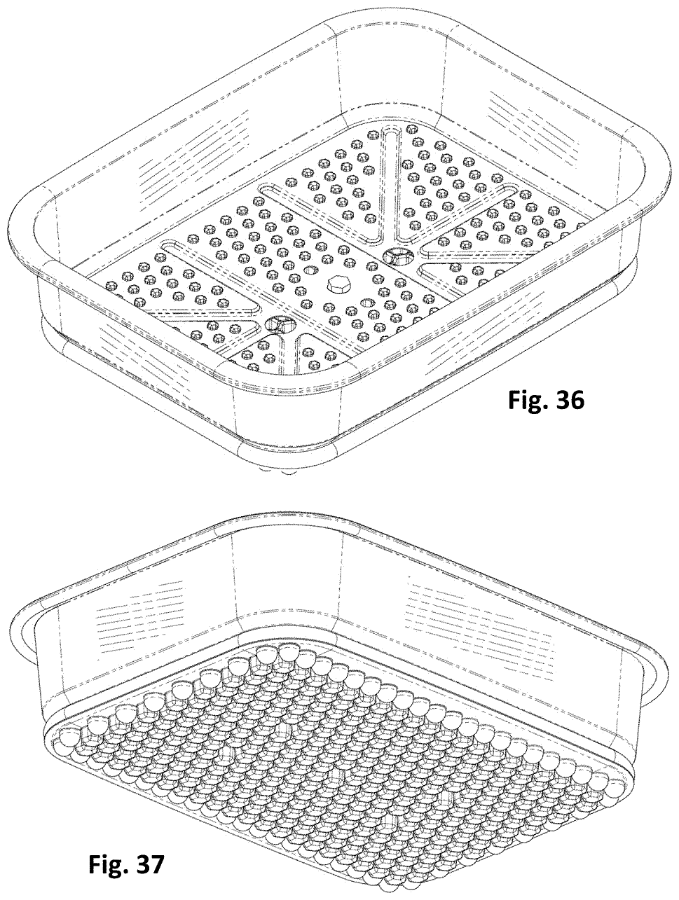

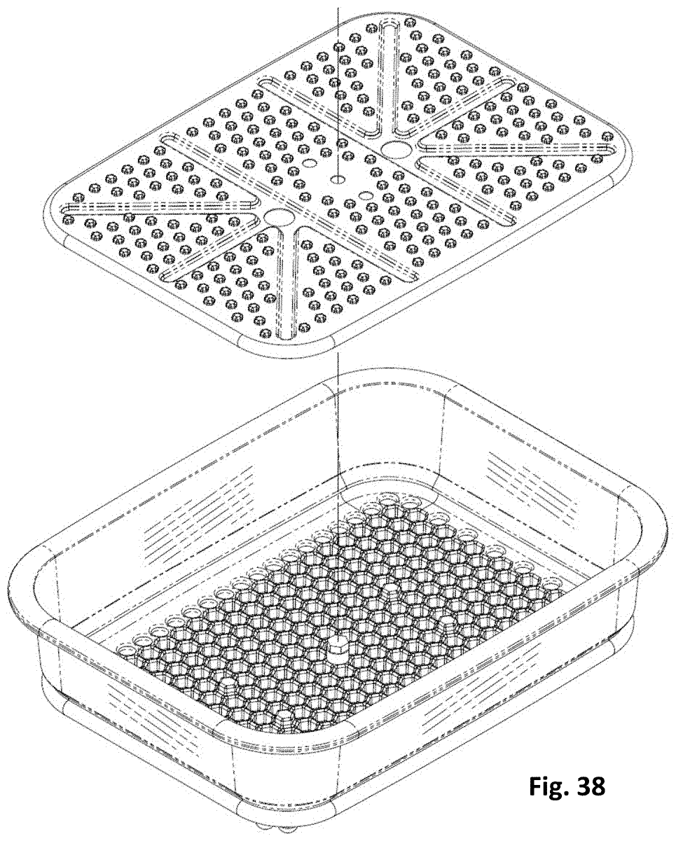

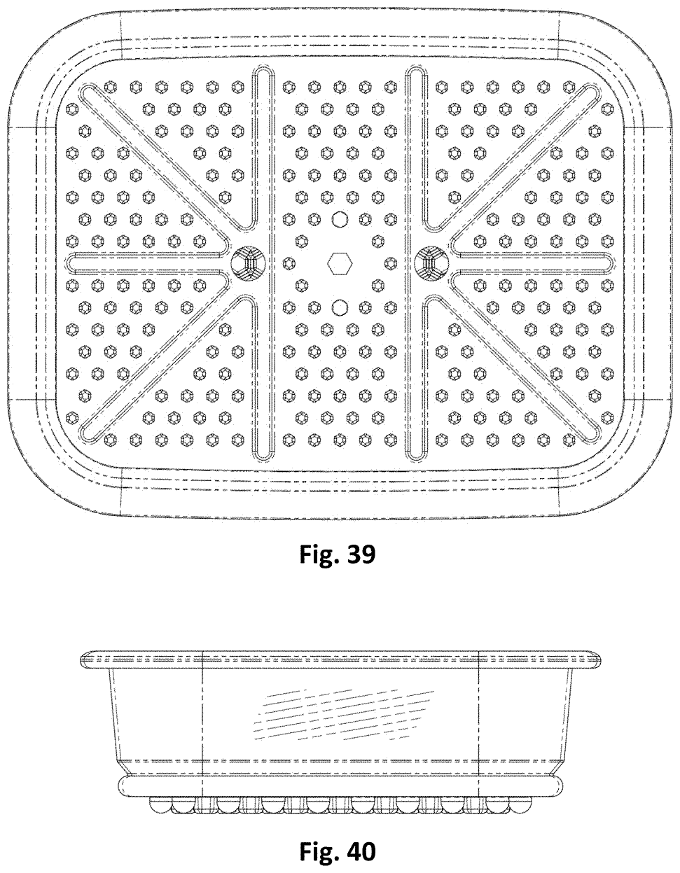

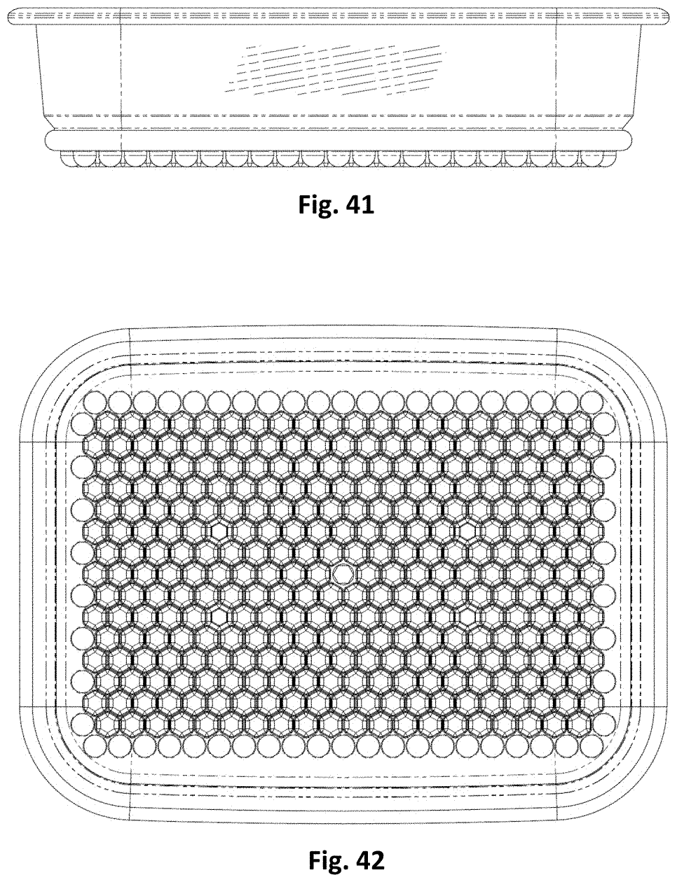

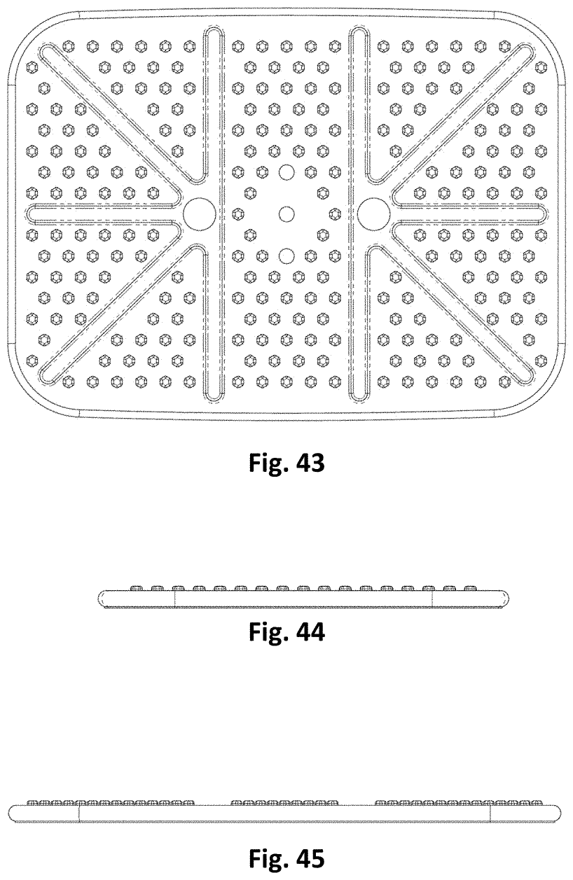

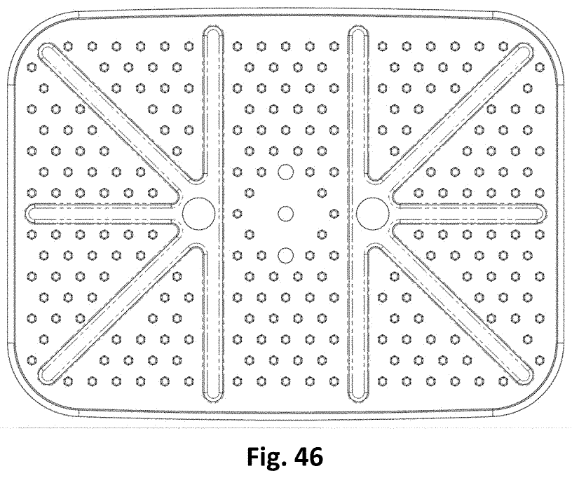

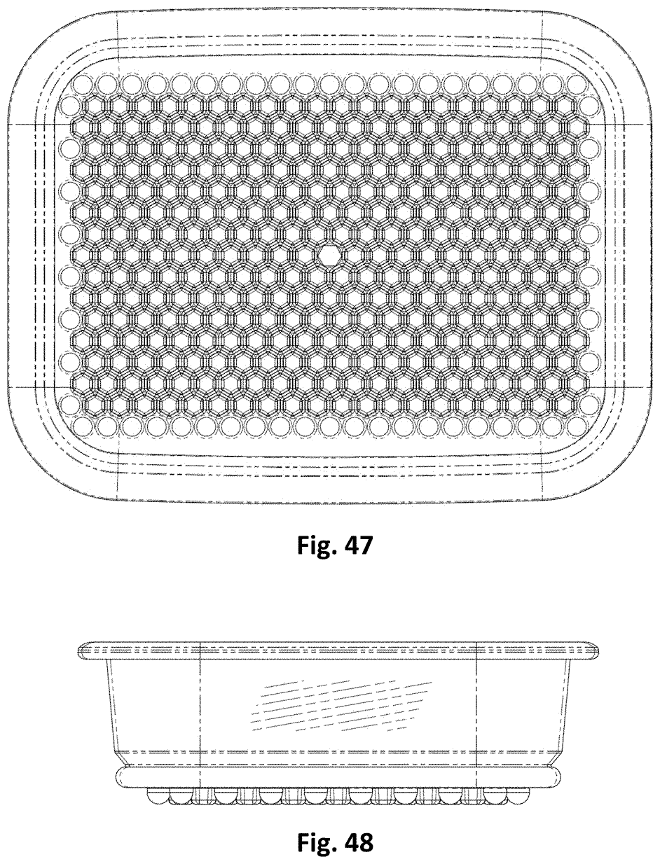

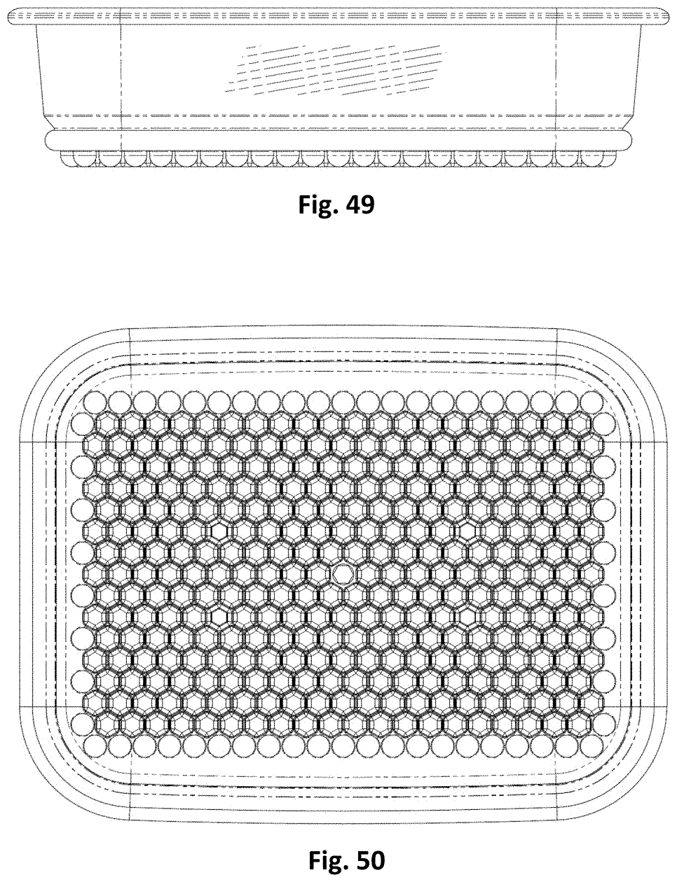

FIGS. 14A, 14B, 14C, and 14D illustrate a tray 300 consisting of the body 200 shown in FIG. 13, engaged with the insert 100 shown in FIGS. 9A-9F. FIG. 14A is an overhead view of the tray, taken above its open face. FIG. 14B is a long-edge view of the tray. FIG. 14C is a sectional view taken along line 14C-14C in FIG. 14A. FIG. 14D is a short-edge view of the tray. In FIG. 14C, it can be seen that the protrusions engage against the doors of the insert, positioning them in their open positions when the insert is engaged against the perimeter engagement zone of the body and dividing the interior of the tray into a storage compartment 301 and a reservoir compartment 303.

FIGS. 15A, 15B, 15C, and 15D illustrate another embodiment of the tray body 200 described herein. FIG. 15A is an overhead view above the open face of the body; labeled are the floor 210, twenty-two rounded truncated-cone-shaped protrusions 220, and a centrally-disposed support 230. FIG. 15B is a long-edge view of the exterior of the body 200, and FIG. 15D is a short-edge view. Because the body is depicted as opaque in these views and hidden lines are not used to depict internal features, those internal features cannot be seen in FIGS. 15B and 15D. FIG. 15C is a sectional view taken along line 15C-15C in FIG. 15A.

FIGS. 16A, 16B, 16C, and 16D illustrate a tray 300 consisting of the body 200 shown in FIG. 15, engaged with the insert 100 shown in FIGS. 9A-9F. FIG. 16A is an overhead view of the tray, taken above its open face. FIG. 16B is a long-edge view of the tray. FIG. 16C is a section taken at line 16C-16C in FIG. 16A. FIG. 16D is a short-edge view of the tray. In FIG. 16C, it can be seen that the protrusions (two visible in FIG. 16C) engage against the doors of the insert 100, positioning them in their open positions when the insert is engaged against the perimeter engagement zone 245 of the body 200. In FIG. 16C, it can be seen that the deflectable portions 135 of the doors engage against the protrusions, causing them to flex at their hinge portions 133 and causing each door edge 137 to become non-aligned with its corresponding frame edge 131.

FIGS. 17A, 17B, and 17C depict a substantially planar, rounded rectangular insert 100 having multiple doors 130 therein. FIG. 17A is an view above a planar face of the insert 100, showing each of the doors 130 in its closed position. FIGS. 17B and 17C are long-edge and short-edge views, respectively, showing the doors in their open positions.

FIG. 18 is an isometric view of an embodiment of the tray 300 described herein. The tray 300 consists of an open-topped tray body 200 having an insert 100 engaged therewith, the insert and the open end of the body defining a storage compartment 301.

FIGS. 19A and 19B illustrate the body 200 of the tray 300 shown in FIG. 18. FIG. 19A is an isometric view taken from above the open end of the body 200. The body has a floor and sidewalls which extend from the floor to a rim having a sealing surface 295 and an outer periphery 297. Within the interior 201 of the body, six protrusions 220 extend away from the floor into the interior, and a perimeter engagement zone 245 is present along the entire extent of the sidewalls at a constant height above the floor. FIG. 19B is an isometric view taken from above the underside of the floor of the inverted body 200 and illustrates the honeycomb-shaped fluid-retaining pattern 215 formed into the floor.

FIGS. 20A, 20B, and 20C illustrate an embodiment of the tray described herein. FIG. 20A is an isometric view taken from above the substantially flat platform 120 face of the insert 100 and illustrates that two doors 130 are defined therein by C-shaped gaps. FIG. 20B is a closer view of the portion of FIG. 20A enclosed in a dashed rectangle. In FIGS. 20A and 20B, it can be seen that an adaptor 150 surrounds the platform 120 of the insert 100, about the entire perimeter of the insert. FIG. 20C illustrates how the body 200 engages with the insert 100 (which is shown in two positions connected by a dashed arrow: an upper position in which it is not engaged with the body and a lower position in which it is engaged with the body).

FIGS. 21A and 21B depiction one embodiment of the insert 100 described herein. FIG. 21A is an isometric perspective drawing of the insert 100, which is made of a clear plastic (which is why the peripheral flange 142 thereof can be see about all four sides of the insert. In FIG. 21A, drainage channels 172 are present as depressions in the platform 120. FIG. 21B is an enlargement of the portion of FIG. 21A indicated by the dashed rectangle. In FIG. 21B are identified a door 130 and two orifices 170 which are positioned at intersections of drainage channels 172.

FIGS. 22A, 22B, 22C, 22D, 22E, 22F, and 22G are images an assembled tray 300 made by combining a body 200 and an insert 100 as described herein. FIGS. 22A and 22B are images of an insert 100 of the type depicted in FIGS. 22A and 22B, viewed with its platform 120 side up in FIG. 22A. The clear plastic insert is depicted against a herringbone pattern background (HPB) to facilitate visibility. The insert is shown with the platform 120 side down in FIG. 22B. FIG. 22C is an image of the body 200, set atop a herringbone fabric background (HFB) to facilitate visibility of the clear plastic tray. FIGS. 22D and 22E are closer images of one of the protrusions 220 on the floor of the body and the fluid-retaining pattern 215 molded into the floor of the body. FIG. 22D is an image taken from above (i.e., through the open rim) of the body, while 22E is an image taken from beneath the floor (i.e., the surface upon which the body rests in FIG. 22C). FIG. 22F is an image of the insert 100 propped against the rim and three protrusions of the body 200. FIG. 22G is an image of the assembled tray 300, in which the insert and body shown in FIG. 22F have been snapped together (i.e., the adapter on the peripheral flange of the insert being snugly opposed against the perimeter engagement zone of the body, which is located peripherally around and just above (i.e., toward the rim) of the floor of the body.

FIGS. 23A, 23B, 23C, 23D, 23E, and 23F are images of a body 200, an insert 100 having multiple C-shaped doors, and an assembled tray 300. FIGS. 23A and 23B are images from above the open rim (FIG. 23A) and from beneath the floor (FIG. 23B) of a body 200 having four ridge-shaped protrusions 220 arising from its floor (indicated by arrows at each end. FIGS. 23C and 23D are images of an insert 100 having four C-shaped doors defined by gaps in the platform thereof; the doors are numbered 1-4, and an ‘X’ is drawn on the platform surface using black ink. FIG. 23C shows the insert before, and FIG. 23D shows the insert after insertion of a piece of paper (P) into the gap of door 4, beneath door 4, and emerging through the gap of door 3. FIGS. 23E and 23F are images of an assembled tray 300 in which doors (labeled 1 and 2) in the insert of the tray are deflected by ridge-shaped protrusions in the body. In this tray, the body is essentially identical to the body shown in FIGS. 23A and 23B, while the insert differs from the insert shown in FIGS. 23C and 23D in that this insert has only two doors and has a line drawn on its platform surface using black ink. FIG. 23E shows the tray before, and FIG. 23F shows the tray after insertion of a piece of paper (P) into the gap of door 1, beneath doors 1 and 2, and emerging through the gap of door 2.

FIGS. 24A, 24B, and 24C are isometric views of an assembled tray 300 as describe herein. FIG. 24A is a diagram which depicts insertion of an insert 100 into a body 200 to yield an assembled tray 300. FIGS. 24B and 24C are sectional views, taken at plane P24 in FIG. 24A, in which the positions of the insert (FIG. 24B) and the body (FIG. 24C) are highlighted (by increasing the thickness of the corresponding line in the figure) in the assembled tray.

FIGS. 25A, 25B, 25C, 25D, 25E, 25F, and 25G illustrate engagement of the insert 100 with the tray body 200. FIG. 25A depicts a tray body 200 and an insert 100 selected to fit within and engage the body. The insert has several fluid drainage channels 172 formed in its surface. FIGS. 25B, 25C, and 25D are sectional views of a portion of the body (FIGS. 25B and 25D) taken along plane 25B in FIG. 25A and a portion of the insert (FIGS. 25C and 25D) taken along plane 25C in FIG. 25A. FIGS. 25B and 25C depict the body (25B) and insert (25C) before assembly, and FIG. 25D depicts the corresponding sections in an assembled tray 300. FIGS. 25E, 25F, and 25G are sectional views of a portion of the body (FIGS. 25E and 25G) and a portion of the insert (FIGS. 25F and 25G) taken along a plane not shown FIG. 25A, and highlight that the position of the drainage channels 172 and the supports 230 are, in this embodiment, selected so that the platform 120 of the insert 100 rests against the top of the support, while the fluid drainage channels do not contact the support. FIGS. 25E and 25H also depict a perimeter engagement zone 245 different from the one depicted in FIGS. 25B and 25G.

FIGS. 26A, 26B, 26C, 26D, and 26E are views of an embodiment of an insert 100 described herein. FIGS. 26A, 26B, and 26C are orthographic short side, overhead, and long side views of the insert, respectively. FIGS. 26D and 26E are isometric views of the insert in its upright (26D) and inverted (26E) positions.

FIGS. 27A, 27B, 27C, 27D, 27E, and 27F are views of an embodiment of a tray body 200 described herein. FIGS. 27A, 27B, and 27C are orthographic overhead, long side, and short side views of the body, respectively. FIGS. 27D and 76E are isometric views of the body in its upright (27D) and inverted (27E) positions. FIG. 27F is a copy of and detail (inset) of the isometric view shown in FIG. 27D, with the inset magnified to better display the four supports 230 which rise above the honeycomb-like pattern that surrounds them.

FIG. 28 is an isometric view of a tray body 200 as shown in FIG. 27A-27F and an insert 100 as shown in FIGS. 26A-26E. The sizes and shapes of the body and insert are selected so that the adaptor of the insert snugly fits against and forms a fluid-tight seal with the perimeter engagement zone of the body. In this image, the supports 230 shown in greater detail in FIG. 27F are marked with white circles and the corresponding portions of the insert, the underside of which impact against the supports when the insert is installed within the body, are marked with black stars.

FIGS. 29A, 29B, and 29C are drawings which depict a tray body 200 and an insert 100 that is nestable therein. FIG. 29A depicts the insert positioned above the concave interior of the tray body 200 at approximately the position it occupies when installed therein. FIG. 29B depicts an assembled tray 300, and a shaded plane intersects the tray along its long axis. FIG. 29C depicts the insert 100 alone. Indicia in FIG. 29C identify the central socket 105, a pair of vents 106, drainage channels 172 which fluidly communicate with orifices 170. Also depicted are the adaptor 145 which nests against the perimeter engagement zone of the body when installed and numerous protrusions 122 which are formed into the top surface of the insert 100.

FIG. 30 is a composite of an assembled cutaway view and an exploded cutaway view of one embodiment of an assembled tray 300 described herein, the cut made along plane P30 in FIG. 29B. In FIG. 30, the center image depicts the assembled tray 300, while the left image depicts the insert 100 and the right image depicts the tray body 200. In the center image, it can be seen that the adaptor 145 (here, a rolled edge 190) and the peripheral edge 199 of the insert 100 are contained within the curved perimeter engagement zone 245 of the tray body 200 when the tray is assembled. Dashed lines extending between the left and center images and between the right and center images indicate the relative positions of the insert 100 and the tray body 200 in the assembled tray 300.

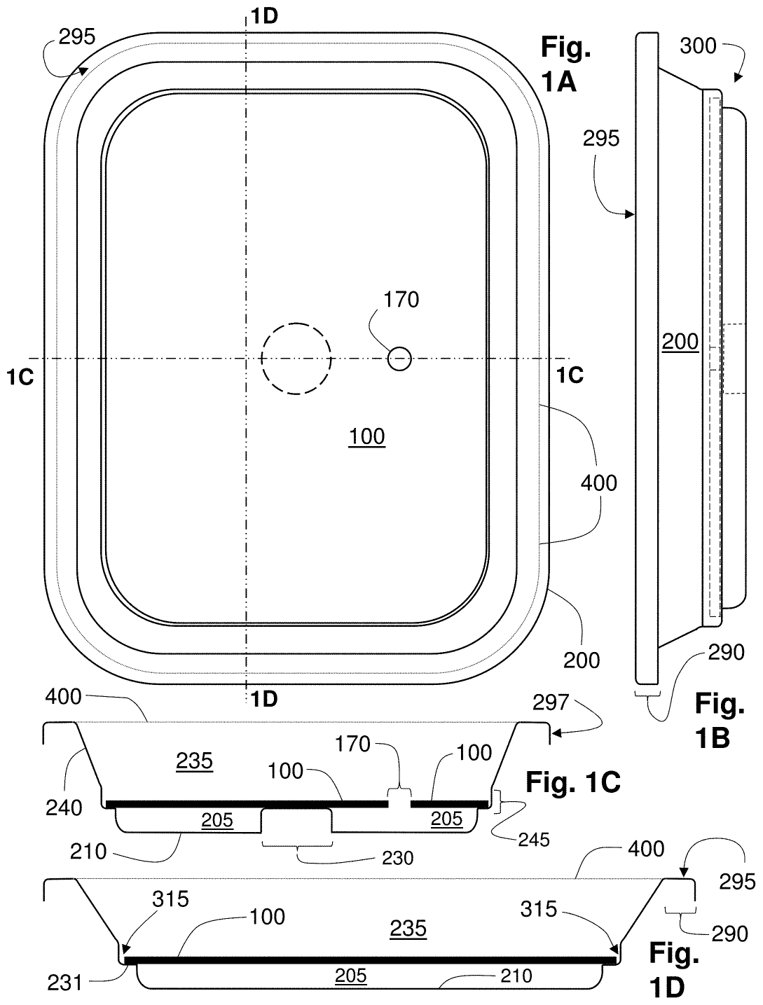

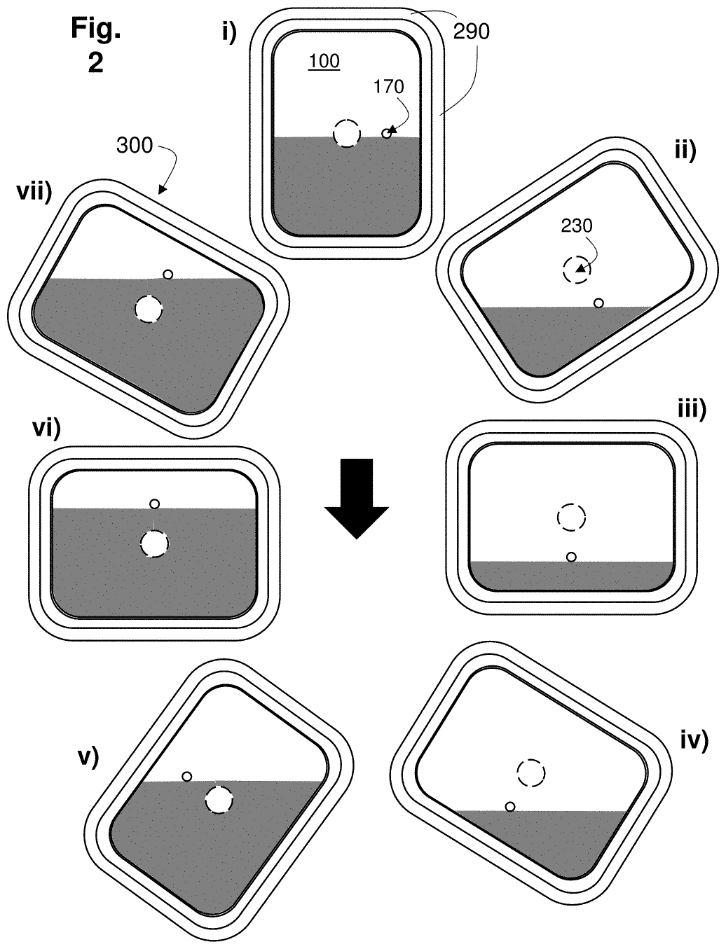

FIGS. 30A-1 and 30A-2 correspond to the portion of FIG. 30 contained within dashed box “30A” in FIG. 30. FIG. 30A-1 is an enlarged view of the cutaway view in FIG. 30 (the light dashed lines corresponding to portions of dashed box “30A”). FIG. 30A-2 is a sectional diagram which depicts the portions of the insert 100 (depicted as a dashed line) and the tray body 200 (depicted as a solid line) that are intersected by plane P30 in FIG. 29B (the light dashed lines corresponding to portions of dashed box “30A”). In these views, engagement of the rolled edge 190 of the insert against the interior surface of the perimeter engagement zone 245 of the tray body 200 can be seen. Also visible are multiple hexagonal fluid cells 216 formed in the tray body 200 and the platform 120 and fluid channel floor 173 surfaces of the insert.

FIGS. 30B-1 and 30B-2 correspond to the portion of FIG. 30 contained within dashed box “30B” in FIG. 30. FIG. 30B-1 is an enlarged view of the cutaway view in FIG. 30 (the light dashed lines corresponding to portions of dashed box “30B”). FIG. 30B-2 is a sectional diagram which depicts the portions of the insert 100 (depicted as a dashed line) and the tray body 200 (depicted as a solid line) that are intersected by plane P30 in FIG. 29B (the light dashed lines corresponding to portions of dashed box “30B”). In these views, the separation maintained between the floor 173 of the drainage channel and the tray body 200 in the insert in the vicinity of the orifice 170 (caused by opposition of the support 230 against the underside of the insert) is visible. Also visible are the relative heights above the tray body 200 of the floor 173 of the drainage channel, the platform 120, and the protrusions 122 of the insert.

FIGS. 30C-1 and 30C-2 correspond to the portion of FIG. 30 contained within dashed box “30C” in FIG. 30. FIG. 30C-1 is an enlarged view of the cutaway view in FIG. 30 (the light dashed lines corresponding to portions of dashed box “30C”). FIG. 30C-2 is a sectional diagram which depicts the portions of the insert 100 (depicted as a dashed line) and the tray body 200 (depicted as a solid line) that are intersected by plane P30 in FIG. 29B (the light dashed lines corresponding to portions of dashed box “30C”). In these views, snug engagement of the shaft 225 of the body against portions of the platform 120 of the insert can be seen. Also visible are two protrusions 122 formed in the platform 120 surface of the insert.

FIGS. 31A, 31B, and 31C depict the same portion of FIG. 30 as is shown in FIG. 30A-2. FIG. 31A is a copy of FIG. 30A-2 and illustrates that, when the rolled edge of the insert lacks an elbow and peripheral flange, the peripheral edge 199 of the insert can lie flush against the interior of the perimeter engagement zone 245 of the body 200. FIG. 31B depicts an embodiment in which the insert includes a peripheral flange extending between an elbow 192 and the peripheral edge 199 of the insert, wherein the peripheral edge is resiliently urged against the body. FIG. 31C depicts an embodiment in which the insert includes a peripheral flange extending between an elbow 192 and the peripheral edge 199 of the insert, but wherein the peripheral edge does not contact the body when the insert is installed therein.

FIG. 32 is an image of an embodiment of the tray described herein. Both the body and the insert of the tray visible in this image was made from clear plastic (PET) sheet material. It can be seen from the image that the optical clarity of the sheet material has been maintained throughout every portion of the tray, including throughout the rolled edge of the body (visible at the outer portion of the rim, which occurs at the left extent of the tray in this image) as well as throughout the tolled edge of the insert (visible at the right-most extents of the tray in this image, where the rolled-edge/adaptor portion of the insert is nested within the semi-circular engagement portion of the body, which is also optically clear). It can also be seen from this image that the shaft extending from the floor of the body extends through the insert, that two small round vent holes perforate the insert adjacent the socket hole through which the shaft extends, that two larger orifices perforate the insert (above and slightly to the left of the shaft and below and slightly to the right of the shaft in this image), that five straight fluid channels communicate with each of the orifices, and that numerous bumps are formed into the surface of the insert, the bumps extending upwardly away from the lower surface of the tray (which is towards the right in this image). The same tray is depicted diagrammatically in FIGS. 29B and 30.

FIGS. 33A, 33B, and 33C depict another embodiment of the tray described herein. This embodiment resembles the embodiment shown in FIG. 32, except that the insert is made from dark, opaque plastic (in contrast to the optically clear plastic insert in FIG. 32) and that the peripheral edge of the body is not rolled (a thin peripheral flange surrounds the vertical portion of the rim about the perimeter of the tray, the peripheral flange being bounded by the vertical portion at one extent and at a potentially sharp peripheral edge of the body at the other extent). FIG. 33A is an image of the tray resting upon a horizontal surface, the image taken from above the nearest corner of the tray. The two orifices are clearly visible as dark ovals, and the upper end of the shaft extending from the floor of the body can be seen as a white portion near the center of the interior of the tray. The two vent holes extending through the insert are also visible adjacent the shaft, as can be seen in FIG. 33B, which is an enlargement of this portion. FIG. 33C is a diagram which illustrates a difficult-to-see aspect of the clear shaft, which is highlighted within the square superimposed upon FIG. 33B. The interior surface (shown as dashed lines) of the shaft 225 largely parallels the contours of the exterior surface (shown as dashed lines) of the shaft 225, except at the portion of the shaft most distal from the floor. As shown in the diagram of FIG. 33C (in which scale has been deliberately exaggerated to highlight this feature), the distal portion of the shaft has a larger outer diameter than do less-distal portions of the shaft. As a result, the closely-opposed collar region of the insert (which contacts the shaft in the image in FIG. 33B) must be “snapped over” the larger-diameter most-distal end of the shaft, and thereafter rebounds to become opposed against the narrower-diameter less-distal portions of the shaft. This feature serves to hold the insert in place and prevent its dissociation from the shaft and from the body.

FIGS. 34A, 34B, 34C, and 34D are diagrams which depict a unitary tray 500, as described herein. FIG. 34A is an overhead view taken from above the open top of the unitary tray 500, looking into the interior at the platform 120 surface, through which an orifice 170 extends. FIG. 34B is a side view of the unitary tray 500 in which it can be seen that the rim 290 has a smooth peripheral surface. FIG. 34C is a section of the unitary tray taken along line 34C-34C in FIG. 34A; the section bisects the orifice 170 in the platform 120 and illustrates how the reservoir space 205 (bounded by platform 120, floor 210, and sidewalls 240) is in fluid communication with the rim-side surface of the platform by way of the orifice. Also visible in this section is the profile of the rolled edge 190 on the rim of the tray. FIG. 34D is a sectional view of the unitary tray taken along line 34D-34D in FIG. 34A; the view illustrates that the reservoir space 205 is closed except for its communication with the storage space 235 within the interior of the tray above the platform by way of the orifice. This view also highlights that the peripheral edge 199 of the unitary tray is turned or rolled to an orientation that is directed substantially anti-peripherally.

FIGS. 35A, 35B, 35C, 35D, and 35E are diagrams which illustrate tray configurations described herein, each illustrated in a sectional view like that shown in FIG. 34C. FIG. 35A illustrates a unitary tray 500. FIG. 35B illustrates a tray consisting of a flat insert 100 which rests flush upon a circumferential shelf 231 which extends about the floor 210 of a tray-shaped body 200. FIG. 35C illustrates a tray consisting of a flat insert 100 which is installed between an overhang 248 and a shelf 231, each of which extends inwardly from the sidewalls 240 of a tray-shaped body 200. FIG. 35D illustrates a tray in which an insert 100 having a substantially flat platform 120 surrounded by downwardly-extending (left half of the figure) or upwardly-extending (right half of the figure) adaptor 145 which can be installed in a closely-opposed configuration with an complementary engagement region 245 of a tray-shaped body 200. FIG. 35E illustrates a jacketed tray in which a tray-shaped insert 100 having circumferential sidewalls 140 surrounding a substantially flat platform 120 bearing an orifice 170 therethrough has a circumferential adaptor 145 which can be installed in a closely-opposed configuration with an complementary engagement region 245 of a tray-shaped body 200.

FIG. 36 is a top perspective view of an embodiment of the tray as described herein, the tray consisting of assembled components made from an opaque thermoplastic, including an insert installed within a body.

FIG. 37 is a bottom perspective view of the tray illustrated in FIG. 36.

FIG. 38 is an exploded top isometric view of the tray illustrated in FIG. 36, with the insert shown separated from the body.

FIG. 39 is a top view of the assembled tray illustrated in FIG. 36.

FIG. 40 is a side view of the assembled tray illustrated in FIG. 36. The right and left views are identical.

FIG. 41 is a front view of the assembled tray illustrated in FIG. 36. The front and rear views are identical.

FIG. 42 is a bottom view of the assembled tray illustrated in FIG. 36.

FIG. 43 is a top view of the insert component of the tray illustrated in FIG. 36.

FIG. 44 is a side view of the insert component of the tray illustrated in FIG. 36.

The right and left views are identical.

FIG. 45 is a front view of the insert component of the tray illustrated in FIG. 36. The front and rear views are identical.

FIG. 46 is a bottom view of the insert component of the tray illustrated in FIG. 36.

FIG. 47 is a top view of the body component of the tray illustrated in FIG. 36.

FIG. 48 is a side view of the body component of the tray illustrated in FIG. 36.

The right and left views are identical.

FIG. 49 is a front view of the body component of the tray illustrated in FIG. 36. The front and rear views are identical.

FIG. 50 is a bottom view of the body component of the tray illustrated in FIG. 36.

### DETAILED DESCRIPTION

The disclosure relates to trays which facilitate segregation of liquid from one or more article present in a storage space of the tray. In an important embodiment, the disclosure relates to plastic food trays which can capture substantial amounts of fluid in a reservoir compartment separate from the food-storage compartment and which will tend not to release fluid from the reservoir compartment back into the food-storage compartment owing to normal handling (e.g., by shippers, retailers, and retail customers) of the package.

Several aspects of the trays described herein can be understood by reference to a difficult-to-manufacture unitary tray depicted in FIGS. 34A-34D. Additional aspects relate to embodiments which can be more practically and easily manufactured, given the importance of inexpensive and rapid production for trays needed to contain foodstuffs and other materials in an economically-practical fashion.

Referring to FIGS. 34A-34D, an important aspect of the trays described herein is that they include at least one platform 120 bounded by the sidewalls 240 and at least one floor 210, distinct from the platform and separated therefrom, the floor also laterally bounded by the sidewalls. The space between the platform(s) and the floor(s) within the sidewalls defines a reservoir space 205. The tray also has a rim 290 formed by or attached to the sidewalls, the rim being positioned above (i.e., in the direction opposite the direction of the floor) the platform, thereby defining a concave storage space 235 bounded by the platform and the sidewalls and the volume of space between the platform and the rim. At least one orifice 170 extends through the platform and facilitates fluid communication between the storage space and the reservoir space. The rim has a smooth periphery formed by a rolled- or turned-over edge, which facilitates wrapping of the tray and its contents within a fragile plastic film. In the embodiment pictured, the rim also has a flat upper surface, which facilitates attachment of plastic film or other material thereto, whether by heat- or sonic-fusion or by adhesion. The rim also serves to rigidify the tray generally and to facilitate its handling by automated machinery.

In use, a tray as shown in FIGS. 34A-34D can store foodstuffs or other materials in the storage space 235, separated from liquid which can flow into and be contained within the reservoir space 205. This is because liquid which might be present in the storage space will be drawn by gravity through the orifice 170 and into the reservoir space when the floor of the tray is maintained horizontally with the platform 150 maintained gravitationally above the floor. The orifice has a size which excludes passage of any substantial amount of the foodstuff therethrough, meaning that foodstuffs will be retained. Furthermore, because the single orifice in the embodiment pictured in these figures is centrally located and because the platform is sealed in a substantially fluid-tight fashion against the sidewalls and/or floor, significant volumes of liquid can be retained in the reservoir space even when the floor of the tray is maintained gravitationally vertically (i.e., much liquid can be held within the reservoir space without spilling through the orifice into the storage space in this configuration). Even if the tray is held “upside-down” (i.e., with the floor gravitationally higher than the platform), even slight deviations from horizontality will permit significant quantities of fluid to be retainable within the reservoir space.

Significantly, all parts of the tray are made from a single type of material. Because many plastics are recyclable, in a practical sense, only when recycled together only with plastic of the same (or very similar) composition, this feature of the trays described herein significantly improves the recyclability of the trays relative to prior trays, which sometimes included components made from non-identical materials. Furthermore, the trays described herein eliminate the need to include an absorbent pad or other material to sequester liquid. The presence of such pads or materials and adhesives used to secure them to prior trays inhibited recyclability of prior trays. Even if trays described herein are soiled with materials (e.g., liquids exuded from foodstuffs or solids precipitated from such liquids), it is commonplace to thoroughly wash shredded recyclable plastics prior to recycling. Thus, the ability of the trays described herein to capture fluids and other materials within the reservoir space does not significantly inhibit their recyclability, even if the platform 120 is not removed from the remainder of the tray prior to recycling.

This overview has highlighted several significant features of the trays described herein. In the following sections, several different embodiments of such trays are described, differing in construction and interaction of their components. In subsequent sections, important aspects of various features (e.g., the orifice 170 and conformations of the platform 120 and floor 220) are described in greater detail, independent of the construction and components of the trays in which those features occur.

FIGS. 35A-35E are sections taken through various embodiments of the trays described herein and illustrate various ways of constructing the trays. FIG. 35A (which is substantially identical to FIG. 34C) depicts a section through a unitary tray. FIGS. 35B, 35C, and 35D depict sections through a tray having an insert 100 held in place against a tray body 200 by various means described herein. FIG. 35E depicts a section through a jacketed tray in which an insert 100 having a perforated platform, sidewalls 140, and a rim with a rolled edge 190 is held in place against a body 200.

A Unitary Tray Embodiment

The unitary tray is made from a single piece of material, and is illustrated in FIGS. 34A-34D. The unitary tray includes circumferential sidewalls 240 which are integral with and completely surround a floor 210. The sidewalls 240 are also integral with and surround a platform 120 that is perforated with at least one orifice 170. The orifice 170 extends through the platform 120 and fluidly connects a reservoir space 205 and a storage space 235. The reservoir space 205 exists between the upper surface of the floor 210 and the lower surface of the platform 120 and that is bounded by the sidewalls 240. The storage space 235 is bounded by the upper surface of the platform 120 and the sidewalls 240 which surround the platform 120, but is “open” at the rim 290 of the tray. The open face of the storage space permits items (e.g., cuts of poultry or meat) to be placed in the storage space 235. In many instances, the open face of the storage space 235 will become closed when a plastic film or a fitted cover is sealed against the rim 290 and/or against the peripheral edge 199 of the tray, whereupon any items in the storage space 235 will be contained between the unitary tray 500 and the film or cover sealed against it. Typically, the platform 120 will be oriented substantially parallel to the floor 210, so that any fluid which is present in the storage space 235 is able to flow onto and across the face of the platform 120, downward through the orifice 170, into the reservoir space 205 and onto the floor 210 when the tray is maintained with its floor in a horizontal orientation. Also, all orifices will typically be centrally positioned on the platform, which enables the tray to contain more liquid in the reservoir space when the tray is held vertically than is possible when orifices are positioned near the platform-sidewall intersection. If it is desired to facilitate drainage of fluid from the reservoir space, then an orifice can be positioned near one edge of the platform-sidewall intersection, in which case fluid will tend to drain out of the reservoir space when the tray is held with its floor substantially vertical and with that end at the bottom of the vertical tray.

Turning specifically to the tray depicted in FIGS. 34A-34D, the tray 500 has the general shape of a rimmed tray with sidewalls 240 which completely surround the planar floor 210 of the tray and which slope inwardly from a wider rim 290 to the narrower planar floor. The floor is also integral with each of the sidewalls, such that when the floor rests upon a horizontal surface and the sidewalls are oriented above the floor, liquid can be contained above the floor and within the sidewalls. Disposed a set distance (here denoted “D_{P}”) above the floor is a platform 120 which is integral with the sidewalls and intersects the sidewalls at the perimeter of the sidewalls at height D_{P} above the floor. In this embodiment, the platform is parallel to the floor. The platform bears an orifice 170 that extends through the platform between its upper and lower surfaces, and fluids such as air, other gases, and liquids such as water or meat exudate can pass from the upper surface to the lower surface of the platform by way of the orifice (see FIG. 34C). The lower surface of the platform and the upper surface of the floor define a reservoir space 205 (see FIGS. 34C and 34D) that is also bounded by the four sidewalls which are integral with both the platform and the floor. In this embodiment, the orifice is the only space through which fluid can flow between the reservoir space and the space above the surface of the platform. The tray bears a perimeter rim at the uppermost (i.e., farthest from the floor) end of the sidewalls. The rim extends completely about the perimeter of the tray and has a rolled edge 190 that causes the peripheral edge 299 of the tray to be disposed inwardly from the outer perimeter of the tray; instead, the outer perimeter is defined by a smooth rounded portion of the rolled edge.

As an illustration of the liquid-sequestering function of the trays described herein, consider the tray illustrated in FIGS. 34A-34D having an ice cube placed upon the upper surface of the platform thereof (the surface 120 visible in FIG. 34A) and then wrapped within a plastic film that is snugly fitted against the rim 290 surface and the rolled edge 190, and the film is sealed against itself as is common in food-wrapping operations, yielding a package that is impermeable to water (water external to the package cannot reach the interior of the package, and liquid water within the package cannot leak out. If the wrapped, ice cube-containing, water-impermeable package is placed with its floor upon a horizontal surface in a warm place, the ice cube will melt, generating liquid water upon the surface of the platform. Because the platform is parallel to the floor, the generated water will spread horizontally upon the platform, with some water eventually reaching the orifice 170. Water which reaches the orifice will pour, under the influence of gravity, into and through the orifice and into the reservoir space 205. Within the reservoir space, the water will drip from the orifice onto the floor 210 and/or trickle along the bottom surface of the platform, downwardly along a sidewall 240 adjacent the bottom surface of the platform, and onto the upper surface of the floor. Once contained within the reservoir space, the liquid water will tend to remain there unless and until vaporized (water vapor can diffuse upwardly through the orifice). If the tray having liquid water in its reservoir space is rotated out of the horizontal plane to the extent that that the floor of the tray is vertical with respect to the horizontal surface and the tray stands on the rounded edge 190 of one of its perimeter edges, then the liquid water will trickle, under the influence of gravity, into the space adjacent the intersection of the platform and the sidewall of the gravitationally lowest perimeter edge, forming a pool or puddle of water bounded by the platform, the sidewall, and (if sufficient water is present) the floor. Even in this vertical orientation, water will be retained between the floor and the platform so long as the vertical depth of the water does not reach the edge of the orifice that extends through the platform. If water depth equals or exceeds that depth, water can pass through the orifice out of the reservoir space and into the storage space 235 defined by the upper surface of the platform, the sidewalls, and the film which is sealed to the rim about its perimeter. FIG. 2 illustrates the quantity of liquid that can be contained within the reservoir space for a similar tray having an orifice 170 offset from the center of the platform, the seven scenarios depicted in FIG. 2 illustrating various rotations of the tray having its floor and platform held vertically relative to the direction of gravity (filled arrow in FIG. 2).

Once liquid is collected in the reservoir space of the unitary tray, it can be difficult to extract the liquid without breaching the reservoir space. The difficulty with which liquid can be released from the reservoir space is beneficial in the contexts described herein, such as for food packaging, because retention of liquid within the reservoir space inhibits contact between the liquid and items (e.g., food) stored in the storage space and inhibits visibility of liquid within the storage space (e.g., when viewed through a transparent film which seals the storage space). The tray illustrated in FIGS. 34A-34D will retain fluid within the reservoir space unless the liquid is able to access the orifice. As described in the preceding paragraph, substantial amounts of fluid can be retained in the reservoir space of a tray with its floor oriented vertically, so long as the orifice(s) which extend through the platform are located in the geometrically central portions of the trays (e.g., within the central third, as measured in any linear direction along the surface of the platform). Even when the tray is inverted (i.e., its floor is maintained gravitationally horizontal and above the level of the rim), even minor deviation from horizontality of the platform will cause fluid in the reservoir space to pool at a perimeter edge of the reservoir space, rather than pouring through the orifice and into the storage space. Moreover, if the platform is not planar, but is instead “funnel-shaped,” such that the orifice is positioned closer to the floor of the tray than are the areas of the platform surrounding the orifice, then even inversion of the tray may be insufficient to cause fluid to pass from the reservoir space, through the orifice, into the storage space. Other surface shapes can, of course, be employed, consistent with well-known principles of fluid flow across and along shaped surfaces.

A unitary tray is beneficial for illustrating the liquid-sequestering capabilities of the trays described herein (so long as it is presumed that all integral parts of the tray are impermeable to the liquid), but is both difficult and expensive to manufacture. In practice, manufacture of a unitary tray would require complicated, time-consuming, and generally expensive tools, equipment, and reagents to manufacture. A unitary tray could be made by additive manufacturing methods such as 3-dimensional printing, with a soluble or removable support materials used to define void areas (such as the reservoir space and orifice) while materials are added adjacent or on top of the support materials, followed by a step of dissolving or otherwise removing the support materials to yield the unitary tray having voids in place of the support materials. Similarly, a unitary tray could be made by assembling an elaborate mold using soluble, retractable, or otherwise removable mold components to define isolated voids such as the reservoir space and orifice(s) which connect it with the storage space. Still further, elaborate (generally long-handled) carving tools could be used to carve a unitary tray from a unitary block of material. All of these methods share the characteristics of very limited practicality, high expense, and elaborate processing. Thus, although such methods could hypothetically be used to manufacture a unitary tray, they are not realistically useable in the field of food trays—a primary intended and anticipated use of the trays described herein.

By contrast, practically-useful food trays must be readily manufacturable, in short time frames, from inexpensive starting materials. Food packaging industries and retail food stores alone use many millions of food trays every year, and most packaged beef, pork, chicken, and turkey products are packed together with an individual food tray. Furthermore, consumer sentiment to reduce public handling of produce is also leading packagers and retailers to offer more fruits and vegetable packaged in or on trays as well. To be practically useful in the food packaging field, a food tray must have a deliverable cost (manufacturing expense and materials) significantly less than a dollar, and typically less than a quarter of a dollar or less. Moreover, given the scale of food packaging, retail, and consumption, many thousands or millions of trays must be deliverable during the time or season when the food is available for packaging. For these reasons, and because the unitary tray described herein is unsuitable for large-scale, low-cost manufacture, the unitary tray is unlikely to be practically used in food packaging and retail industries, at least until and unless manufacturing methods advance sufficiently to enable rapid, cheap production of unitary trays. The unitary tray nonetheless remains useful as a model for the functionality which needs to be achieved by trays manufactured by cheaper, faster, more practical means.

An important feature of the unitary tray is that liquid present in the reservoir space can enter the storage space substantially only through one or more orifices which extend through the platform (or around the platform, in the case of a platform which does extend completely to a sidewall, leaving an space analogous to an orifice between the platform and an element that supports the platform).

Another important feature of the unitary tray is that items that are too large to pass through an orifice extending through or around the platform will remain on whichever side of the platform they are. This is advantageous to the extent that items larger than orifice dimensions are intended to be stored in (and remain in) the storage space, but a disadvantage of the unitary tray to the extent that such items form (e.g., a clump of precipitated food proteins carried into the reservoir space by fluid shed from a foodstuff) or grow (e.g., a clump of microorganisms, such as molds or sprouted seeds) within the reservoir space. It is, of course, desirable that items place into the storage space of a unitary tray remain there until their removal is desired (e.g., beefsteaks or cut chicken parts placed into the storage compartment of a tray that is subsequently wrapped or sealed with plastic film). However, if items form or grow within the reservoir space, it may be difficult or impossible to remove them from the reservoir space without at least partially destroying the tray, or at least the floor, the platform, or a sidewall of the tray. Several of the embodiments described herein have platform-containing insert elements that are reversibly assemble-able with and removable from a body element, such that the insert and body form a tray as described herein when assembled, but are dis-assemble-able to remove items larger than an orifice that have formed or grown within a reservoir space of the tray. In addition to enabling recovery of such items from the reservoir space, such disassembly can enhance the recyclability of the tray and its components by easing separation of such items from tray components.

Applicants have invented several embodiments of two-component trays which share the functionality of the unitary tray, but which are simpler and less-expensive to manufacture. These embodiments involve assembling two or more components, in each instance to define the reservoir space between the two assembled components.

Multi-Component Tray Embodiments

In important embodiments, the tray described herein includes i) a body 200 having an interior with an imperforate (i.e., bearing no perforations) floor 210 and ii) a perforated insert 100 which engages with the body at an interface which preferably extends about the entire perimeter of the interior of the body. The body and insert form a generally liquid-tight seal about the perimeter of the interface. The insert includes a perforated platform 120 which serves at least two functions: it separates the interior of the body into a reservoir space (bounded by the body, the sidewalls of the body, and at least one surface of the insert) and a storage space (bounded by the opposite surface of the insert and sidewalls which extend from either the body or the insert) having an open top. One or more perforations which extend through the insert facilitate flow of fluid from the storage space into the reservoir space. Perforations through the insert are preferably confined to the central portion of the insert, so as to enhance the volume of fluid that can be retained within the reservoir space when the tray is held with its floor in a non-horizontal (or even vertical) position.

FIGS. 35B-35E illustrate several embodiments of the trays described herein which are constructed from at least one insert and at least one body.

FIG. 35B is a section (analogous to the section view of FIG. 34C) of a tray in which a perforated insert rests upon a peripheral shelf form in the sidewalls of a rounded rectangular tray. Such a tray is also depicted in FIGS. 1A-1D, 2, and 3A. In each of these figures, the insert 100 is a flat (i.e., planar) plastic plate bearing at least one orifice 170 extending therethrough (similar to the multiperforate flat inserts depicted in FIGS. 10A and 10B). At least the edges of the plate-shaped insert rest upon a shelf 231 that extends around the perimeter of a generally tray-shaped body 200. The shelf has a flat (i.e., planar, so as to match the contour of the edges of the plate) upper surface 232 for receiving the insert thereon. When the flat edges of the insert plate rest upon the flat upper surface of the shelf, the insert and body fit snugly against one another such that there is little or no three-dimensional space through which liquid can flow. So long as the floor 210 of the body is lower than the upper surface of the shelf, there will exist a space between the insert and the body, bounded by the shelf and floor of the body and the lower surface of the plate-shaped insert, that can serve as a reservoir space. Because the orifice(s) extend through the insert, the reservoir space communicates with the space above the upper surface of the insert. This space, bounded by the upper surface of the insert and by the sidewalls of the tray-shaped body and having an open “top” extent, is herein designated a storage space. Items can be placed atop the insert in the storage space and can optionally be sandwiched between the insert and a film which overwraps the tray or is sealed to the rim which surrounds the storage space. So long as the flat edges of the insert remain closely opposed against the flat upper surface of the shelf of the body, fluid cannot pass between the reservoir and storage spaces other than by way of the orifice(s). Indeed, pressure applied to the plate by a wrapping film that urges a foodstuff against the insert and the insert against the body can serve to maintain the substantial liquid-impermeability of the insert-edge/shelf seal. Optionally, the flat edges of the insert could be glued or fused to the flat upper surface of the shelf.

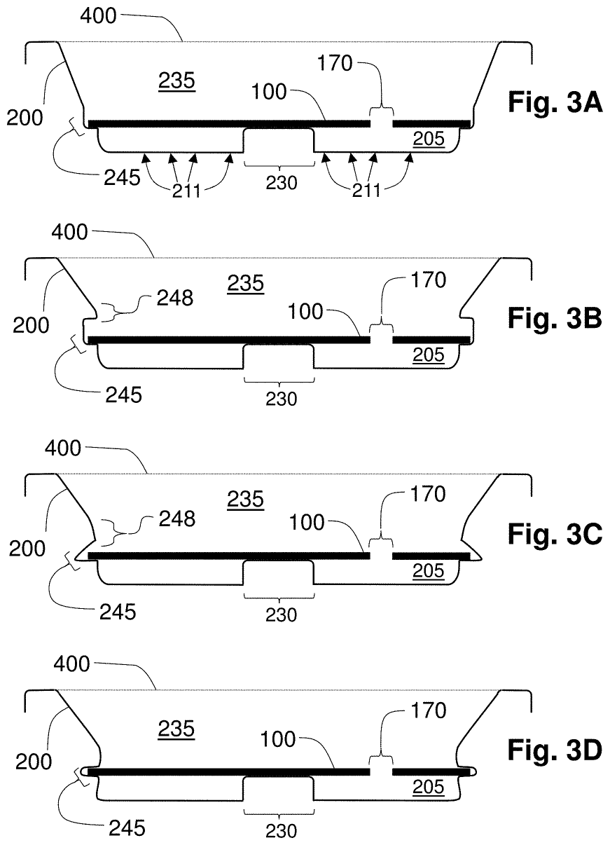

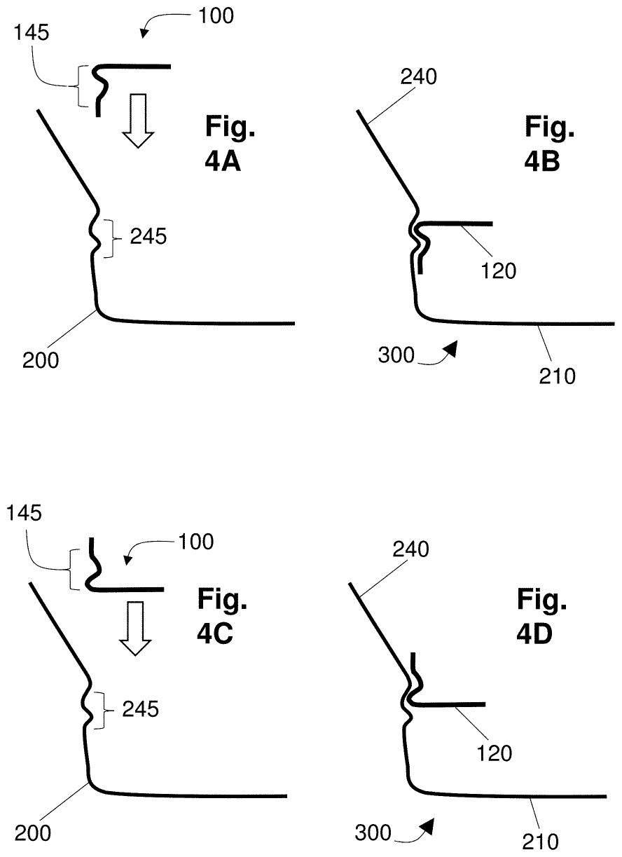

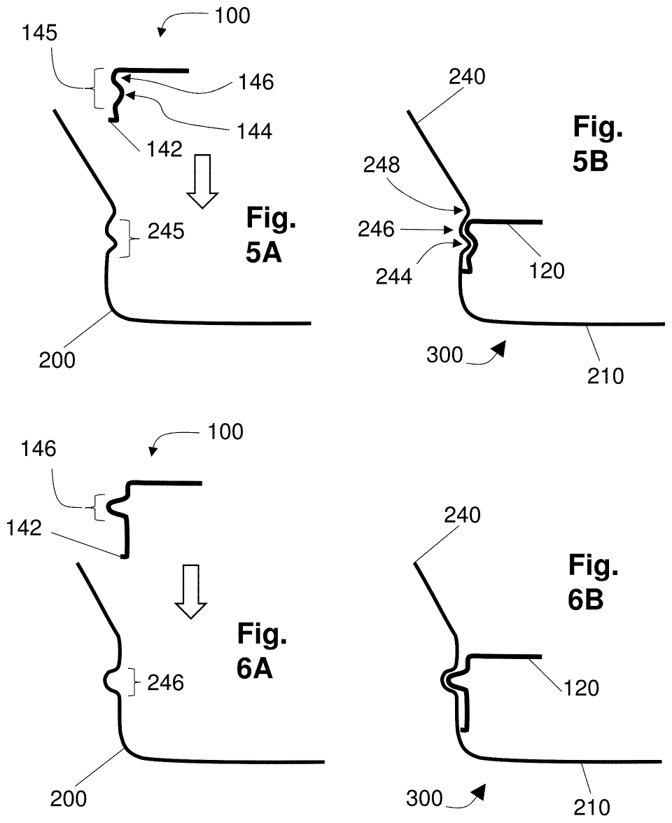

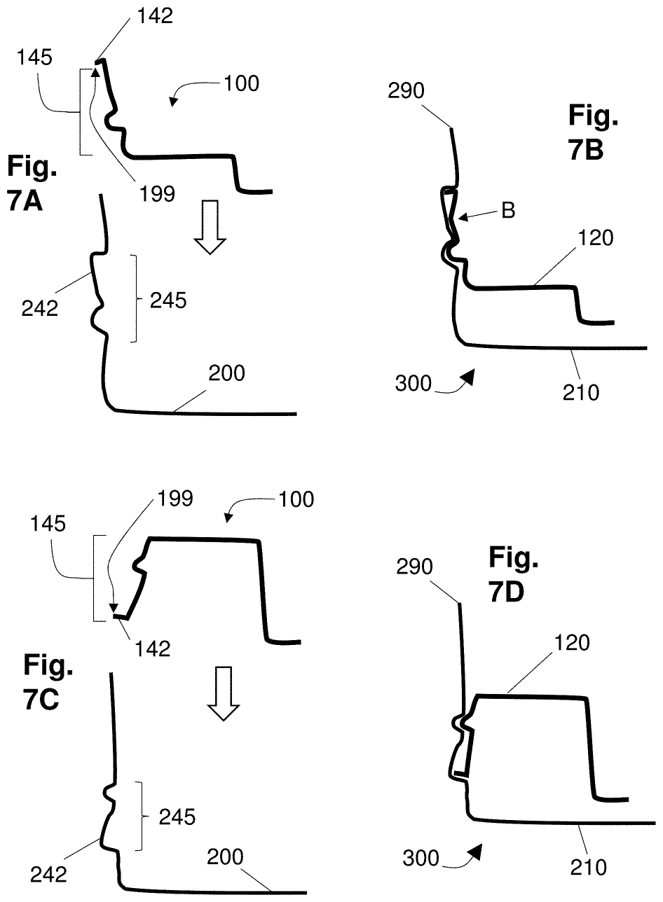

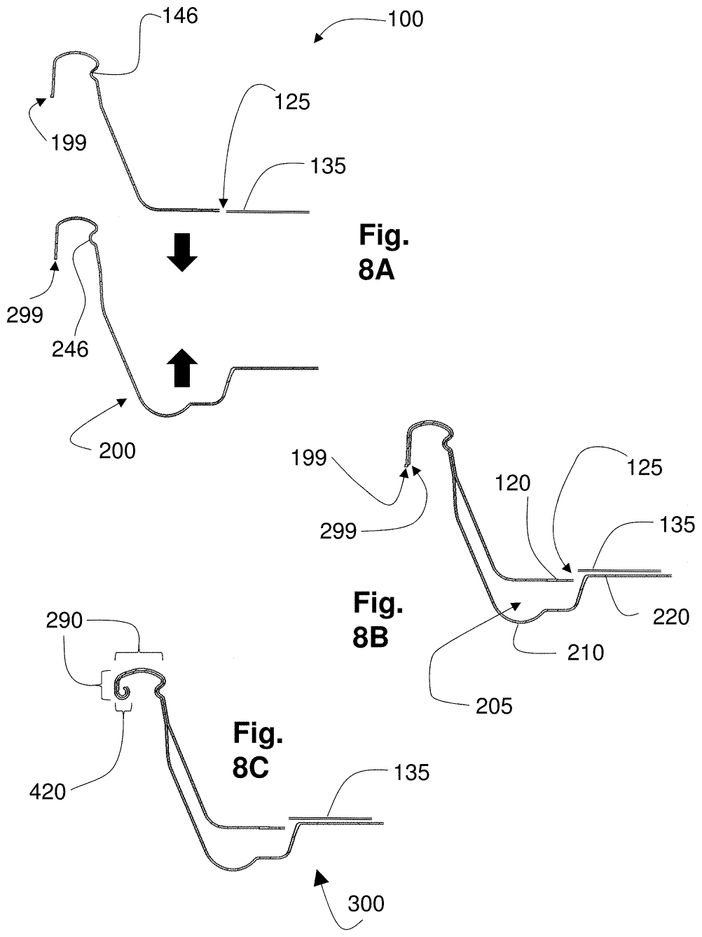

FIG. 35C is a section (analogous to the section view of FIG. 34C) of a tray in which a perforated insert 100 has one or more edges (two are visible in the section shown in FIG. 35C) that are interposed (and preferably wedged) between i) a shelf 231 which juts inwardly from a peripheral sidewall of a tray-shaped body 200 and has a flat upper surface and ii) an overhang 248 that juts inwardly from a peripheral sidewall of the body. The overhang and shelf can be aligned so that the overhang extends above a portion of the shelf at the same circumferential position of the body. Alternatively, multiple overhangs can be present, all, some, or none of which extend inwardly above inwardly-extending portions of the shelf (which may be present as a continuous shelf extending completely about the perimeter of the tray or as short shelf segments which extend along only a portion of the tray perimeter). Interposition of the insert between the overhang(s) and shelf(ves) both maintains separation between the bottom surface of the insert and the floor (i.e., maintains a reservoir space) and inhibits the insert from becoming separated from the tray if the tray is inverted (i.e., if the floor 210 of the body is held horizontally above the rim of the tray depicted in FIG. 35C. This is one type of a “snap in” body/insert arrangement of a tray, in that one or both of the body and the insert will typically need to be flexed or temporarily and resiliently stretched to install the insert between the overhang(s) and the shelf(ves). The intersection of the insert and the body is preferably substantially water-tight (i.e., prevents passage of liquid between the storage and reservoir spaces except through orifice(s) which extend through the insert). Such a substantially water-tight fit can be achieved, for example, by i) including a shelf that extends completely about the perimeter of the tray and can be closely opposed against the perimeter edges of the lower surface of the insert, ii) including an overhang that extends completely about the perimeter of the tray and can be closely opposed against the perimeter edges of the upper surface of the insert, iii) including a combination of shelf and overhang segments along the body perimeter such that the perimeter edge of the insert is closely opposed at least one of a shelf surface, an overhang surface, or against a sidewall of the body along substantially the entire perimeter of the insert, or iv) some combination of these. Examples of tray bodies having such shelf/overhang combinations can be seen in FIGS. 3B, 3C, and 3D, for example. The insert can also be attached to the body using an adhesive or by heat- or sonic-fusion, if desired.

FIG. 35D is a section (analogous to the section view of FIG. 34C) of a tray in which a perforated insert which includes a perimeter adaptor 145 which has a shape complementary to a corresponding engagement zone 245 positioned in one or more sidewalls (and preferably along the entire periphery of the body at its sidewalls). FIG. 35D illustrates, in its left half, that the adaptor and engagement zone can be positioned so that they are situated “below” (nearer the floor of the body than the rim of the tray) the platform 120 of the insert 100 when the insert is installed in the body 200; in the right half of FIG. 35D, the adaptor and engagement zone are positioned so that they are above the upper surface of the platform when the insert is installed within the body. Components of and trays of the types depicted in FIGS. 35D and 35E include those depicted in FIGS. 4A-4D, 5A, 5B, 6A, 6B, 7A-7D, 18, 19A, 19B, 20A-20C, 21A, 22A-22G, 24A-24C, 25A-25G, 26A-26E, 27A-27F, and 28.

FIG. 35E is a section (analogous to the section view of FIG. 34C) of a tray in which a perforated insert 100 bears an adaptor 145 that can be installed closely opposed against an engagement zone 245 of a body 200 having a non-perforated floor 210 to form the reservoir and storage spaces described herein. This embodiment differs from the one depicted in FIG. 35D in that the rim of the tray extends from sidewalls 140 which are attached to the platform 120 of the insert. In this embodiment, the body 200 acts like a fluid-impermeable “jacket” attached to the perforated bottom end of an otherwise tray-shaped insert 100.

Each of the trays depicted in FIGS. 35B-35E is made from two or more discrete parts (although the insert and body of each tray could, if desired, be cut from a single piece of thermoformable plastic material and connected by a relatively thin strip of the material, and assembled by flexing the thin strip to assemble the insert and body as described). Accordingly, these trays will ordinarily prove much simpler, less complicated, and less expensive to produce than the unitary tray depicted in FIG. 35A and in FIGS. 34A-34D. Typically, the insert and body of each of the trays depicted in FIGS. 35B-35E will be made separately and then assembled by opposing the corresponding parts of the insert and the body against one another to form a reservoir space between the body and insert and a storage space which fluidly communicates with the reservoir space substantially only by way of one or more orifice extending through the insert.

Another way of forming a two-piece insert+body tray is depicted in FIGS. 8A, 8B, and 8C. In this embodiment, both the insert 100 and the body 200 are tray-shaped elements with complementary-shaped rims. The depth (rim to floor) of the body is greater than the depth of the insert in at least some places across its floor. Also, the rims of the insert and the body are complementary in size and shape, such that the insert can be nested within the body and, when nested, the lower surface of the rim of the insert is snugly opposed against the upper surface of the rim of the body. Hence, when the insert is nested within the body, there will be at least some portions of the interior of the body which are located lower than parts of the interior of the insert. The platform 120 of the insert (i.e., the “floor” of the tray-shaped insert) bears at least one perforation, so that liquid on the platform can pass through the platform and into the reservoir space 205 that exists between the nested insert and body. In the embodiment depicted in FIGS. 8A-8C, a door 135 portion of the insert platform normally occludes much of the area of the perforation, other than at a small gap 125 region. In the assembled tray 300, however, the door of the nested insert is moved out of the plane of the platform by opposition against a projection 220 extending upwardly from the floor 210 of the body, thereby “opening” the door, “widening” the gap and facilitating fluid flow through the perforation defined by the gap. The closely-opposed rims of the nested insert and body can be adhesed to or fused with one another, or they can be rolled together, as illustrated in FIG. 8C. The nested insert and body can also be “locked” in place by positioning elements such as an outwardly-extending adapting section 146 formed in the insert which interlocks when assembled with an outwardly-extending engagement section 246 in the body.

Yet another way of connecting the insert and the body is by including a shaft 225 on one of the insert and the body and a corresponding socket 105 on the other. The shaft and socket should be positioned such that when the insert and body are assembled in the desired configuration the shaft extends into and/or through the socket such that a collar 104 portion of the socket snugly fits against a portion of the shaft (e.g., either the top 226 of the shaft or one or more of the peripheral walls 224 of the shaft), such as in a compression fit, so as to compressibly lock the shaft within the socket. Such an arrangement can be seen in FIG. 30 (and in greater detail in FIGS. 30C-1, 30C-2, 33A, and 33B), in which a socket 105 centrally positioned on the insert 100 receives a shaft through its void and the collar 104 portions which bound the void of the socket are snugly opposed against the peripheral walls 224 of the shaft in the assembled tray (see FIG. 30C-2), enhancing retention of the insert within the body, even when the tray is jostled or inverted. Such a socket/shaft arrangement can be used cooperatively with insert-body engagements which act at the peripheries of the insert and the body and/or with supports not located at the periphery of body, as shown for example in embodiment depicted in FIG. 30 (in which four supports 230 maintain separation between the insert and the body, while a central socket/shaft and a peripheral rolled-edge adaptor (145, 190) interacting with a peripheral engagement zone 245 lock the insert 100 within the body 200. Trays and tray components of this type are depicted in FIGS. 29A-29C, 30-30C-2, 31A-31C, 32, 33A-33C, and 36-50.

In these multi-component embodiments, the tray has at least two parts: an outer body and an insert that lodges within the body. The insert has one or more orifices and/or gaps through which liquid can flow from the storage space (i.e., the food-storage compartment) into the reservoir space (i.e., the reservoir compartment). Such fluid can, for example, be fluids which exude from animal or vegetable tissues over time, fluids released as tissue begins to decompose, fluids used to wash foodstuffs which are shed after packaging, fluids released upon thawing of frozen packaged foodstuffs, or any other fluids released or generated in the storage space after a tray has been sealed (e.g., with a plastic film which enwraps the tray and its contents or which is sealed against the open rim of the tray). Such trays may have multiple inserts (i.e., each overlapping a single compartment formed in the body or multiple inserts overlapping a single compartment).

The orifice(s) and/or gap(s) which extend through the insert should be positioned generally toward the center of the assembled package. This permits fluid to flow from the storage space into the reservoir space and to remain there, even when the tray is turned into a vertical position (i.e. with the floor of the tray vertical or near vertical). This will tend to cause fluids to remain separate from foodstuffs in the storage area. The liquid remains sequestered from the foodstuff because when the insert is lodged against the inside of the body (i.e., with the adaptor portion of the insert closely opposed against an engagement zone within the compartment of the body), it is difficult or impossible for fluid to flow through the adaptor—engagement zone interface. Because all fluid transfer between the compartments must occur through the gaps and orifices, their central location limits retrograde flow.

The insert includes a platform portion intended to support foodstuffs thereupon when the assembled tray is stored in its normal horizontal position (with the floor of the body resting upon a horizontal surface. The gaps and orifices in the insert should be positioned at low points on the insert, and the insert can be designed to have lower portions (see, e.g., the drainage channels in the examples described herein in order to direct fluid flow away from stored foodstuffs and toward one or more of the gaps and orifices.

Door-Bearing Insert Embodiment

An important aspect of the insert is that it can have one or more ‘doors’ formed therein. A door can be defined by an extended gap which has a shape or configuration which defines a deflectable portion of the insert that can pivot or bend around another (“hinge”) portion of the insert. Because the plastic material from which the insert is formed is flexible (e.g., as with many known polyethyelenes, polypropylenes, and polyesters such as polyethyene terephthalate), pressure or force applied to the deflectable portion of the door will cause it to pivot around the hinge portion, expanding the gap (which extends through the insert) into a larger opening through which a greater quantity of liquid can flow. The force or pressure can be applied by a foodstuff resting upon the deflectable portion. Preferably, however, the body has one or more protrusions extending from its floor (or possibly a sidewall) that impact upon the deflectable portion of a door and deflect it into an opened position when the insert is engaged against the body.

The fluid-segregating ability of the trays described herein does not require use of an absorbent pad in the reservoir space (although one could be included if desired). A significant advantage of not requiring an absorbent pad is that the entire tray can be made from a single, recyclable material, such as a recyclable plastic. Furthermore, if at least one deflectable door, one gap, or one orifice is positioned near an edge of the insert—or if the insert is removable after use—any liquid in the reservoir space can be drained, the tray can be rinsed if desired, and the tray can be left with relatively little contamination, increasing the likelihood that it will be acceptable for recycling. Removability of the insert also facilitates cleaning of used trays at a recycling facility, even if not the insert is not removed prior to collection of used trays from consumers or from municipal solid waste.

Materials of Construction

The trays described herein can be made using substantially any thermoplastic material. What is important is that the material be capable of being softened by heating and re-stiffened upon cooling in thermoforming operations. Substantially all thermoplastics exhibit a characteristic temperature above which they soften and become flexible or workable and below which they become more rigid and retain their shape. Desirable thermoplastics for the articles and methods described herein retain their shape under normal conditions of the anticipated end use of the container (typically at normal room and refrigerator temperatures from about 0 to 40 degrees Celsius). In situations in which freezing of products packaged in the trays described herein is anticipated, the material from which the trays are made should be selected to resist extreme brittleness at the thickness and shape(s) used. It is also desirable to use thermoplastics which can be softened under conditions that are readily attainable in a manufacturing environments. A wide variety of thermoplastics are available in sheet form and are known for use in thermoforming operations. Examples of suitable thermoplastics include polyethylene (PE), polypropylene (PP), polyethylene terephthalate (PET), and polyvinyl chloride (PVC). Other suitable thermoplastics are apparent to skilled workers in this field, and substantially any of these can be used. Also potentially useful are flexible plastics having deformable materials such as metal foils bound to their surface.

The trays can, but preferably do not, include one or more peelable layers, for example as described in U.S. Pat. No. 9,302,842 to Wallace and in U.S. patent application publication 2018/0272666 of Wallace. A peelable layer can be applied to the insert, to the body, or one to each of the insert and the body. However, unless the peelable layer is made from the same plastic material as the insert or body to which it is attached, the recyclability of the insert/base can be adversely affected by the presence of the peelable layer (because end users may not always reliably remove the peelable layer prior to discarding the tray). In such instances, it is preferred to omit the peelable layer so as not to inhibit recyclability of the container.

In some embodiments, it is desirable to have optically clear tray components (i.e., either or both of the insert and the body). Many known thermoformable plastic sheets are substantially optically clear, meaning that a substantial amount of light incident upon one face of the sheet will pass therethrough and be visible to an observer looking at the opposite face. More simply put, it is possible to “see through” such materials, whether the material appears “clear-as-glass” or somewhat cloudy (like frosted glass). Optical clarity is especially important for containers meant to contain articles which a purchaser may wish to visually inspect prior to purchasing—such as foodstuffs like cuts of meat, fish, fruits, berries, or vegetables.

The methods described in U.S. Pat. No. 10,562,680 to Wallace permit bending of optically clear thermoplastic materials to form containers without significantly reducing the optical clarity of the materials. Those methods, or other methods which do not induce crystallization or other opacification of optically clear materials should be used to preserve transparency.

It is partially on account of this optical clarity that trays made as described herein are sold under the CLEARLY CLEAN (TM, Converter Manufacturing, LLC, Orwigsburg, Pa.) brand name in the United States. Nevertheless, the trays described herein (and their individual components) can be made from optically clear thermoplastics, translucent ones, opaque ones, and each of these types can be colored by addition of dyes and colorants, as is known in the field of thermoplastic production.

It is ordinarily irrelevant whether the body and the insert of a tray described herein are made from the same batch of thermoplastic (although this can lend reliability to the identity of their materials). Recyclability of multi-component trays without separating tray components depends upon the body and insert being made from the same type of plastic. It is immaterial whether the thicknesses of the thermoplastic sheets used to make the body and insert are the same, so long as they are composed of the same material. Likewise, it is ordinarily immaterial whether the body material is the same color as the insert material—however because these two components will commonly end up recycled together, the coloration of the two components may affect the value of plastic recycled from the mixed plastics (e.g., clear PET recycled together with black-colored PET will tend to cause the recycled PET mass to have a non-clear color, the precise color varying with the amount(s) and identity(ies) of the recycled components. In a preferable embodiment, both the body and the insert are the same color (preferably optically clear for many food-packaging embodiments).

For the purpose of enhancing recyclability of the trays described herein, it is preferable that no component be used to make the tray other than a thermoplastic of a single type (or multiple thermoplastics of types sufficiently similar that they can be practically recycled as a mixture). For this reason, it is preferable that no adhesives be included in the trays (even though some components can be made by attaching components using an adhesive). Heat or sonic fusion can be used to attach adjacent surfaces of the same composition, and tools and methods for employing such fusion are well known.

Thermoforming

The multi-component trays described herein can be made using well-known techniques for thermoforming of thin thermoplastic sheets, especially with the edge-rolling and handling techniques described in greater detail in U.S. Pat. No. 10,562,680 to Wallace. Some additional guidance is provided in this section.

Some embodiments of the trays described herein have intricate patterns (e.g., the honeycomb pattern of fluid cells on the floor 210 of the body 200 of certain trays, giving the floor a liquid-retaining texture 215; e.g., as shown in FIG. 27D). It is important that molds used to form intricately-patterned sections incorporate numerous vacuum ports positioned at distant portions of the mold (e.g., at two or preferably three portions of the most-recessed portions of the hexagonal “honeycomb” cells) in order to form these features. Similarly, for features such as supports 230, adaptors 145, and engagement regions 245, which bear a surface against which another component must snugly fit, special attention should be paid to mold components to ensure smooth, accurate forming of those surfaces.

A particular feature requiring careful molding is the shaft 225 employed in some embodiments of the trays described herein. As illustrated for example in FIG. 30C-1, the shaft can have a hexagonal portion at its distal end and a cylindrical portion adjacent it at a less distal position. For the shaft in FIG. 30C-1, vertices of the hexagonal portion compress portions of a collar 140 in a socket 105 into which the hexagonal portion of the shaft is inserted; compression of the collar against the hexagonal vertices “locks” the insert to the shaft and thence to the body of which the shaft is a part. Accordingly, the shape of the hexagonal portion of the shaft is very important and a mold used to form that portion should be associated with sufficiently numerous and sufficiently placed vacuum ports to ensure the desired shape.

A particular advantage of the tray designs disclosed herein is that they can be made quickly and relatively inexpensively using relatively simple thermoforming and edge-rolling machinery. Plastic trays used as food containers are ordinarily made and used in batches of many tens of thousands or millions of trays. For that reason, the simplicity and manufacture-ability of the tray designs described herein are a critically-important feature of the trays.

The basic process for making a multi-component tray as described herein is to i) make a tray-shaped body according to a design described herein, generally by a thermoforming process; ii) make an insert which can be assembled with the body according to a design described herein; and iii) assemble the insert and body to form an assembled tray. It is ordinarily irrelevant whether the body or insert is made first or whether they are made substantially simultaneously. (However, it can be simpler to ensure identity of body and insert materials if they are made simultaneously, such as from the same lot of thermoplastic material.) The number of discrete steps used to manufacture the trays described herein is ordinarily irrelevant and often depends upon the machinery and facilities available to the maker. Some tray bodies and some tray inserts described herein have rolled-edges, for example, As described in U.S. Pat. No. 10,562,680 to Wallace, for example, articles can be formed formed into their final shapes and conformations and thereafter have their peripheral edge(s) rolled in a separate operation. Alternative, as described in the same reference, the shape and conformation of the article can be formed in a single machine which also rolls the peripheral edge within the same mold cavity used to form the part.

In some embodiments of the trays described herein, a rolled peripheral edge of the insert is used to form a substantially liquid-tight seal with a portion of a body (see, e.g., the tray depicted in FIGS. 29A through 32). Where a rolled edge is to be snugly fitted against a curved interior surface (e.g., the engagement zone 245 depicted in FIGS. 31A-31C), a tighter fit can be obtained if the radius of curvature of the curved portion of the rolled edge is slightly larger than the radius of curvature of the curved interior surface. Without being bound by any particular theory of operation, this is believed to be explained as follows. In theory, the rolled edge and the curved interior surface should fit best if they exhibit precisely the same radius of curvature (so long as the radius is measured from the center line to the interior surface of the curved interior and from the center line to the exterior surface of the rolled edge). However, if there is any mismatch between the dimensions of the insert and body, the identically-curved surfaces may not meet, leaving a gap. When the radius of curvature of the rolled edge is slightly larger than the radius of curvature of the curved interior, the rolled edge must flex slightly to fit within the interior surface. In this case, if there is any mismatch between the dimensions of the insert and body, the gap which would otherwise be formed can be bridged by “un-flexing” of the curved edge to fill the gap. Similarly, leaving a small peripheral flange at the peripheral edge 199 of a rolled edge can cause the peripheral flange to act as a flexor of the rolled edge when it impinges against a portion of a curved body into which the curved portion of a rolled edge mates, as shown in FIGS. 31B and 31C. Leaving a peripheral flange can also simplify cutting of rolled edge components, as described in U.S. Pat. No. 10,562,680 to Wallace.

The methods and devices used to perforate plastic parts (e.g., to form an orifice 170, a vent 106, socket 105, or a gap 125 which defines a door) are not critical, and substantially any plastic-cutting device can be used, such as standard knife-based dies or matched-metal dies. When a tray is intended for use as a food container, it can be important to ensure that any plastic cutout (or chaff, shavings, or other debris) is completely removed from the cut component and from the tray, so as to prevent accidental ingestion by a consumer of the food.

Recyclability

The unitary trays described herein are necessarily made from a single material. In all embodiments of multi-component trays including at least one insert and at least one body, it is preferable that all of the components be made from the same material, because this greatly simplifies recycling. Many plastics cannot be practically recycled unless the input into the plastic-recycling process is composed of substantially only one type of plastic (although some variability or contamination of input streams can be tolerated in some recycling schemes). Because the trays described herein can be made using only a single type of plastic, they can be simply discarded with trash (and recovered therefrom by a solid waste processor) or with mixed recyclable materials (and recovered by sorting in a material recovery facility) and recycled. There is no requirement to separate different materials in a single tray (or in layers of a tray made from a laminate of dissimilar plastics). Soiling, fluid, or dried food residue can be removed from the trays by washing procedures that are incident to normal recycling procedures. For these reasons, the trays described herein can be more readily recycled than prior trays which included multiple materials which were bound to one another.

The liquid-retaining characteristics of the trays described herein further enhance their recyclability. Previously, food packagers had to either tolerate the presence of excluded or shed liquids within the food storage space of a sealed food package, include a vent or other outlet to permit fluid egress without microbial ingress, or include an absorbent material within the sealed food package to absorb such fluids. Inclusion of an absorbent has therefore been a common characteristic of existing food packaging systems—especially for those intended for use with fresh meat and poultry. Absorbent pads tend to be composed of cellulose fibers of various types and consistencies and/or of highly hygroscopic polymeric materials (such as materials commonly referred to as “superabsorbent polymers,” such as are found in infant diapers). Undesirable odors, consistencies, and appearances, physical attachment to package materials, and difficulties with identifying fluid-saturated absorbent materials leads to the materials frequently being left attached to or within discarded food containers. The presence of these absorbent materials and their attachment to or capture within food packages has inhibited recycling of food packaging, even when the materials of the package would be otherwise recyclable.

The trays described herein have a reservoir space in which fluid can be sequestered. Bulk fluid can be captured within the reservoir space and, even though it may slosh around when the package is moved, appropriate placement (i.e., toward the center of the package) and contouring (e.g., orifices “sunken” or having an “funnel shape”) of the insert, especially near orifices therethrough, can limit passage of fluid from the reservoir back into the storage space. Within the reservoir space, fluid cells (e.g., formed as a pattern of small, separated spaces on the floor of a tray body) can further sequester fluid (e.g., to reduce or eliminate the “sloshing” sensation when fluid is present). Thus, the trays described herein can be used without any absorbent material present on or within the tray. Omission of absorbent material enhances recyclability by eliminating recyclate processing steps that would otherwise be necessary to remove absorbent materials from the recyclate stream. Even to the extent that food-related fluids (or solids contained in or precipitated from fluids) remain within the trays at the time of disposal, collection for recycling, or recycling, shredding of recyclable material is a very common step in the recycling process, and extensive washing which normally accompanies or follows the shredding steps can be expected to remove food-related liquids and solids without interfering with the recycling process. Furthermore, trays described herein which have separate or separable insert and body compartments can have their components disassembled and washed separately and before shredding steps, potentially further reducing the burden of washing or rinsing food-related fluids or solids therefrom prior to recycling.

The enhanced recyclability of the trays described herein is important to consumers and to the businesses which produce products for them. So long as no additional materials are fixedly attached to the trays described herein, the trays can be readily recycled. Accordingly, businesses which use the trays to package products (again, without fixedly attaching to them any material that will impede recycling) can ethically communicate to their customers the recyclability of the trays and the businesses' virtue in making an environmentally sound choice of packaging material. As consumer concern grows for environmentalism, waste reduction, and energy conversation, businesses are called upon to improve their performance on these scores. The trays described herein facilitate such performance improvements.

Ornamental Design of Trays

Also disclosed herein is a preferred ornamental design for a fully-recyclable liquid-sequestering food tray. The functional aspects of these trays are described herein. The ornamental design of a preferred embodiment is depicted in the accompanying drawings, in particular at FIGS. 36-50. The broken lines in the figures illustrate portions of the designs that form no part of a design claimed herein. The appearance of an opaque tray is shown in the ornamental design figures, but the tray may also be made from optically clear, translucent, or transparent materials.

### Definitions

As used herein, each of the following terms has the meaning associated with it in this section.

The “outer periphery” of a tray is the peripheral-most extent of the tray when the tray rests with its bottom on a flat, horizontal surface.

A “bent-over” edge of a tray and a “rolled-over” edge of a tray have the meanings set forth in U.S. Pat. No. 10,562,680 to Wallace, which describes such edges and how they can be made, and which is incorporated herein by reference in its entirety.

### EXAMPLES

The subject matter of this disclosure is now described with reference to the following Examples. These Examples are provided for the purpose of illustration only, and the subject matter is not limited to these Examples, but rather encompasses all variations which are evident as a result of the teaching provided herein.

Several examples of the trays described herein are depicted in the drawings. Some of these are described in the following examples.

### Example 1

One example of a preferred tray is depicted in FIGS. 22A through 22G. This tray has a body which has a fluid-retaining pattern in its floor. Here, the pattern is a “honeycomb”-type pattern in which relatively small hexagonal depressions are closely spaced against one another. The surface tension inherent in liquids (especially aqueous liquids) causes fluid to flow into the depressions, but to flow back out only with difficulty (e.g., only by inverting the tray and sharply rapping its rim against a hard surface). The floor also has several protrusions jutting therefrom, which serve to support the insert when it is installed. Images of the body appear in FIGS. 22C through 22G and FIGS. 19A and 19B are diagrams which depict the body.

The body has a perimeter engagement zone around the interior perimeter of its concave interior, the zone positioned near the floor. The insert has a generally planar platform portion for supporting items during storage within the tray. The insert has one or more (here, two) relatively large, centrally-positioned orifices which facilitate flow of relatively large quantities of fluid from the storage space to the reservoir space between the insert and the floor of the body. Drainage channels (portions of the insert positioned at a lower height than the platform when the tray is in its normal horizontal position) extend across the insert and tend to channel fluid downwardly from the platform and toward the orifices. Images of the insert appear in FIGS. 22A, 22B, 22F, and 22G, and FIGS. 21A and 21B are diagrams of the insert.

Also extending through the insert are several slits 165, including several “L” shaped slits each of which defines a deflectable door, the tip (i.e., at the vertex of the “L”) can be deflected downwardly by flexing the insert along an axis extending roughly between the ends of the ‘L’-shaped slit, thereby opening and enlarging the slit to better facilitate fluid flow therethrough. If desired (not shown here), one or more protrusions can engage a door and cause its deflection when the insert is installed within the body. Other slits 165 are simply straight-line slits which can permit passage of a fluid such as a gas from one face of the insert 100 to the other, analogously to passage of the fluid through an orifice 170. When slits 165 are very narrow (e.g., <1 millimeter of space between opposed sides of the slit), flow of liquids having any significant surface tension may be inhibited, causing such narrow slits 165 to function primarily as passages for gas flow (and thereby, pressure equalization) across the insert 100. At one extreme, a slit 165 that is very narrow and very short in length (e.g., <1 millimeter in length) may exist as merely a small orifice 170 or a “pin-hole,” the primary difference between a slit 165 and an orifice 170 being the ratio of length-to width (length being the longer of the two approximately orthogonal dimensions in the plane of the insert platform 120), with slits 165 having a high ratio (generally greater than 10, preferably greater than 100) and orifices 170 generally having a low ratio (generally less than five, preferably less than two and greater-than-or-equal-to one). Slits 165 and orifices 170 can generally act interchangeably, and the two terms are used herein primarily to differentiate “narrow” slits 165 from orifices 170 having lengths more nearly equal their widths.

An adaptor portion 145 of the insert 100 is shaped so that it closely mirrors the shape of the perimeter engagement zone 245 of the body 200. In this way, a largely fluid-tight seal can be made between the perimeter of the insert and the body when the adaptor is fitted against it. Preferably, these portions can be shaped so that the insert can “snap into place” and be held there without any continuing applied force. Because the orifices and gaps are centrally positioned, the reservoir can contain a significant amount of fluid that will not spill from the reservoir space into the storage space, even when the tray is held in a vertical position.

Each of the insert and the body was made by ordinary thermoforming procedures using thin gauge, optically clear PET material and holes, gaps, slits, and edges were cut by die cutting. The peripheral edge of the body was rolled over using methods described in U.S. Pat. No. 10,562,680 to Wallace.

In this embodiment, the insert was installed with the flat platform of the insert facing upwards (i.e., toward the open end of the body) and with the adaptor on the underside of the insert (i.e., nearer to the floor than to the open end of the body). The shape of the adaptor was made to be complementary to the shape of the engagement zone in the body, and the insert was installed into the tray by “snapping” the adaptor into the engagement zone of the body.

When the insert was installed within the body and a fluid-exuding item was placed atop the platform portion of the insert (within the sidewalls of the body; i.e., in the storage space of the assembled tray), exuded fluid flowed onto the platform surface 120, into the drainage channels 172, into and through one or the other orifice 170 and into the reservoir space between the insert 100 and the body 200. Within the reservoir space, fluid flowed into various ones of the hexagonal fluid cells of the fluid-retaining pattern 215 on the floor of the body. The six upwardly-extending supports 230 opposed downward movement of the insert platform, because the underside of the platform was supported by the uppermost face of the support.

### Example 2

As shown in FIGS. 9A-9F, an insert can be substantially flat and can have doors formed therein by making C-shaped (or other shapes—see FIG. 17, for example) gaps or slices which extend through the insert. If the insert is installed (e.g., by “snapping in” as shown in FIGS. 22F and 22G, by having a matched, nested rim, as shown in FIGS. 8A-8C, or by being held, welded, or adhered to a flat perimeter surface, as shown in FIGS. 14A-14D and 16A-16D) in a configuration in which a protrusion impacts upon one of the doors, then the door will be “held open” by the protrusion, facilitating fluid drainage through the door.

In an embodiment illustrated in FIGS. 23A through 23D, a body 200 and an insert 100 capable of nesting within the body were made by thermoforming and die-cutting optically-clear (i.e., transparent) PET material having a thickness in the range from 18 to 25 gauge. The body 200 (depicted in an overhead image of the upright body in FIG. 23A and in an overhead image of the inverted body in FIG. 23B) was molded into the form of a tray having a rounded rectangular overall shape with a rim surrounding a central rounded rectangular void bounded by sidewalls and a floor. The body was molded so that four longitudinal supports (indicated between white arrows in FIGS. 23A and 23B) rose from the lowest floor surface into the interior of the body. Each support had a flat top surface. The insert 100 (depicted in an overhead image of the upright insert in FIG. 23C and in an overhead image of the inverted insert in FIG. 23D) was molded was molded into the form of a tray having the same length and width dimensions as the body and the same shape and dimensions for the rim which surrounded the interior of the body. That is, the rim of the insert nested snugly against the rim of the body when the upright insert is placed atop the upright body in an aligned manner. Within the rim of the insert was a flat central platform portion, surrounded by sidewalls. Importantly, the depth of the insert (i.e., the distance between the upper surface of the rim and the platform portion when the insert is in the upright position) was molded to be smaller than the depth of the body (i.e., the distance between the upper surface of the rim and the lowest portion of the floor when the body is in the upright position), so that a space (the “reservoir space”) existed between the lower surface of the platform on the insert and the upper surface of the lowest portions of the floor of the body when the rims of the insert was pressed downward and snugly against the upper surface of the rim of the body. However, the uppermost surfaces of the supports contacted the lower surface of the platform of the insert when the rims were thus engaged. It would have been impossible to cause the rim of the insert to fit snugly against the rim of the body if it were not for four C-shaped doors (numbered 1-4 in FIGS. 23C and 23D) that were die-cut into the platform. When the insert was fitted to the body and the rim of the insert was pressed flush against the rim of the body, each of the four supports of the body contacted the bottom surface of the platform at one of the four doors of the insert. As the rim of the insert was pressed against the rim of the body, each support was urged through the gap formed as the door was displaced along the axis formed by the hinge region (the uncut portion of the platform between the two ends of the C-shaped gap that defined each door). As a result, all four doors were held in a deformed (“open”) position when the rim of the insert was flush against the rim of the body. If the rim of the insert were fixed to the rim of the body in this flush configuration (e.g., by adhesing the two, by fusing the two, by clamping the two, or by rolling the aligned peripheral edges of the two rims over together), the doors would be maintained in this “open” configuration, permitting fluid present in the storage space above the platform surface to pass through the doors and into the reservoir space between the lower surface of the platform of the insert and the upper surface of the platform of the body.

FIGS. 23E and 23F are images of a similar tray in which the insert bears only two C-shaped cut doors, numbered 1 and 2 in the images and the body bears only two corresponding elongated support members molded into its floor. The identically-shaped rims of the insert and body of this tray were urged snugly against one another and the aligned peripheral edges of the insert and body were rolled over to maintain the snug configuration. In FIG. 23F, a slip of paper (P) is inserted into each of forced-open doors 1 and 2, positioned between the corresponding supports in the body and the lower surface of the platform at the doors. A black line drawn upon the upper platform surface illustrates that the paper extends from the storage space (paper surface obscures the black line above door 1 in FIG. 23F), into the reservoir space (black line remains above the paper surface between the gaps defining doors 1 and 2) and back into the storage space (paper surface obscures the black line below door 2 in FIG. 23F), illustrating paths by which liquid present in the storage space can enter the reservoir space.

### Example 3

Rolled-Edge Tray Having Perforated Insert With a Peripheral Adaptor Region and a Body Having a Liquid Sequestering Floor

This example describes a particularly advantageous embodiment of the trays described herein. This embodiment is depicted in at least FIGS. 24A through 28 and its ornamental features are depicted in greater detail in FIGS. 36-50. A photographic image of a tray of this embodiment, made with optically clear PET material and exhibiting optical clarity throughout every portion of the tray is shown in FIG. 32.

As illustrated in the views shown in FIG. 24A, this embodiment of the tray includes an insert 100 and a body 200 that are assembled to form an assembled tray 300. FIGS. 24B and 24C show a sectional view taken along plane P24 with the sectioned portion of the insert (FIG. 24B) or the sectioned portion of the body (FIG. 24C) indicated with a thick line.

FIGS. 25A through 25G illustrate how the tray is assembled. FIG. 25A is an image of the body 200 and the insert 100 side by side, each with a sectional plane indicated. FIGS. 25B through 25D are sections taken through the planes shown in FIG. 25A, showing the profile of a portion of the body (FIG. 25B) of an unassembled tray, the profile of a portion of the insert (FIG. 25C) of an unassembled tray, and the profiles and positional relationship of the body 200 and the insert 100 in an assembled tray 300. It can be seen from these figures that the shape of the adaptor 145 of the insert is complementary to the shape of the engagement zone 245 of the body, such that these two portions form a “snap-fit” type interface in the assembled tray. Also, it can be seen from FIG. 25D that a reservoir space 205 exists between the body and the insert in the assembled tray. FIGS. 25E through 25G illustrate one embodiment of how supports 230 and drainage channels 172 are accommodated in this example tray. FIG. 25E is a profile of a portion of the body 200 bearing a support 230 and FIG. 25F is a profile of a portion of the insert bearing a drainage channel bounded by platform 120 portions of the insert 100. When the insert is installed within the body (note engagement at the engagement zone 245), the upper end of the support rests against the lower surface of one of the platform portions in this embodiment, while the drainage channel is positioned clear of the support (i.e., so that the position of the drainage channel does not interfere with the platform resting upon the support).

FIGS. 26A through 26F are views of the insert 100 of the tray described in this example. Referring to FIG. 226B, the insert bears two relatively large orifices 170 that extend completely through the insert. Each of the orifices is positioned at the vertex of a series of drainage channels 172 which radiate outwardly and toward one end of insert. As can be seen in FIGS. 26A and 26C, the orifices and the drainage channels 172 are gravitationally lower than the platform surface 120 of the insert when the tray is in this (“upright”) orientation. Referring again to FIGS. 26A and 26C, the insert also bears a peripheral adaptor 145, which is oriented generally at a right angle to and above the platform 120. The adaptor is sized, shaped, and positioned to fit in a complementary way against the engagement zone 245 of the body when insert is installed within the body, as illustrated in FIGS. 25D and 25G (note that the adaptor is oriented in the opposite direction in FIG. 25G, reflecting that this “adaptor-downward” orientation can alternatively be employed). The adaptor, in this embodiment, is oriented in the opposite direction from the downward orientation of the drainage channels 172. The adaptor in this embodiment includes both an inwardly-extending adapting section 144 that bulges toward the interior of the assembled tray and an outwardly-extending adapting section 146 that bulges away from the interior of the assembled tray. The adaptor also has a small circumferential peripheral flange 142 at its uppermost extent. These contours and features help to define a sinuous passage between the adaptor of the insert and the engagement zone of the body, which improves the liquid-tightness of the seal. Not visible in the central drainage channel 172 are pinhole-sized vents which are also positioned within this channel; the vents are contribute to gas flow between the reservoir space 205 and the storage space 235 of the tray. The platform 120 surfaces of the insert are substantially flat in this embodiment (i.e., all platform surfaces are in a single plane. FIGS. 26D and 26E are isometric top (FIG. 26D) and bottom (FIG. 26E) views of the insert.

FIGS. 27A through 27E are views of the body 200 of the tray described in this example. Referring to FIGS. 27A, 27D, and 27E, the body 200 has a rounded rectangular configuration of peripheral sidewalls 240, which extend from a highly-invaginated floor at the lowest extent (when the tray is in the upright position) to a circumferential rim 290 at the uppermost extent of the sidewalls. At its outer periphery 297, the body has a rolled- or turned-edge conformation, so that the potentially sharp peripheral edge is turned away from the outer periphery of the body. The rim also bears a substantially flat or only-slightly-rounded sealikng surface 295 about the entire rim, to which a plastic film can be sealed, if desired, to seal the storage space above the insert and within the sidewalls. In this embodiment, four supports 230 (highlighted with filled arrows in the detail view in FIG. 27F) rise from and are integral with the floor of the body. FIG. 29 is another view of the body 200 and the insert, showing where the upper surface of the four supports (a solid white circle is added atop each support) engages against the lower surface of the insert (a filled star is used to indicate the portion of the upper surface of the insert on the opposite face of where the support contacts the insert); the support helps to maintain the vertical position of the platform when items are placed upon the platform, and to keep it from collapsing into the body (i.e., helps to keep the adaptor of the insert from slipping out of engagement from and below the engagement zone of the body). The sidewalls include the engagement zone 245 for engaging the adaptor of the insert. In this embodiment, the engagement zone includes an inwardly-extending engagement section 244 (for engaging the inwardly-extending adapting section 144 of the adaptor), an outwardly-extending engagement section 246 (for engaging the outwardly-extending adapting section 146 of the adaptor), and an outwardly-extending socket 242 (for engaging the peripheral flange 142 of the insert). In this embodiment, the engagement zone is at the very bottom of the sidewalls; the engagement zone could be positioned above the bottom of the sidewalls if the insert is to be held at a higher position when installed within the body. Arrayed across the floor of the body (the area at its bottom, within the sidewalls; not numbered in these views, owing to the tortuous shape of the floor in this embodiment) are numerous fluid cells 216 and 217 for sequestering fluid. At the peripheral-most positions, the fluid cells are rounded fluid cells 217, the smooth, rounded exterior of which are unlikely to damage any fragile plastic film which may press or rub against the cells. Between the rounded fluid cells and at positions at which their edges are unlikely to contact plastic film wraps or seals are other fluid cells 216, which can have substantially any cross-sectional shape, but which are hexagonal in this embodiment. The hexagonal shape permits numerous fluid cells to be formed adjacent one another and adjacent the peripheral-most rounded fluid cells. This disposition of fluid cells, substantially covering the floor of the body, increase the quantity of liquid which can be sequestered within the cells. The dimensions of the cells are not critical and are preferably selected so that the surface tensional forces of fluid in the cells will tend to retain liquid within the cells (taking into account the viscosity of the fluid anticipated to reach the cells, if desired). Overall, the body has a substantially smooth shape, not having any sharp or pointed surfaces which would tend to cut, snag, or abrade a flexible film drawn or rubbed across the surface. If desired, one or more of the outer surfaces of the body can have a texture (e.g., “pebble” or “mottled” surface texture to reduce static frictional forces between the surface and a film applied flush against the surface. Both the smoothness and the friction-reducing texture can tend to reduce the likelihood that a flexible plastic film used to wrap or seal the tray will be damaged by contact with the tray.

The tray in this embodiment is assembled by inserting the insert within the interior of the body, with the adaptor disposed above the platform of the insert. The adaptor is urged (“snapped”) into the complementarily-sized-and-shaped engagement zone of the body. In this configuration, the lower surface of the insert rests upon the uppermost surface of each of the four supports, and a substantially fluid-tight seal is formed between the perimeter of the insert and the interior sidewall surface of the body at the engagement zone thereof. In this configuration, the tray includes a storage space above the insert and within the sidewalls of the body, into which substantially any item can be placed. The tray is specifically intended to contain liquid-exuding items such as cuts of beef, pork, or fish or cut poultry parts (wings, legs, breasts, breast fillets, or others). The tray also has a reservoir space sandwiched between the lower surface of the insert and the floor of the body. The reservoir space fluidly communicates with the storage space substantially only by way of the orifices and vents which extend through the insert.

When the tray is in this assembled state and in the upright position (rim uppermost, floor of the body resting upon a horizontal surface), fluid which is exuded within the storage space will tend to drip or flow onto the platform and to drain through the orifices 170 (and possibly the vents 106). This is because gravity will tend to draw the fluid downward; even if the fluid does not drip or flow from the item directly into an orifice, fluid which rests upon the upper surface of the insert will tend to flow laterally across it until it reaches a drainage channel 172, an orifice 170, a vent 106, or an obstruction (e.g., a sidewall). Once within a drainage channel, fluid will tend to travel downward through an orifice into the reservoir space of the tray. If desired, the platform can be contoured specifically to cause fluids to flow towards the orifice.

When fluid enters the reservoir space when the tray is in the upright position, gravity will tend to draw the fluid downwards, toward and into the fluid cells. Fluid can continue to flow into a fluid cell until the cell is filled, at which time additional fluid will tend to flow toward adjacent cells. Even when all fluid cells are filled, fluid can nonetheless continue to accumulate in the reservoir space until the entire space is filled (at least to the lowest extent of the orifices and any vents which are present). When choosing tray geometry, the vertical position of the insert and the number and volume of fluid cells can be selected to accommodate a desired volume of fluid (e.g., the greatest quantity of liquid that might reasonably be expected to be exuded from items in the storage space). Moreover, if the dimensions of the fluid cells are selected appropriately (in light of the identity and expected surface tension of liquid anticipated to be collected there), liquid within fluid cells will remain within the cells (under the influence of surface tensional forces) even if the tray is tilted out of the horizontal plane (even vertically or inverted). This characteristic can be beneficial for maintaining exuded fluid separately from items stored in the storage space of the tray.

Because the insert and body can be (and preferably are) made from the same plastic, the tray can be recycled after use (and after removing any dissimilar plastic wrapping film) even without rinsing or disassembling the tray. Any liquid or solid particles (or bacterial growth or other substances) which are sequestered within the reservoir space will tend to be removed during the rinsing and/or washing steps which normally accompany the plastic recycling process. Moreover, a consumer or recycler can reduce the quantity of material which needs to be removed at the recycling plant by shaking fluid from the tray prior to disposal or by disassembling the insert from the body and rinsing either or both components prior to disposing them in a recycling container. In this way, the quantity of packaging material which is created as non-recyclable solid waste is greatly reduced, relative to prior trays and packages. In fact, if any plastic film used to seal or wrap the tray can also be made recyclable, then the entirety of the packaging can be recycled.

### Example 4

Rolled-Edge Tray Having Perforated Rolled-Edge Insert and Liquid Sequestering Floor

This example describes a particularly advantageous embodiment of the trays described herein. This embodiment is depicted in at least FIGS. 29A through 33C and its ornamental features are depicted in greater detail in FIGS. 36-50. A photographic image of a tray of this embodiment, made with optically clear PET material and exhibiting optical clarity throughout every portion of the tray is shown in FIG. 32.

As illustrated in the exploded views shown in FIGS. 29A, 30, and 38, this embodiment of the tray includes an insert 100 and a body 200 that are assembled to form an assembled tray 300.

Referring to FIG. 29C, the insert bears two relatively large orifices 170 that extend completely through the insert. Each of the orifices is positioned at the vertex of a series of drainage channels 172 which radiate outwardly and toward one end of the insert. As can be seen in FIGS. 30A-2 and 30B-2, the orifices and the floor 173 of the drainage channels 172 are gravitationally lower than the platform surface 120 of the insert when the tray is in this (“upright”) orientation, in which the substantially planar exterior surface 211 of the floor 210 of the body rests upon a horizontal surface. Referring again to FIG. 29C, the insert also bears a centrally-located socket 105, which is a perforation sized to compressively fit against the shaft 225 of the body when that shaft is urged upwardly into and through the socket, as illustrated in FIG. 30C-2; the edges of the socket which compressively fit against the peripheral surfaces 224 of the socket are designated the collar 104. The socket, in this embodiment, is vertically positioned at the platform 120 surface of the insert, rather than being recessed downwardly, as are the drainage channels 172. Also visible in FIG. 29C are two vents 106 which are also positioned at the platform surface of the insert; the vents are substantially smaller than the orifices 170 in this embodiments because their purpose is primarily to contribute to gas flow between the reservoir space 205 and the storage space 235 of the tray. Numerous protrusions 122 or “bumps” are scattered across the surface of the platform. These bumps can be arranged in a decorative pattern, but at least some of the bumps function to maintain articles that are stored in the storage space above one or more of the drainage channels 172, orifices 170, and vents 106, so that the articles do not inhibit flow of fluids (i.e., gases or liquids) through or along these spaces. About its periphery, insert has an adaptor 145 in the form of a rolled edge 190. In the assembled tray 300, the adaptor/rolled-edge fits within a corresponding engagement zone 245 formed in the sidewall 240 of the body. Preferably, the radius of curvature of the rolled edge 190 of the insert is slightly greater than the radius of curvature of the engagement zone 245 of the body, so as to cause the rolled edge to be compressively urged against the interior of the engagement zone when the insert is installed in the body; this improves the liquid-tightness of the seal formed between the insert and the body. FIG. 30A-2 illustrates a rolled edge which is rolled all the way out to the peripheral edge 199 of the insert, which is also depicted in the insert/body assembly illustrated in FIG. 31A. FIGS. 31B and 31C illustrate that the rolled edge can terminate at an elbow 192 from which a portion of the insert extends to the peripheral edge 199. In such situations, the rolled edge may be rolled to an extent that the peripheral edge rests against the interior of the engagement zone 245, as in FIG. 31B, or it can be rolled farther, so that the peripheral edge does not contact the body when the insert is installed, as shown in FIG. 31C.

Referring to FIGS. 29A, 30, 30B-1, and 30B-2, the body 200 has a rounded rectangular configuration of peripheral sidewalls 240, which extend from a highly-invaginated floor at the lowest extent (when the tray is in the upright position) to a circumferential rim 290 at the uppermost extent of the sidewalls. At its peripheral edge 299, the body has a rolled- or turned-edge conformation, so that the potentially sharp peripheral edge is turned away from the outer periphery of the body. In this embodiment, four supports 230 rise from and are integral with the floor of the body. In FIG. 30B-1, it can be seen that the upper surface of the support engages against the lower surface of the insert; the support helps to maintain the vertical position of the platform when items are placed upon the platform. The body also has a centrally-located shaft 225 that, in the assembled tray 300 extends into and through the socket 105 of the insert. The outer dimensions of the shaft are slightly larger than (or at least about the same as) the inner dimensions of the socket, so that the collar 104 of the socket engages against the peripheral surfaces 224 of the shaft when the insert is installed within the body; this both supports the insert against further downward movement when items are placed upon the insert and helps to keep the insert from disengaging from the body when the tray is inverted. In this embodiment, the shaft has a hexagonal cross-section near its upper surface; this hexagonal portion enters into and through the socket. In this embodiment, the linear distance between opposite vertices of the hexagonal shape are slightly larger than the diameter of the socket at the collar, causing the collar to compressively fit against the vertices when the collar is engaged against the shaft. Also in this embodiment, the shaft has an essentially cylindrical shape beneath the hexagonal portion, and the diameter of this cylindrical section is greater than the diameter of the collar; this causes the shaft to serve like a support to prevent downward movement of the platform when it is loaded. The sidewalls include the engagement zone 245 for engaging the adaptor of the insert. In this embodiment, the engagement zone is at the very bottom of the sidewalls; the engagement zone could be positioned above the bottom of the sidewalls if the insert is to be held at a higher position when installed within the body. Arrayed across the floor of the body (the area at its bottom, within the sidewalls; not numbered in these views, owing to the tortuous shape of the floor in this embodiment) are numerous fluid cells 216 and 217 for sequestering fluid. At the peripheral-most positions, the fluid cells are rounded fluid cells 217, the smooth, rounded exterior of which are unlikely to damage any fragile plastic film which may press or rub against the cells. Between the rounded fluid cells and at positions at which their edges are unlikely to contact plastic film wraps or seals are other fluid cells 216, which can have substantially any cross-sectional shape, but which are hexagonal in this embodiment. The hexagonal shape permits numerous fluid cells to be formed adjacent one another and adjacent the peripheral-most rounded fluid cells. This disposition of fluid cells, substantially covering the floor of the body, increase the quantity of liquid which can be sequestered within the cells. The dimensions of the cells are not critical and are preferably selected so that the surface tensional forces of fluid in the cells will tend to retain liquid within the cells (taking into account the viscosity of the fluid anticipated to reach the cells, if desired). Overall, the body has a substantially smooth shape, not having any sharp or pointed surfaces which would tend to cut, snag, or abrade a flexible film drawn or rubbed across the surface. If desired, one or more of the outer surfaces of the body can have a texture (e.g., “pebble” or “mottled” surface texture to reduce static frictional forces between the surface and a film applied flush against the surface. Both the smoothness and the friction-reducing texture can tend to reduce the likelihood that a flexible plastic film used to wrap or seal the tray will be damaged by contact with the tray.

The tray described in this example is particularly suitable for containing fluid-exuding foodstuffs, such as cuts of meat, poultry, or fish. As an initial matter, the tray has a large open top, which permits consumers to view the contents of the tray through a clear plastic wrapping or sealing film, even if the tray itself (or a component, such as the insert as in FIGS. 33A and 33B) is opaque. Further, the tray and some or all of its components can be made from clear thermoformable plastics, such as PET, and such trays can permit contained items to be viewed from many or all angles.

When a fluid-exuding item is placed upon the platform, fluid which drips or flows onto the platform will tend to drain through the orifices 170 (and possibly the vents 106) when the tray is in the upright position. This is because gravity will tend to draw the fluid downward; even if the fluid does not drip or flow from the item directly into an orifice, fluid which rests upon the upper surface of the insert will tend to flow laterally across it until it reaches a drainage channel 172, an orifice 170, a vent 106, or an obstruction (the side of a bump, a sidewall, or a peripheral surface of a shaft). Once within a drainage channel, fluid will tend to travel downward through an orifice into the reservoir space of the tray. If desired, the platform can be contoured specifically to cause fluids to flow towards the orifice. Bumps on the insert surface also tend to keep items placed therein above (and, therefore, not occluding) lateral flow routes, including routes to orifices and vents.

When fluid enters the reservoir space when the tray is in the upright position, gravity will tend to draw the fluid downwards, toward and into the fluid cells. Fluid can continue to flow into a fluid cell until the cell is filled, at which time additional fluid will tend to flow toward adjacent cells. Even when all fluid cells are filled, fluid can nonetheless continue to accumulate in the reservoir space until the entire space is filled (at least to the lowest extent of the orifices and any vents which are present). When choosing tray geometry, the vertical position of the insert and the number and volume of fluid cells can be selected to accommodate a desired volume of fluid (e.g., the greatest quantity of liquid that might reasonably be expected to be exuded from items in the storage space). Moreover, if the dimensions of the fluid cells are selected appropriately (in light of the identity and expected surface tension of liquid anticipated to be collected there), liquid within fluid cells will remain within the cells (under the influence of surface tensional forces) even if the tray is tilted out of the horizontal plane (even vertically or inverted). This characteristic can be beneficial for maintaining exuded fluid separately from items stored in the storage space of the tray.

Because the insert and body can be (and preferably are) made from the same plastic, the tray can be recycled after use (and after removing any dissimilar plastic wrapping film) even without rinsing or disassembling the tray. Any liquid or solid particles (or bacterial growth or other substances) which are sequestered within the reservoir space will tend to be removed during the rinsing and/or washing steps which normally accompany the plastic recycling process. Moreover, a consumer or recycler can reduce the quantity of material which needs to be removed at the recycling plant by shaking fluid from the tray prior to disposal or by disassembling the insert from the body and rinsing either or both components prior to disposing them in a recycling container. In this way, the quantity of packaging material which is created as non-recyclable solid waste is greatly reduced, relative to prior trays and packages. In fact, if any plastic film used to seal or wrap the tray can also be made recyclable, then the entirety of the packaging can be recycled.

### PARTS LIST

The following list is provided as an aid to describing the indicia intended to be used to refer to the various elements of the subject matter described herein, unless the context of a particular disclosure of an indicium indicates otherwise. In the list, the indicium is followed by its intended meaning.
100 Insert
104 Collar
105 Socket
106 Vent
120 Platform
122 Protrusion
125 Gap
130 Integral Door
131 Frame Edge
133 Hinge Region
135 Deflectable Portion
137 Door Edge
140 Insert Walls
142 Peripheral Flange (also called Circumferential Flange)
144 Inwardly-Extending Adapting Section
145 Adaptor
146 Outwardly-Extending Adapting Section
165 Slit
170 Orifice
172 Drainage Channel
173 Floor of Drainage Channel 172
190 Rolled Edge
192 Elbow connecting Rolled Edge 190 with Peripheral Edge 199
199 Peripheral Edge of Insert
200 Body
201 Interior
205 Reservoir Space
210 Floor
211 Substantially Planar Exterior Surface of Floor
215 Fluid-Retaining Pattern
216 Hexagonal Fluid Cell
217 Rounded Fluid Cell
222 Protrusion
224 Sidewalls of shaft 225
225 Shaft
226 Top Surface of Shaft 225
228 Concave interior of Shaft 225
230 Support
231 Shelf Extending Inwardly From Sidewall 240
232 Upper Surface of Shelf 231
233 Upper Surface of Support 230
235 Storage Space
240 Sidewall
242 Outwardly-Extending Socket
244 Inwardly-Extending Engagement Section
245 Perimeter Engagement Zone
246 Outwardly-Extending Engagement Section
248 Overhang
290 Rim
295 Sealing Surface
297 Outer Periphery of Rim 290
299 Peripheral Edge
300 Assembled Tray
301 Storage Compartment
303 Reservoir Compartment
311 Sinuous Passage Between Perimeter Engagement Zone and Adapto
313 Biased Engagement of Adaptor with Perimeter Engagement Zone
315 Void (between Adaptor of Insert and Perimeter Engagement Zone of Body)
340 Substantially Flat Side
400 Sealing Film
420 Inwardly Deflected Edge
500 UnitaryTray
B Bent region
D_{FC} Depth of Drainage Channel 172
D_{H} Height Distance of Protrusion 220
D_{L} Gap-to-Platform-Edge Distance of Selected Length
D_{P} Floor-to-Support Distance
Ds Relatively Short Gap-to-Platform-Edge Distance
D_{V} Gap-to-Platform-Edge Distance Selected by Retained Volume
Sₙ Edge of Insert 100 Referred to by Integer ‘n’
HFB Herringbone Fabric Background

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

1. A thermoplastic tray for segregating liquid, the tray comprising a body and an insert, the body being peripherally-sealably engageable with the insert,
the body comprising
a floor contiguous with
sidewalls which surround the floor, which are contiguous with one another, and which extend away from the floor to
a circumferential rim,
the floor and the walls defining a concave interior and a convex exterior, and the sidewalls including an interior perimeter engagement zone for engaging the insert, and
the floor having at least one protrusion extending away from the floor into the interior and the exterior of the floor defining a lower surface of the tray; and
the insert comprising
a perimeter adaptor having a shape complementary to and snugly opposable against the perimeter engagement zone of the body, the adaptor being contiguous with and surrounding
a platform having at least one orifice extending therethrough.

2. The tray of claim 1, wherein the lower surface of the tray is substantially planar.

3. The tray of claim 2, wherein the rim extends horizontally completely around the perimeter of the sidewalls when the lower surface of the tray rests on a horizontal surface.

4. (canceled)

5. (canceled)

6. The tray of claim 1, wherein the platform is oriented substantially parallel to the exterior lower surface of the floor when the adaptor of the insert is nested against the engagement zone of the body.

7. (canceled)

8. The tray of claim 1, wherein at least one protrusion extends inwardly a distance sufficient for the protrusion to contact the platform when the adaptor of the insert is nested against the engagement zone of the body.

9. The tray of claim 8, wherein the protrusion is a support that contacts the platform at a surface of the support that is planar and substantially parallel to the platform.

10. (canceled)

11. The tray of claim 8, wherein the protrusion is a shaft which extends inwardly a distance sufficient to extend into a socket formed in the platform.

12. The tray of claim 11, wherein the shaft compressibly fits the socket.

13. The tray of claim 12, wherein the socket is a hole which extends through the platform.

14. The tray of claim 12, wherein the socket is a sealed extension of the platform which extends generally in the direction of the rim.

15. (canceled)

16. The tray of claim 1, wherein the rim includes the peripheral edge of the thermoplastic sheet from which the body is formed.

17. The tray of claim 16, wherein the rim includes a rolled edge which disposes away from the periphery of the rim the peripheral edge of the thermoplastic sheet from which the body is formed.

18. The tray of claim 1, wherein the body has the overall shape of a rounded rectangular tray.

19. The tray of claim 18, wherein the insert has a rounded rectangular shape and wherein the adaptor is snugly opposed against the engagement zone of the body

20. The tray of claim 19, wherein the engagement zone has a roughly semi-circular profile having its concavity facing the interior around the entire perimeter of the sidewalls.

21. The tray of claim 20, wherein the adaptor has a rolled edge conformation about the entire perimeter of the insert.

22. (canceled)

23. The tray of claim 1, wherein the platform has a generally planar conformation and wherein the adaptor includes a strip-shaped circumferential band that is offset from the plane of the platform by an angle of more than about 45 degrees and that has a profile which closely conforms to the profile of the engagement zone of the body.

24. The tray of claim 23, wherein the circumferential band is offset from the plane of the platform by an angle of about 60-90 degrees.

25. (canceled)

26. The tray of claim 1, wherein the platform has a shape which includes at least one drainage channel for facilitating liquid communication from the platform to the orifice, the drainage channel being positioned gravitationally lower than the platform when the adaptor of the insert is nested against the engagement zone of the body and the lower surface of the tray rests on a horizontal surface.

27. The tray of claim 26, wherein the platform has a vent extending therethrough, the vent being positioned gravitationally higher than the drainage channel when when the adaptor of the insert is nested against the engagement zone of the body and the lower surface of the tray rests on a horizontal surface.

28. The tray of claim 1, wherein the platform is imperforate beyond the central portion of the insert.

29. The tray of claim 1, wherein the platform is imperforate beyond the central third of the insert, as measured along any primary axis of the insert.

30. The tray of claim 1, wherein the platform has at least one bump extending therefrom in in a direction opposite the position of the lower surface when the adaptor of the insert is nested against the engagement zone of the body.

31-34. (canceled)

35. The tray of claim 1, wherein the floor of the body has a texture which includes a plurality of fluid cells for sequestering fluid therein.

36. The tray of claim 35, wherein the texture includes multiple hexagonal fluid cells formed therein in a honeycomb pattern.

37. The tray of claim 35, wherein the lower surface is planar.

38. The tray of claim 35, wherein at least one of the fluid cells of the floor has a rounded shape at the exterior surface of the floor, for reducing snagging of a flexible film which contacts the lower surface.

39. The tray of claim 38, wherein the peripheral-most portion of each fluid cell nearest the periphery of the floor has a rounded exterior surface.

40. The tray of claim 39, wherein the floor is substantially covered with an array of hexagonal fluid cells arranged in a honeycomb-like pattern, with the peripheral-most portion of each fluid cell nearest the periphery of the floor having a rounded exterior surface.

41. The tray of claim 1, wherein the engagement zone of the body has, about its entire periphery, a semicircular interior face bounded by the interior surface of the floor at one semicircular extent and by an inwardly-indented portion of the sidewalls at its other semicircular extent.

42. The tray of claim 1, wherein the engagement zone of the body has a semicircular interior face bounded by the interior surface of the floor at one semicircular extent about its entire periphery and bounded at its other semicircular extent by an inwardly-indented portion of the sidewalls at at least one peripheral position.

43. The tray of claim 1, wherein the engagement zone of the body has a semicircular interior face having a first radius of curvature and wherein the adaptor has a semi-circular surface conformation that is complementary to the semicircular interior face of the engagement zone and that has a second radius of curvature that is greater than the first radius of curvature.

44. The tray of claim 1, wherein the body and the insert are composed of the same material.

45. The tray of claim 44, wherein the material is selected from the group consisting of polyethylenes, polypropylenes, polyethylene terephthalates (PETs), polyvinyl chlorides, and combinations of these.

46. The tray of claim 44, wherein the material is a PET.

47. The tray of claim 1, wherein the perimeter engagement zone of the body is a perimeter shelf which extends entirely about the sidewalls and has a substantially planar upper surface and wherein the adaptor is a substantially planar region adjacent the perimeter edge of the insert.

48. The tray of claim 47, wherein the upper surface of the shelf is substantially parallel to the lower surface of the tray.

49. The tray of claim 47, wherein at least one sidewall includes an overhang positioned adjacent to, and nearer to the rim than, the shelf.

50. The tray of claim 49, wherein the dimensions of the insert and the spacing of the overhang from the shelf are selected so that the adaptor is snugly opposed against the upper surface of the shelf when the insert is positioned between the shelf and the overhang.

51. The tray of claim 50, wherein multiple sidewalls of the tray include an overhang positioned adjacent to, and nearer to the rim than, the shelf.

52. The tray of claim 1, wherein the orifice defines an integral door extending through the platform, the door including
a deflectable portion having a door edge defined by one extent of the orifice, the deflectable portion being deflectable between open and closed positions along
a flexible hinge region that is integral with the platform and integral with the deflectable portion of the door, and
a frame edge which is integral with the platform and has a frame edge defined by another extent of the orifice,
the door edge and frame edge being closely opposed against one another when the deflectable portion is in the closed position and less closely opposed against one another when the deflectable portion is in the open position,
the position of the engagement zone, the position of the door in the platform, the contour of the platform, and the position and height of at least one protrusion being selected such that when the adaptor is snugly opposed against the engagement zone,
the insert divides the interior into a storage space and a reservoir space and
the protrusion
impinges against the door and
deflects the deflectable portion into the open position, thereby facilitating fluid flow through the orifice between the storage and reservoir spaces.

53. The tray of claim 52, wherein the platform includes multiple doors and wherein the body includes multiple protrusions, at least two of the protrusions impinging upon doors, deflecting the deflectable portion into the corresponding open positions when the adaptor is snugly opposed against the perimeter engagement zone.

54. The tray of claim 52, wherein the protrusion has the shape of a rounded post extending away from the floor.

55. The tray of claim 52, wherein the protrusion has the shape of a rounded conical section extending away from the floor.

56. The tray of claim 52, wherein the protrusion has the shape of an elongate ridge extending away from the floor.

57. A tray for isolating liquid and a solid mass, the tray comprising a body and an insert, the body being engageable with the insert,
the body comprising
a floor contiguous with
sidewalls which surround the floor, which are contiguous with one another, and which extend away from the floor to
a circumferential rim,
the floor and the walls defining an interior,
the sidewalls including a perimeter engagement zone within the interior for engaging the body and the insert, and
the floor having one or more protrusions, each extending away from the floor by a height distance into the interior; and
the insert comprising
a platform including an integral door defined by a gap extending through the platform, the platform being surrounded by
an adaptor for engaging the perimeter engagement zone of the body,
the door including
a deflectable portion having a door edge defined by one extent of the gap, the deflectable portion being deflectable between open and closed positions along
a flexible hinge region that is integral with the platform and integral with the deflectable portion of the door, and
a frame edge which is integral with the platform and has a frame edge defined by another extent of the gap,
the door edge and frame edge being closely opposed against one another when the deflectable portion is in the closed position and less closely opposed against one another when the deflectable portion is in the open position,
the adaptor having a shape substantially the same as, but snugly nestable against, the perimeter engagement zone, and
the position of the perimeter engagement zone within the interior, the position of the door in the platform, the contour of the platform, and the position and height of at least one protrusion being selected such that when the adaptor is snugly nested against the perimeter engagement zone, the insert divides the interior into a storage space and a reservoir space and the protrusion impinges against the door, deflects the deflectable portion into the open position, and facilitates fluid flow through the gap between the storage and reservoir spaces.
